(19) United States
(12) Patent Application Publication
(10) Pub. No.: US 2026/0269457 A1
(43) Pub. Date: Sep. 10, 2026

(54) ELECTRONIC DEVICE

(71) Applicant: Huawei Technologies Co., Ltd., Shenzhen (CN)

(72) Inventors: Liang Xue, Shanghai (CN); Yuan Zhou, Shanghai (CN); Zhiyuan Xie, Shanghai (CN); Dong Yu, Shanghai (CN); Jikang Wang, Shanghai (CN); Huatao Liu, Shanghai (CN); Chi Fan, Xi'an (CN)

(21) Appl. No.: 19/662,408

(22) Filed: Apr. 29, 2026

Related U.S. Application Data
(63) Continuation of application No. PCT/CN2025/089506, filed on Apr. 17, 2025.

(30) Foreign Application Priority Data
Apr. 28, 2024 (CN) 202410544831.9

(51) Int. Cl. H01Q 1/24; G06F 1/16; H01Q 1/38; H01Q 1/50

(52) U.S. Cl. CPC H01Q 1/243; G06F 1/1616; G06F 1/1641; G06F 1/1652; G06F 1/1698; H01Q 1/38; H01Q 1/50

(57) ABSTRACT

Embodiments of this application provide an electronic device. The electronic device includes a first antenna and a second antenna. The first antenna uses conductive parts of a side frame of a first housing as a first radiator and a parasitic stub. The second antenna uses a conductive part of a side frame of a second housing as a second radiator, and the second radiator and the parasitic stub are adjacently disposed. The electronic device may be a foldable electronic device.

### CROSS-REFERENCE TO RELATED APPLICATIONS

This application is a continuation of International Application No. PCT/CN2025/089506, filed on Apr. 17, 2025, which claims priority to Chinese Patent Application No. 202410544831.9, filed on Apr. 28, 2024. The disclosures of the aforementioned applications are hereby incorporated by reference in their entireties.

### TECHNICAL FIELD

This application relates to the field of wireless communication, and in particular, to an electronic device.

### BACKGROUND

Wireless communication technologies continue to evolve rapidly. Second generation (2G) mobile communication system mainly supported a call function, electronic devices are only a tool used by people to send and receive SMS messages and perform voice communication, and a wireless network access function speed is extremely slow because data is transmitted through a voice channel. Nowadays, in addition to making calls, sending SMS messages, and taking photos, electronic devices can be further used for listening to music online, watching online movies, making video calls in real time, and the like, covering various applications such as calling, film and television entertainment, and e-commerce in people's life. As a result, a quantity of antennas incorporated in an electronic device has gradually increased.

For a foldable electronic device in a folded state, a radiation environment of an antenna is limited. To improve a radiation characteristic (for example, bandwidth and efficiency) of the antenna, a parasitic stub is typically disposed near a radiator. However, the parasitic stub deteriorates isolation between the antenna and another antenna that is adjacently disposed, causing inconvenience for users.

### SUMMARY

This application provides an electronic device. The electronic device includes a first antenna and a second antenna. Both the first antenna and the second antenna can improve antenna radiation characteristics by using a parasitic stub, and there is good isolation between the first antenna and the second antenna.

According to a first aspect, an electronic device is provided, including: a first housing, a second housing, and a ground plane, where the first housing includes a first side frame, and the second housing includes a second side frame; the first side frame includes a first position, a second position, and a third position that are sequentially disposed, the first side frame is coupled to the ground plane or has an insulation slot at the first position, and the first side frame has a first insulation slot and a second insulation slot at the second position and the third position respectively; and the second side frame includes a fourth position and a fifth position, the second side frame has a third insulation slot at the fourth position, and the second side frame is coupled to the ground plane or has an insulation slot at the fifth position; a first rotating shaft, where the first rotating shaft is located between the first housing and the second housing, and the first rotating shaft is rotatably connected to the first housing and the second housing separately; a first antenna, where the first antenna includes: a first radiator, where the first radiator includes a conductive part of the first side frame between the first position and the second position, and at least a part of the first radiator and the ground plane are spaced from each other; and a first feed circuit, where the first radiator includes a first feed point, and the first feed circuit is coupled to the first feed point to feed a radio frequency signal of a first frequency band; and a second antenna, where the second antenna includes: a second radiator, where the second radiator includes a conductive part of the second side frame between the fourth position and the fifth position, and at least a part of the second radiator and the ground plane are spaced from each other; and a second feed circuit, where the second radiator includes a second feed point, and the second feed circuit is coupled to the second feed point to feed a radio frequency signal of a second frequency band; and the electronic device further including: a parasitic stub, where the parasitic stub includes a conductive part of the first side frame between the second position and the third position, and at least a part of the parasitic stub and the ground plane are spaced from each other; and a first element, where the parasitic stub includes a first connection point, the first element is inductive, and the first element is coupled between the first connection point and the ground plane, where based on the electronic device being in a folded state, the parasitic stub and the second radiator at least partially overlap in a first direction, the first radiator and the second radiator are staggered in the first direction, and the first direction is a thickness direction of the electronic device; based on the electronic device being in the folded state, a distance between the second position and the fourth position is less than a distance between the second position and the fifth position; and a center frequency of the first frequency band is less than or equal to a center frequency of the second frequency band, and a frequency difference between the center frequency of the first frequency band and the center frequency of the second frequency band is less than or equal to 300 MHz.

According to this embodiment of this application, when the electronic device is in the folded state, and the radio frequency signal is fed at the first feed point, the first antenna may be coupled on the parasitic stub to generate a first current path. In the first current path, currents on the parasitic stub between the second position and the third position are co-directional.

In the first frequency band, because the first element is coupled between the first connection point of the parasitic stub and the ground plane, a second current path may be additionally generated on the parasitic stub. In the second current path, currents on parasitic stubs on two sides of the first connection point are reverse.

Therefore, the currents on the first current path are partially reverse to the currents on the second path, and the currents on the second path may offset a part of the currents on the first path, thereby weakening coupling between the first radiator and the second radiator, and improving isolation between the first antenna and the second antenna.

In addition, because the first element is inductive, an operating frequency band of a first antenna 401 is lower than an operating frequency band of the second antenna, and the inductive element has a low-pass high-resistance characteristic, an additional current path generated by the second antenna (a radio frequency signal fed at the second feed point) on the parasitic stub is weaker, and does not greatly affect an original current path, and a parasitic stub 430 can be configured to improve a radiation characteristic (for example, radiation efficiency) of the second antenna.

With reference to the first aspect, in some implementations of the first aspect, a distance between the first connection point and the second position is greater than a distance between the first connection point and the third position.

According to this embodiment of this application, when the first connection point is disposed on a side that is of the parasitic stub and that is away from the first radiator, a current for reverse cancellation between the current on the first current path and the current on the second path can be increased, further reducing coupling between the first radiator and the second radiator, and improving isolation between the first antenna and the second antenna.

With reference to the first aspect, in some implementations of the first aspect, the first connection point is located in a first current strong point area of the parasitic stub, and the first current strong point area is generated by coupling the second antenna.

According to this embodiment of this application, the first current strong point area generated by the second antenna may be understood as an area in which a current strong point is located in a current path generated by coupling the second antenna on the parasitic stub. Because a current corresponds to an electric field, the current strong point may also be understood as an electric field node (electric fields on two sides of the electric field node are reverse). In this embodiment of this application, the current strong point area may be understood as an area within 5 mm away from a current strongest point, or an area within 5 mm away from an electric field node.

When the first connection point is located in the first current strong point area, the first element has less impact on the second antenna, and the radiation characteristic of the second antenna can be greatly improved by using the parasitic stub.

With reference to the first aspect, in some implementations of the first aspect, the first radiator is configured to generate a first resonance, and a resonance frequency band of the first resonance includes the first frequency band; the second radiator is configured to generate a second resonance, a resonance frequency band of the second resonance includes the second frequency band, and a resonance point frequency of the second resonance is greater than or equal to a resonance point frequency of the first resonance; and the parasitic stub and the first element are configured to generate a first parasitic resonance and a second parasitic resonance, a resonance point frequency of the first parasitic resonance is greater than the resonance point frequency of the second resonance, and a resonance point frequency of the second parasitic resonance is less than the resonance point frequency of the first resonance.

According to this embodiment of this application, in the foregoing embodiment, the first current path generated by coupling the first antenna on the parasitic stub and the current path generated by coupling the second antenna on the parasitic stub may correspond to the first parasitic resonance. In the foregoing embodiment, the second current path generated by coupling the first antenna on the parasitic stub may correspond to the second parasitic resonance.

With reference to the first aspect, in some implementations of the first aspect, a frequency difference between the resonance point frequency of the second parasitic resonance and the resonance point frequency of the first resonance is greater than or equal to 100 MHz.

According to this embodiment of this application, compared with a resonance point of the first resonance, a resonance point of the second parasitic resonance is closer to a low frequency. When a frequency between the resonance point frequency of the second parasitic resonance and the resonance point frequency of the first resonance is within a specific range, cancellation effect between the current on the second current path and the current on the first current path is better, and there is better isolation between the first antenna and the second antenna. In addition, the second parasitic resonance being close to the first resonance does not cause a dip in the radiation efficiency of the first antenna in the first frequency band, nor does it reduce a radiation characteristic of the first antenna in the first frequency band.

With reference to the first aspect, in some implementations of the first aspect, a frequency difference between the resonance point frequency of the first parasitic resonance and the resonance point frequency of the second resonance is greater than or equal to 100 MHz and less than or equal to 400 MHz.

According to this embodiment of this application, when a frequency between the resonance point frequency of the first parasitic resonance and the resonance point frequency of the second resonance is within a specific range, the first parasitic resonance being close to the second resonance does not cause a dip in the radiation efficiency of the second antenna in the second frequency band. In this way, the second antenna can have a better radiation characteristic (for example, radiation efficiency) in the second frequency band.

With reference to the first aspect, in some implementations of the first aspect, at a resonance point of the first parasitic resonance, currents on the parasitic stub are co-directional; and/or at a resonance point of the second parasitic resonance, part of currents on the parasitic stub are reverse currents.

With reference to the first aspect, in some implementations of the first aspect, the first parasitic resonance is used to improve radiation efficiency of the second antenna in the second frequency band; and/or the second parasitic resonance is used to improve isolation between the first antenna and the second antenna in the first frequency band.

According to this embodiment of this application, at the resonance point of the first parasitic resonance, in the first current path generated by coupling the first antenna on the parasitic stub and the current path generated by coupling the second antenna on the parasitic stub, currents on the parasitic stub are co-directional, and the co-directional currents can be used to improve a radiation characteristic (for example, radiation efficiency) of the antenna.

At the resonance point of the second parasitic resonance, in the second current path generated by coupling the first antenna on the parasitic stub, part of currents on the parasitic stub are reverse currents, and currents on the second current path may offset a part of currents on the first current path, so that an overall current generated by coupling the first antenna 401 on the parasitic stub 430 is weakened (because the overall current is weakened, the radiation characteristic of the first antenna is slightly improved by using the first parasitic resonance), thereby weakening coupling between the first radiator and the second radiator, and improving isolation between the first antenna and the second antenna.

With reference to the first aspect, in some implementations of the first aspect, the electronic device further includes a second element, the parasitic stub includes a second connection point, the second element is capacitive, and the second element is coupled between the second connection point and the ground plane.

According to this embodiment of this application, a part of currents in the current path generated by the second antenna flows into the ground plane at the second connection point, further reducing coupling between the first radiator and the second radiator, and improving isolation between the first antenna and the second antenna.

In addition, because the second element is capacitive, an operating frequency band of the first antenna is lower than an operating frequency band of the second antenna, and the capacitive element has a high-pass low-impedance characteristic, on the parasitic stub, a current path generated by the first antenna is not affected near the second connection point, and the parasitic stub can be configured to improve the radiation characteristic (for example, radiation efficiency) of the first antenna.

With reference to the first aspect, in some implementations of the first aspect, a distance between the second connection point and the second position is less than a distance between the second connection point and the third position.

With reference to the first aspect, in some implementations of the first aspect, the second connection point is located in a third current strong point area of the parasitic stub, and the third current strong point area is generated by coupling the first antenna.

According to this embodiment of this application, the second current strong point area by the first antenna may be understood as an area in which a current strong point is located in a current path generated by coupling the first antenna on the parasitic stub.

When the second connection point is located in the second current strong point area, the second element has less impact on the first antenna, and the radiation characteristic of the first antenna can be greatly improved by using the parasitic stub.

With reference to the first aspect, in some implementations of the first aspect, the second element is configured to improve isolation between the first antenna and the second antenna in the second frequency band.

With reference to the first aspect, in some implementations of the first aspect, the first side frame is coupled to the ground plane at the first position; the second side frame has a fourth insulation slot at the fifth position; and the first insulation slot is aligned with the third insulation slot, and/or the first insulation slot is aligned with the fourth insulation slot.

With reference to the first aspect, in some implementations of the first aspect, the second side frame further includes a sixth position, the fifth position is located between the fourth position and the sixth position, the second side frame has the fourth insulation slot at the fifth position, and the second side frame is coupled to the ground plane at the sixth position; the second radiator includes a conductive part of the second side frame between the fourth position and the sixth position; and the second antenna further includes a third element, the second radiator includes a third connection point and a fourth connection point, the fourth insulation slot is located between the third connection point and the fourth connection point, and the third element is coupled between the third connection point and the fourth connection point.

With reference to the first aspect, in some implementations of the first aspect, a distance between the fourth insulation slot and the third connection point and/or a distance between the fourth insulation slot and the fourth connection point are/is less than or equal to 5 mm.

With reference to the first aspect, in some implementations of the first aspect, the first side frame further includes a seventh position, the third position is located between the second position and the seventh position, and the first side frame is coupled to the ground plane at the seventh position; the parasitic stub includes a conductive part of the first side frame between the second position and the seventh position, and the first connection point is located on the parasitic stub between the second position and the third position; and the first antenna and the second antenna further include a fourth element, the parasitic stub includes a fifth connection point and a sixth connection point, the second insulation slot is located between the fifth connection point and the sixth connection point, and the fourth element is coupled between the fifth connection point and the sixth connection point.

With reference to the first aspect, in some implementations of the first aspect, a distance between the second insulation slot and the fifth connection point and a distance between the second insulation slot and the sixth connection point are less than or equal to 5 mm.

With reference to the first aspect, in some implementations of the first aspect, a length L1 of the first side frame between the first position and the second position and a length L2 of the first side frame between the second position and the third position satisfy: L1×150%≤L2.

According to this embodiment of this application, as a length of the parasitic stub increases, it is more conducive to improving a radiation characteristic of the antenna (the first antenna or the second antenna).

With reference to the first aspect, in some implementations of the first aspect, the first frequency band includes 1578.42±1.023 MHz, and the second frequency band includes 1.71 GHz to 1.785 GHz; and/or the first frequency band includes 2.4 GHz to 2.4835 GHZ, and the second frequency band includes 2.5 GHz to 2.57 GHz or 2.496 GHz to 2.69 GHz.

With reference to the first aspect, in some implementations of the first aspect, the first side frame between the second position and the third position does not include a ground point.

According to a second aspect, an electronic device is provided, including: a first housing, a second housing, and a ground plane, where the first housing includes a first side frame, and the second housing includes a second side frame; the first side frame includes a first position, a second position, and a third position that are sequentially disposed, the first side frame is coupled to the ground plane or has an insulation slot at the first position, and the first side frame has a first insulation slot and a second insulation slot at the second position and the third position respectively; and the second side frame includes a fourth position and a fifth position, and the second side frame has a third insulation slot and a fourth insulation slot at the fourth position and the fifth position respectively; a first rotating shaft, where the first rotating shaft is located between the first housing and the second housing, and the first rotating shaft is rotatably connected to the first housing and the second housing separately; a first antenna, where the first antenna includes: a first radiator, where the first radiator includes a conductive part of the first side frame between the first position and the second position, and at least a part of the first radiator and the ground plane are spaced from each other; and a first feed circuit, where the first radiator includes a first feed point, and the first feed circuit is coupled to the first feed point to feed a radio frequency signal of a first frequency band; a second antenna, where the second antenna includes: a second radiator, where the second radiator includes a conductive part of the second side frame between the fourth position and the fifth position, and at least a part of the second radiator and the ground plane are spaced from each other; and a second feed circuit, where the second radiator includes a second feed point, and the second feed circuit is coupled to the second feed point to feed a radio frequency signal of a second frequency band; and a first element, where the second radiator includes a first connection point, the first element is inductive, and the first element is coupled between the first connection point and the ground plane; and the first antenna and the second antenna further include: a parasitic stub, where the parasitic stub includes a conductive part of the first side frame between the second position and the third position, and at least a part of the parasitic stub and the ground plane are spaced from each other, where based on the electronic device being in a folded state, the parasitic stub and the second radiator at least partially overlap in a first direction, the first radiator and the second radiator are staggered in the first direction, and the first direction is a thickness direction of the electronic device; and a center frequency of the first frequency band is less than or equal to a center frequency of the second frequency band, and a frequency difference between the center frequency of the first frequency band and the center frequency of the second frequency band is less than or equal to 300 MHz.

With reference to the second aspect, in some implementations of the second aspect, based on the electronic device being in the folded state, a distance between the second position and the fourth position is less than a distance between the second position and the fifth position; and a distance between the first connection point and the fourth position is greater than a distance between the first connection point and the fifth position, and a distance between the second feed point and the fourth position is less than a distance between the second feed point and the fifth position.

With reference to the second aspect, in some implementations of the second aspect, the first connection point is located in a second current strong point area of the second radiator, and the second current strong point area is generated by coupling the second antenna.

With reference to the second aspect, in some implementations of the second aspect, the first radiator is configured to generate a first resonance, and a resonance frequency band of the first resonance includes the first frequency band; the second radiator and the first element are configured to generate a second resonance and a third resonance, a resonance frequency band of the second resonance includes the second frequency band, a resonance point frequency of the second resonance is greater than or equal to a resonance point frequency of the first resonance, and a resonance point frequency of the third resonance is less than the resonance point frequency of the first resonance; and the parasitic stub is configured to generate a first parasitic resonance, and a resonance point frequency of the first parasitic resonance is greater than the resonance point frequency of the second resonance.

With reference to the second aspect, in some implementations of the second aspect, a frequency difference between the resonance point frequency of the third resonance and the resonance point frequency of the first resonance is greater than or equal to 100 MHz.

With reference to the second aspect, in some implementations of the second aspect, a frequency difference between the resonance point frequency of the first parasitic resonance and the resonance point frequency of the first resonance is greater than or equal to 100 MHz and less than or equal to 400 MHz.

With reference to the second aspect, in some implementations of the second aspect, at a resonance point of the second resonance, currents on the second radiator are co-directional; and/or at a resonance point of the third resonance, currents on the second radiator include a part of reverse currents.

With reference to the second aspect, in some implementations of the second aspect, the first parasitic resonance is used to improve radiation efficiency of the first antenna in the first frequency band; and/or the third resonance is used to improve isolation between the first antenna and the second antenna in the first frequency band.

With reference to the second aspect, in some implementations of the second aspect, the electronic device further includes a second element, the parasitic stub includes a second connection point, the second element is capacitive, and the second element is coupled between the second connection point and the ground plane.

With reference to the second aspect, in some implementations of the second aspect, a distance between the second connection point and the second position is less than a distance between the second connection point and the third position.

With reference to the second aspect, in some implementations of the second aspect, the second connection point is located in a third current strong point area of the parasitic stub, and the third current strong point area is generated by coupling the first antenna.

With reference to the second aspect, in some implementations of the second aspect, the second element is configured to improve isolation between the first antenna and the second antenna in the second frequency band.

With reference to the second aspect, in some implementations of the second aspect, the first side frame is coupled to the ground plane at the first position; and the first insulation slot is aligned with the third insulation slot, and/or the first insulation slot is aligned with the fourth insulation slot.

With reference to the second aspect, in some implementations of the second aspect, the second side frame further includes a sixth position, the fifth position is located between the fourth position and the sixth position, and the second side frame is coupled to the ground plane at the sixth position; the second radiator includes a conductive part of the second side frame between the fourth position and the sixth position, and the first connection point is located on the second radiator between the fourth position and the fifth position; and the second antenna further includes a third element, the second radiator includes a third connection point and a fourth connection point, the fourth insulation slot is located between the third connection point and the fourth connection point, and the third element is coupled between the third connection point and the fourth connection point.

With reference to the second aspect, in some implementations of the second aspect, a distance between the fourth insulation slot and the third connection point and/or a distance between the fourth insulation slot and the fourth connection point are/is less than or equal to 5 mm.

With reference to the second aspect, in some implementations of the second aspect, the first side frame further includes a seventh position, the third position is located between the second position and the seventh position, and the first side frame is coupled to the ground plane at the seventh position; the parasitic stub includes a conductive part of the first side frame between the second position and the seventh position; and the first antenna and the second antenna further include a fourth element, the parasitic stub includes a fifth connection point and a sixth connection point, the second insulation slot is located between the fifth connection point and the sixth connection point, and the fourth element is coupled between the fifth connection point and the sixth connection point.

With reference to the second aspect, in some implementations of the second aspect, a distance between the second insulation slot and the fifth connection point and a distance between the second insulation slot and the sixth connection point are less than or equal to 5 mm.

With reference to the second aspect, in some implementations of the second aspect, a length L1 of the first side frame between the first position and the second position and a length L2 of the first side frame between the second position and the third position satisfy: L1×150%≤L2.

With reference to the second aspect, in some implementations of the second aspect, the first frequency band includes 1578.42±1.023 MHz, and the second frequency band includes 1.71 GHz to 1.785 GHz; and/or the first frequency band includes 2.4 GHz to 2.4835 GHz, and the second frequency band includes 2.5 GHz to 2.57 GHz or 2.496 GHz to 2.69 GHz.

With reference to the second aspect, in some implementations of the second aspect, the second side frame between the fourth position and the fifth position does not include a ground point.

According to a third aspect, an electronic device is provided, including: a first side frame and a ground plane, where the first side frame includes a first position, a second position, a third position, and a fourth position that are sequentially disposed, the first side frame is coupled to the ground plane or has an insulation slot at the first position, the first side frame has a second insulation slot and a third insulation slot at the second position and the third position respectively, and the first side frame is coupled to the ground plane or has an insulation slot at the fourth position; a first antenna, where the first antenna includes: a first radiator, where the first radiator includes a conductive part of the first side frame between the first position and the second position, and at least a part of the first radiator and the ground plane are spaced from each other; and a first feed circuit, where the first radiator includes a first feed point, and the first feed circuit is coupled to the first feed point to feed a radio frequency signal of a first frequency band; and a second antenna, where the second antenna includes: a second radiator, where the second radiator includes a conductive part of the first side frame between the third position and the fourth position, and at least a part of the second radiator and the ground plane are spaced from each other, and a second feed circuit, where the second radiator includes a second feed point, and the second feed circuit is coupled to the second feed point to feed a radio frequency signal of a second frequency band; and the electronic device further including: a first parasitic stub, where the first parasitic stub includes a conductive part of the first side frame between the second position and the third position, and at least a part of the first parasitic stub and the ground plane are spaced from each other; and a first element, where the first element is inductive, the first parasitic stub includes a first connection point, and the first element is coupled between the first connection point and the ground plane, where a center frequency of the first frequency band is less than or equal to a center frequency of the second frequency band, and a frequency difference between the center frequency of the first frequency band and the center frequency of the second frequency band is less than or equal to 300 MHz.

With reference to the third aspect, in some implementations of the third aspect, a distance between the first connection point and the second position is greater than a distance between the first connection point and the third position.

With reference to the third aspect, in some implementations of the third aspect, the first connection point is located in a first current strong point area of the first parasitic stub, and the first current strong point area is generated by coupling the second antenna.

With reference to the third aspect, in some implementations of the third aspect, the first element is configured to improve isolation between the first antenna and the second antenna in the first frequency band.

With reference to the third aspect, in some implementations of the third aspect, the first antenna and the second antenna further include a second element, the second element is capacitive, the first parasitic stub includes a second connection point, and the second element is coupled between the second connection point and the ground plane.

With reference to the third aspect, in some implementations of the third aspect, a distance between the second connection point and the second position is less than a distance between the second connection point and the third position.

With reference to the third aspect, in some implementations of the third aspect, the second connection point is located in a third current strong point area of the first parasitic stub, and the third current strong point area is generated by coupling the first antenna.

With reference to the third aspect, in some implementations of the third aspect, the second element is configured to improve isolation between the first antenna and the second antenna in the second frequency band.

With reference to the third aspect, in some implementations of the third aspect, the first side frame is coupled to the ground plane at the first position; and/or the first side frame is coupled to the ground plane at the fourth position.

With reference to the third aspect, in some implementations of the third aspect, the first side frame is coupled to the ground plane at the fourth position; and the second antenna further includes a third element, the second radiator includes a third connection point, the first parasitic stub includes a fourth connection point, and the third element is coupled between the third connection point and the fourth connection point.

With reference to the third aspect, in some implementations of the third aspect, a distance between the second insulation slot and the third connection point and/or a distance between the second insulation slot and the fourth connection point are/is less than or equal to 5 mm.

With reference to the third aspect, in some implementations of the third aspect, the electronic device further includes a first housing, a second housing, and a first rotating shaft, where the first rotating shaft is located between the first housing and the second housing, and the first rotating shaft is rotatably connected to the first housing and the second housing separately; the first housing includes the first side frame; the second housing includes a second side frame; and the second side frame includes a fifth position and a sixth position, the second side frame is coupled to the ground plane or has an insulation slot at the fifth position, and the second side frame is coupled to the ground plane or has an insulation slot at the sixth position; and the electronic device further includes a second parasitic stub, where the second parasitic stub includes a conductive part of the second side frame between the fifth position and the sixth position, and at least a part of the second parasitic stub and the ground plane are spaced from each other, where based on the electronic device being in a folded state, the second parasitic stub and the first radiator at least partially overlap in a first direction, and the first direction is a thickness direction of the electronic device.

With reference to the third aspect, in some implementations of the third aspect, the second parasitic stub is configured to improve radiation efficiency of the first antenna in the first frequency band.

With reference to the third aspect, in some implementations of the third aspect, the electronic device further includes a first housing, a second housing, and a first rotating shaft, where the first rotating shaft is located between the first housing and the second housing, and the first rotating shaft is rotatably connected to the first housing and the second housing separately; and the first housing includes the first side frame, the second housing includes a second side frame, the second side frame include a seventh position and an eighth position, the second side frame is coupled to the ground plane or has an insulation slot at the seventh position, and the second side frame is coupled to the ground plane or has an insulation slot at the eighth position; and the electronic device further includes a third parasitic stub, where the third parasitic stub includes a conductive part of the second side frame between the seventh position and the eighth position, and at least a part of the third parasitic stub and the ground plane are spaced from each other, where based on the electronic device being in a folded state, the third parasitic stub and the second radiator at least partially overlap in a first direction, and the first direction is a thickness direction of the electronic device.

With reference to the third aspect, in some implementations of the third aspect, the third parasitic stub is configured to improve radiation efficiency of the second antenna in the second frequency band.

With reference to the third aspect, in some implementations of the third aspect, the electronic device further includes a first housing, a second housing, and a first rotating shaft, where the first rotating shaft is located between the first housing and the second housing, and the first rotating shaft is rotatably connected to the first housing and the second housing separately; and the first housing includes the first side frame, the second housing includes a second side frame, the second side frame includes a fifth position, a sixth position, a seventh position, and an eighth position that are sequentially disposed, the second side frame is coupled to the ground plane at the fifth position, the second side frame has a third insulation slot and a fourth insulation slot at the sixth position and the seventh position respectively, and the second side frame is coupled to the ground plane at the eighth position; and the electronic device further includes a second parasitic stub and a third parasitic stub, where the second parasitic stub includes a conductive part of the second side frame between the fifth position and the sixth position, at least a part of the second parasitic stub and the ground plane are spaced from each other, the third parasitic stub includes a conductive part of the second side frame between the sixth position and the eighth position, and at least a part of the third parasitic stub and the ground plane are spaced from each other; and the second antenna further includes a fourth element, the third parasitic stub includes a fifth connection point and a sixth connection point, the fourth insulation slot is located between the fifth connection point and the sixth connection point, and the fourth element is coupled between the fifth connection point and the sixth connection point, where based on the electronic device being in a folded state, the second parasitic stub and the first radiator at least partially overlap in a first direction, the third parasitic stub and the second radiator at least partially overlap in the first direction, and the first direction is a thickness direction of the electronic device.

With reference to the third aspect, in some implementations of the third aspect, the second parasitic stub is configured to improve radiation efficiency of the first antenna in the first frequency band, and/or the third parasitic stub is configured to improve radiation efficiency of the second antenna in the second frequency band.

With reference to the third aspect, in some implementations of the third aspect, based on the electronic device being in the folded state, the first insulation slot is aligned with the third insulation slot, and/or the second insulation slot is aligned with the fourth insulation slot.

With reference to the third aspect, in some implementations of the third aspect, a length L1 of the first side frame between the first position and the second position and a length L2 of the first side frame between the second position and the third position satisfy: L1×150%≤L2.

With reference to the third aspect, in some implementations of the third aspect, the first frequency band includes 1578.42±1.023 MHz, and the second frequency band includes 1.71 GHz to 1.785 GHz; and/or the first frequency band includes 2.4 GHz to 2.4835 GHZ, and the second frequency band includes 2.5 GHz to 2.57 GHz or 2.496 GHz to 2.69 GHz.

With reference to the third aspect, in some implementations of the third aspect, the first side frame between the second position and the third position does not include a ground point.

### BRIEF DESCRIPTION OF THE DRAWINGS

FIG. 1 is a diagram of an electronic device 100 according to an embodiment of this application;

FIG. 2 is a diagram of a structure of a foldable electronic device 100 according to an embodiment of this application;

FIG. 3 is a diagram of a structure of a foldable electronic device 100 in an outward-folded state;

FIG. 4 is a diagram of a structure of a foldable electronic device 100 in a possible unfolded state;

FIG. 5 is a diagram of a structure of a foldable electronic device 100 in a possible folded state;

FIG. 6 is a diagram of a structure of a foldable electronic device 100 in a possible partially-unfolded state;

FIG. 7 is a diagram of a structure of an antenna in a common mode and distribution of corresponding currents and electric fields according to this application;

FIG. 8 is a diagram of a structure of another antenna in a differential mode and distribution of corresponding currents and electric fields according to this application;

FIG. 9 is a diagram of a foldable electronic device 100 in an unfolded state according to an embodiment of this application;

FIG. 10 is a diagram of a foldable electronic device 100 in a folded state according to an embodiment of this application;

FIG. 11 is a diagram of an electronic device 100 according to an embodiment of this application;

FIG. 12 is a diagram of an electronic device 100 according to an embodiment of this application;

FIG. 13 is a diagram of an electronic device 100 according to an embodiment of this application;

FIG. 14 is a diagram of an electronic device 100 according to an embodiment of this application;

FIG. 15 is a diagram of an electronic device 100 according to an embodiment of this application;

FIG. 16 is a diagram of an electronic device 100 according to an embodiment of this application;

FIG. 17 shows simulation results of S parameters of a first antenna and a second antenna when a first element and a second element are not disposed;

FIG. 18 shows simulation results of S parameters of a first antenna and a second antenna when only a first element is disposed;

FIG. 19 shows simulation results of S parameters of a first antenna and a second antenna when a first element and a second element are disposed;

FIG. 20 shows simulation results of radiation efficiency and total efficiency of a second antenna;

FIG. 21(a) and FIG. 21(b) are a diagram of distribution of currents and electric fields of a first antenna at a resonance point (1.57 GHZ) of a first resonance in the electronic device 100 shown in FIG. 16;

FIG. 22(a) and FIG. 22(b) are a diagram of distribution of currents and electric fields of a second antenna at a resonance point (1.74 GHZ) of a second resonance in the electronic device 100 shown in FIG. 16;

FIG. 23 is a diagram of another electronic device 100 according to an embodiment of this application;

FIG. 24 shows a simulation result of an S parameter of a first antenna in the electronic device 100 shown in FIG. 23;

FIG. 25 shows a simulation result of an S parameter of a second antenna in the electronic device 100 shown in FIG. 23;

FIG. 26 shows simulation results of radiation efficiency and total efficiency of a first antenna in the electronic device 100 shown in FIG. 23;

FIG. 27 shows simulation results of radiation efficiency and total efficiency of a second antenna in the electronic device 100 shown in FIG. 23;

FIG. 28 is a diagram of another electronic device 100 according to an embodiment of this application;

FIG. 29 is a diagram of another electronic device 100 according to an embodiment of this application;

FIG. 30 shows simulation results of S parameters of a first antenna and a second antenna when a first element and a second element are not disposed;

FIG. 31 shows simulation results of S parameters of a first antenna and a second antenna when a first element and a second element are disposed;

FIG. 32 is a diagram of another electronic device 100 according to an embodiment of this application;

FIG. 33 is a diagram of another electronic device 100 according to an embodiment of this application;

FIG. 34 is a diagram of another electronic device 100 according to an embodiment of this application;

FIG. 35 shows simulation results of radiation efficiency and total efficiency of a first antenna and a second antenna in the electronic device 100 shown in FIG. 34; and

FIG. 36 shows simulation results of radiation efficiency and total efficiency of a second antenna in the electronic device 100 shown in FIG. 34.

### DETAILED DESCRIPTION OF EMBODIMENTS

The following describes possible terms in embodiments of this application.

It should be understood that the term “and/or” in this specification describes only a same field for describing associated objects and indicates that three relationships may exist. For example, A and/or B may indicate the following three cases: Only A exists, both A and B exist, and only B exists. In addition, the character “/” in this specification usually indicates an “or” relationship between associated objects.

In this application, “within a range of . . . ” is used, except when it is separately specified that no end value is included, end values at both ends of the range are included by default. For example, within a range from 1 to 5, two values 1 and 5 are included.

Coupling: Coupling may be understood as direct coupling and/or indirect coupling, and a “coupling connection” may be understood as a direct coupling connection and/or an indirect coupling connection. The direct coupling may also be referred to as an “electrical connection”, which may be understood as physical contact and electrical conduction of components, or may be understood as a form of connection between different components in a line structure through a physical line that can transmit an electrical signal, for example, a printed circuit board (PCB) copper foil or a conducting wire. The “indirect coupling” may be understood as electrical conduction of two conductors in a spaced/non-contact manner. In an embodiment, the indirect coupling may also be referred to as capacitive coupling. For example, signal transmission is implemented by forming an equivalent capacitor through coupling in a gap between two spaced conductive members.

Element/Component: The element/component includes at least one of a lumped element/component, and a distributed element/component.

Lumped element/component: The lumped element/component is a general name of all elements whose sizes are far less than a wavelength corresponding to an operating frequency of a circuit. For a signal, a characteristic of the element is always constant at any time, regardless of a frequency.

Distributed element/component: A difference between the distributed element and the lumped element lies in that if a size of an element is close to or greater than a wavelength corresponding to an operating frequency of a circuit, a characteristic of each point of the element varies with a signal when the signal passes through the element. In this case, the element cannot be considered as a single body with a constant characteristic, but should be referred to as a distributed element.

Capacitor: The capacitor may be understood as a lumped capacitor and/or a distributed capacitor. The lumped capacitor is a capacitive component, for example, a capacitive element. The distributed capacitor (or a distributed type capacitor) is an equivalent capacitor formed by two conductive members that are spaced from each other by a specific gap.

Inductor: The inductor may be understood as a lumped inductor and/or a distributed inductor. The lumped inductor is an inductive component, for example, an inductive element. The distributed inductor (or a distributed type inductor) is an equivalent inductor formed by a conductive member with a specific length.

Radiator: The radiator is an apparatus configured to receive/send electromagnetic wave radiation in an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator through a feeder. The radiator converts the energy into specific polarized electromagnetic wave energy and radiates the energy in a desired direction. A receive radiator converts specific polarized electromagnetic wave energy from a specific direction of space into modulated high-frequency current energy, and transmits the modulated high-frequency current energy to an input end of a receiver through a feeder.

The radiator may include a conductor with a specific shape and dimension, for example, a linear radiator or a sheet-like radiator. A specific shape is not limited in this application. In an embodiment, the linear radiator may be referred to as a wire antenna for short. In an embodiment, the linear radiator may be implemented by a conductive side frame, and may also be referred to as a side frame antenna. In an embodiment, the linear radiator may be implemented by a bracket conductor, and may also be referred to as a bracket antenna. In an embodiment, a wire diameter (for example, including a thickness and a width) of the linear radiator or a radiator of the wire antenna is far less than a wavelength (for example, a dielectric wavelength) (for example, is less than 1/16 of the wavelength), and a length may be compared with the wavelength (for example, the dielectric wavelength) (for example, the length is approximately ⅛ of the wavelength, or ⅛ to ¼ of the wavelength, or ¼ to ½ of the wavelength, or greater). Main forms of the wire antenna include the following: a dipole antenna, a half-wave dipole antenna, a monopole antenna, a loop antenna, and an inverted F antenna (also referred to as an IFA). For example, for the dipole antenna, each dipole antenna usually includes two radiation stubs, and each stub is fed by a feed part from a feed end of the radiation stub. For example, the inverted F antenna (IFA) may be considered as being obtained by adding a ground path to a monopole antenna. The IFA antenna has a feed point and a ground point. A side view of the IFA antenna is inverted F-shaped, and therefore, the IFA antenna is referred to an inverted F antenna. In an embodiment, a sheet-like radiator may include a microstrip antenna, or a patch antenna, for example, a planar inverted F antenna (PIFA). In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. The sheet-like radiator may be in a circular shape, a rectangular shape, a ring shape, or the like. A specific shape is not limited in this application. A structure of the microstrip antenna usually includes a dielectric substrate, a radiator, and a ground plane, where the dielectric substrate is disposed between the radiator and the ground plane.

The radiator may also include a slot or a slit formed on a conductor, for example, a closed or semi-closed slot or slit formed on a grounded conductor surface. In an embodiment, a radiator with a slot or a slit may be briefly referred to as a slot antenna or a slotted antenna. In an embodiment, a radial size (for example, including a width) of the slot or slit of the slot antenna/slotted antenna is far less than a wavelength (for example, a dielectric wavelength) (for example, is less than 1/16 of the wavelength), and a length size may be compared with the wavelength (for example, the dielectric wavelength) (for example, the length is approximately ⅛ of the wavelength, or ⅛ to ¼ of the wavelength, or ¼ to ½ of the wavelength, or greater). In an embodiment, a radiator with a closed slot or slit may be briefly referred to as a closed slot antenna. In an embodiment, a radiator with a semi-closed slot or slit (for example, an opening is additionally provided on the closed slot or slit) may be referred to as an open slot antenna for short. In some embodiments, the slot is long strip-shaped. In some embodiments, a length of the slot is approximately half the wavelength (for example, the dielectric wavelength). In some embodiments, a length of the slot is approximately an integer multiple of the wavelength (for example, a one-fold dielectric wavelength). In some embodiments, the slot may be used for feeding through a transmission line bridged on one side or two sides of the slot. In this way, a radio frequency electromagnetic field is excited on the slot, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced from each other from the ground plane and is grounded at two ends of the radiator, to form a closed or semi-closed slot or slit. In an embodiment, the radiator of the slot antenna or the slotted antenna may be implemented by a bracket conductor that is grounded at two ends, and may also be referred to as a bracket antenna.

A feed circuit is a combination of all circuits for receiving and transmitting radio frequency signals. The feed circuit may include a transceiver (transceiver) and a radio frequency front end (RF front end) circuit. In some cases, the “feed circuit” is a radio frequency chip (RFIC) in a narrow sense, and the RFIC may be considered to include a radio frequency front end chip and the transceiver. The feed circuit has a function of converting a radio wave (for example, a radio frequency signal) and an electrical signal (for example, a digital signal). Usually, the feed circuit is considered as a part of radio frequency.

In some embodiments, an electronic device may further include a test base (which is also referred to as a radio frequency base or a radio frequency test base). A coaxial cable may be inserted into the test base, to test a characteristic of a radio frequency front end circuit or the radiator of the antenna through the cable. The radio frequency front end circuit may be considered as a circuit part coupled between the test base and the transceiver.

In some embodiments, the radio frequency front end circuit may be integrated into the radio frequency front end chip of the electronic device, or the radio frequency front end circuit and the transceiver may be integrated into the radio frequency chip of the electronic device.

It should be understood that any two of a first feed circuit, a second feed circuit, . . . , and an N^{th} feed circuit in this application may share a same transceiver, for example, transmit a signal through a radio frequency channel in the transceiver (for example, a pin of the radio frequency integrated circuit); and may further share a radio frequency front end circuit, for example, process the signal via a tuning circuit or an amplifier in the radio frequency front end circuit.

It should be further understood that two of the first feed circuit, the second feed circuit, . . . , and the N^{th} feed circuit in this application usually correspond to two radio frequency test bases of the electronic device.

A matching circuit is a circuit for adjusting a radiation characteristic of the antenna. In an embodiment, the matching circuit is coupled between the feed circuit and a corresponding radiator. In an embodiment, the matching circuit is coupled between a test base and a radiator. Usually, the matching circuit is a combination of circuits coupled between the radiator and the ground plane. In an embodiment, the matching circuit may include a tuning circuit and/or an element. The tuning circuit may be an element configured to switch a coupling connection of the radiator. The matching circuit has a function of impedance matching and/or frequency tuning. Usually, the matching circuit is considered as a part of the antenna.

Ground structure/Feed structure: The ground structure/feed structure may include a connector, for example, a metal spring. The radiator is coupled to the ground plane through the ground structure/coupled to the feed circuit through the feed structure. In some embodiments, the feed structure may include a transmission line/feeder, and the ground structure may include a ground cable.

End/point: The “end/point” in a first end/second end/feed end/ground end/feed point/ground point/connection point of a radiator of an antenna cannot be understood in a narrow sense as an endpoint or an end part that is physically disconnected from another radiator, and may also be considered as a point or a section on a continuous radiator. In an embodiment, the “end/point” may include a connection/coupling area that is on a radiator of an antenna and that is coupled to another conductive structure. For example, a feed end/feed point may be a coupling area (for example, an area facing a part of a feed circuit) that is on the radiator of the antenna and that is coupled to a feed structure or a feed circuit. For another example, a ground end/ground point may be an open end or a closed end of a connection/coupling area that is on the radiator of the antenna and that is coupled to a ground structure or a ground circuit. In some embodiments, the open end and the closed end are, for example, defined relative to whether an end is grounded. The closed end is grounded, and the open end is not grounded. In some embodiments, the open end and the closed end are, for example, defined relative to another conductor. The closed end is electrically connected to the another conductor, and the open end is not electrically connected to the another conductor. In an embodiment, the open end may also be referred to as a floating end, a free end, an opening end or an open-circuit end. In an embodiment, the closed end may also be referred to as a ground end or a short-circuit end. It should be understood that, in some embodiments, another conductor may be connected in a coupling manner through the open end, to transfer coupling energy (which may be understood as transferring a current).

In some embodiments, the “closed end” may also be understood from a perspective of current distribution. The closed end, the ground end, or the like may be understood as a current strong point on a radiator, or may be understood as an electric field weak point on a radiator. In an embodiment, the closed end is coupled to an electronic component (for example, a capacitor or an inductor), so that a current distribution characteristic of the current strong point/electric field weak point on the radiator may not be changed. In an embodiment, a slit (for example, a slot filled with an insulation material) is disposed at or near the closed end, so that the current distribution characteristic of the current strong point/electric field weak point on the radiator may not be changed.

In some embodiments, the “open end” may also be understood from a perspective of current distribution. The open end, the floating end, or the like may be understood as a current weak point on a radiator, or may be understood as an electric field strong point on a radiator. In an embodiment, the open end is coupled to an electronic component (for example, a capacitor or an inductor), so that a current distribution characteristic of the current weak point/electric field strong point on the radiator may not be changed.

It should be understood that a radiator end (similar to a radiator at an opening of the open end or the floating end from a perspective of a radiator structure) in a slot is coupled to an electronic component (for example, a capacitor or an inductor), so that the radiator end is a current strong point/electric field weak point. In this case, it should be understood that the radiator end in the slot is actually a closed end, a ground end, or the like.

A “floating radiator” in embodiments of this application means that the radiator is not directly connected to a feeder/feed stub and/or a ground cable/ground stub, but is fed and/or grounded in an indirect coupling manner.

It should be understood that “floating” in the “floating end” and the “floating radiator” does not mean that there is no structure around the radiator to support the radiator. In an embodiment, the floating radiator may be, for example, a radiator provided on an inner surface of an insulation rear cover.

That currents are co-directional/reverse in embodiments of this application should be understood as that directions of main currents on conductors on a same side are co-directional/reverse. For example, when co-directionally distributed currents are excited on a bent conductor or an annular conductor (for example, a current path is also bent or annular), it should be understood that, for example, although directions of main currents excited on conductors on two sides of the annular conductor (for example, on conductors on two sides of a slot in conductors around the slot) are reverse, the main currents still fall within a definition of co-directionally distributed currents in embodiments of this application. In an embodiment, that currents on a conductor are co-directional may mean that the currents on the conductor have no reverse point. In an embodiment, that currents on a conductor are reverse may mean that the currents on the conductor have at least one reverse point. In an embodiment, that currents on two conductors are co-directional may mean that none of the currents on the two conductors has a reverse point and the currents flow in a same direction. In an embodiment, that currents on two conductors are reverse may mean that none of the currents on the two conductors has a reverse point and the currents flow in reverse directions. It may be correspondingly understood that currents on a plurality of conductors are co-directional/reverse.

Resonance/Resonance frequency: The resonance frequency is also referred to as a resonant frequency. The resonance frequency may have a frequency range, namely, a frequency range in which a resonance occurs. A frequency corresponding to a strongest resonance point is a center frequency point frequency. A return loss of the center frequency may be less than −20 dB. It should be understood that, unless otherwise specified, an antenna/a radiator generates a “first/second . . . resonance” in this application, where the first resonance should be a fundamental mode resonance generated by the antenna/radiator, or a resonance that is generated by the antenna/radiator and that has a lowest frequency. It should be understood that the antenna/radiator may generate one or more antenna modes based on a specific design, and one fundamental mode resonance may be correspondingly generated in each antenna mode.

Resonance frequency band: A range of a resonance frequency is a resonance frequency band, and a return loss of any frequency in the resonance frequency band may be less than −6 dB or −5 dB.

Communication frequency band/Operating frequency band: Regardless of a type of antenna, the antenna constantly operates in a specific frequency range (a frequency bandwidth). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna.

The resonance frequency band and the operating frequency band may be the same, or may partially overlap. In an embodiment, one or more resonance frequency bands of an antenna may cover one or more operating frequency bands of the antenna.

Electrical length: The electrical length may be a ratio of a physical length (namely, a mechanical length or a geometric length) to a wavelength of a transmitted electromagnetic wave, and the electrical length may satisfy the following formula:

$$\overline{L} = \frac{L}{λ} ;$$

L is the physical length, and λ is the wavelength of the electromagnetic wave.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz. In this case, an operating wavelength may be a wavelength calculated based on the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiation signal in the air may be calculated as follows: (air wavelength or vacuum wavelength)=speed of light/frequency, where the frequency is a frequency (MHz) of the radiation signal, and the speed of light may be 3×10⁸ m/s. A wavelength of the radiation signal in a dielectric may be calculated as follows: dielectric wavelength=(speed of light/\sqrt{ε})/frequency, where ε is a relative dielectric constant of the dielectric. The wavelength in embodiments of this application is usually a dielectric wavelength, and may be a dielectric wavelength corresponding to a center frequency of a resonance frequency, or a dielectric wavelength corresponding to a center frequency of an operating frequency band supported by an antenna. For example, it is assumed that a center frequency of a B1 uplink frequency band (with a resonance frequency ranging from 1920 MHz to 1980 MHz) is 1955 MHz. In this case, a wavelength may be a dielectric wavelength calculated based on the frequency of 1955 MHz. The “dielectric wavelength” is not limited to the center frequency, and may alternatively be a dielectric wavelength corresponding to a non-center frequency of the resonance frequency or the operating frequency band. For ease of understanding, the dielectric wavelength mentioned in embodiments of this application may be simply calculated based on a relative dielectric constant of a dielectric filled in one or more sides of a radiator.

Total efficiency of an antenna: The total efficiency of the antenna is a ratio of input power to output power at an antenna port.

Radiation efficiency of an antenna: The radiation efficiency of the antenna is a ratio of power radiated by the antenna to space (namely, power that is effectively converted into an electromagnetic wave) to active power input to the antenna. Herein, active power input to the antenna=input power of the antenna-loss power. The loss power mainly includes return loss power and metal ohmic loss power and/or dielectric loss power. The radiation efficiency is a value for measuring a radiation capability of the antenna. Both a metal loss and a dielectric loss are factors that affect the radiation efficiency.

A person skilled in the art may understand that efficiency is usually indicated by a percentage, and there is a corresponding conversion relationship between the efficiency and dB. Efficiency closer to o dB indicates better efficiency of the antenna.

Antenna return loss: The antenna return loss may be understood as a ratio of power of a signal reflected back to an antenna port through an antenna circuit to transmit power of the antenna port. A smaller reflected signal indicates a larger signal radiated by an antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one of the S parameters. S11 indicates a reflection coefficient, and the parameter can indicate quality of transmit efficiency of the antenna. The S11 parameter is usually a negative number. A smaller S11 parameter indicates a smaller antenna return loss, less energy reflected back by the antenna, namely, more energy that actually enters the antenna, and higher total efficiency of the antenna. A larger S11 parameter indicates a larger antenna return loss and lower total efficiency of the antenna.

It should be noted that an S11 value of −6 dB is usually used as a standard in engineering. When an S11 value of the antenna is less than −6 dB, it may be considered that the antenna can operate normally, or it may be considered that transmit efficiency of the antenna is high.

Antenna pattern: The antenna pattern is also referred to as a radiation pattern, is a pattern in which relative field strength (a normalized modulus value) of a radiation field of an antenna changes with a direction at a specific distance from the antenna (a far field), and is usually represented by two plane patterns that are perpendicular to each other in a maximum radiation direction of the antenna.

The antenna pattern usually includes a plurality of radiation beams. A radiation beam with highest radiation intensity is referred to as a main lobe, and the other radiation beams are referred to as minor lobes or side lobes. In the minor lobes, a minor lobe in an opposite direction of the main lobe is also referred to as a back lobe.

Directivity coefficient: The directivity coefficient is also referred to as directionality of an antenna. The directivity coefficient is a ratio of a maximum power density to an average value in an antenna pattern at a specific distance from the antenna (a far field), is a dimensionless ratio greater than or equal to 1, and may indicate an energy radiation characteristic of the antenna. A larger directivity coefficient indicates a larger proportion of energy radiated by the antenna in a direction, and more concentrated energy radiation.

Antenna gain: The antenna gain represents a degree to which the antenna intensively radiates input power. Usually, a narrower main lobe of the antenna pattern indicates a smaller minor lobe, and a higher antenna gain.

Polarization direction of an antenna: At a given point in space, electric field strength E (a vector) is a function of time t. A vector endpoint periodically depicts a trajectory in space over time. That the trajectory is a straight line and perpendicular to the ground is referred to as vertical polarization. That the trajectory is horizontal to the ground is referred to as horizontal polarization. That the trajectory is an ellipse or a circle and rotates right-handed or clockwise over time when viewed in a propagation direction is referred to as right-hand circular polarization (RHCP). That the trajectory is an ellipse or a circle and rotates left-handed or counter-clockwise over time when viewed in a propagation direction is referred to as left-hand circular polarization (LHCP).

Ground (Ground plane) (GND): The ground (the ground plane) may generally be at least a part of any ground layer, ground plate, ground metal layer, or the like in an electronic device (for example, a mobile phone), or at least a part of any combination of any ground layer, ground plate, ground component, or the like. The “ground” may be configured to ground a component in the electronic device. In an embodiment, the “ground” may be a ground layer of a circuit board of the electronic device, or may be a ground plate formed by a middle frame of the electronic device, or a ground metal layer formed by a metal film below a screen of the electronic device. In an embodiment, the circuit board may be a printed circuit board (printed circuit board, PCB), for example, an 8-layer, 10-layer, or 12-layer to 14-layer board with 8, 10, 12, 13, or 14 layers of conductive materials, or an element that is separated and electrically insulated by a dielectric layer or an insulation layer, for example, a glass fiber or a polymer. In an embodiment, the circuit board includes a dielectric substrate, a ground layer, and a trace layer. The trace layer and the ground layer are electrically connected through a via. In an embodiment, components such as a display, a touchscreen, an input button, a transmitter, a processor, a memory, a battery, a charging circuit, and a system-on-chip (system on chip, SoC) structure may be mounted on or connected to the circuit board, or electrically connected to the trace layer and/or the ground layer in the circuit board. For example, a radio frequency source is disposed on the trace layer.

Any of the foregoing ground layers, or ground plates, or ground metal layers is made of conductive materials. In an embodiment, the conductive material may be any one of the following materials: copper, aluminum, stainless steel, brass and an alloy thereof, copper foil on an insulation substrate, aluminum foil on the insulation substrate, gold foil on the insulation substrate, silver-plated copper, silver-plated copper foil on the insulation substrate, silver foil on the insulation substrate, tin-plated copper, cloth impregnated with graphite powder, a graphite-coated substrate, a copper-plated substrate, a brass-plated substrate, and an aluminum-plated substrate. A person skilled in the art may understand that the ground layer/ground plate/ground metal layer may alternatively be made of other conductive materials.

Grounding: The grounding means coupling with the ground/ground plane in any manner. In an embodiment, grounding may be grounding via an entity, for example, grounding via an entity (or referred to as entity grounding) at a specific position on a side frame is implemented via some mechanical members of a middle frame. In an embodiment, grounding may be grounding via a component, for example, grounding via a component (or referred to as component grounding) like a capacitor/inductor/resistor connected in series or in parallel.

The following describes technical solutions of embodiments in this application with reference to accompanying drawings.

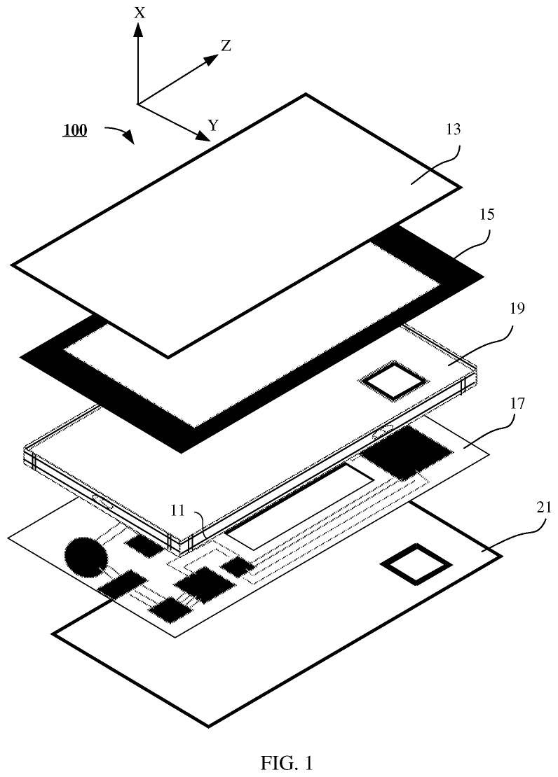

As shown in FIG. 1, an electronic device 100 may include a cover (cover) 13, a display/module 15, a printed circuit board (printed circuit board, PCB) 17, a middle frame 19, and a rear cover 21. It should be understood that, in some embodiments, the cover 13 may be cover glass or may be replaced with a cover made of another material, for example, a cover made of a polyethylene terephthalate (Polyethylene terephthalate, PET) material.

The cover 13 may be tightly attached to the display module 15, and may be mainly configured to protect the display module 15 and prevent the display module 15 from dust.

In an embodiment, the display module 15 may include a liquid crystal display (LCD) panel, a light-emitting diode (LED) display panel, an organic light-emitting semiconductor (OLED) display panel, or the like. This is not limited in embodiments of this application.

The middle frame 19 is mainly used to support the entire electronic device. FIG. 1 shows that the PCB 17 is disposed between the middle frame 19 and the rear cover 21. It should be understood that, in an embodiment, the PCB 17 may alternatively be disposed between the middle frame 19 and the display module 15. This is not limited in embodiments of this application. The printed circuit board PCB 17 may be a flame-resistant material (FR-4) dielectric board, or may be a Rogers (Rogers) dielectric board, or may be a hybrid dielectric board of Rogers and FR-4, or the like. Herein, FR-4 is a grade designation for a flame-resistant material, and the Rogers dielectric board is a high-frequency board. An element, for example, a radio frequency chip, is carried on the PCB 17. In an embodiment, a metal layer may be disposed on the printed circuit board PCB 17. The metal layer may be configured to ground the element carried on the printed circuit board PCB 17, or may be configured to ground another element, for example, a bracket antenna or a side frame antenna. The metal layer may be referred to as a ground plane, a ground plate, or a ground layer. In an embodiment, the metal layer may be formed by etching metal on a surface of any dielectric board in the PCB 17. In an embodiment, the metal layer configured for grounding may be disposed on a side that is of the printed circuit board PCB 17 that is close to the middle frame 19. In an embodiment, an edge of the printed circuit board PCB 17 may be considered as an edge of the ground layer of the PCB 17. In an embodiment, the metal middle frame 19 may also be configured to ground the foregoing element. The electronic device 100 may further have another ground plane/ground plate/ground layer. As described above, details are not described herein again.

Due to internal compactness of the electronic device, a ground plane/ground plate/ground layer (for example, a printed circuit board, a middle frame, a screen metal layer, and a battery may all be considered as a part of the ground plane) is usually disposed in internal space 0 mm to 2 mm away from an inner surface of the side frame. In an embodiment, a dielectric is filled between the side frame and the ground plane. A length and a width of a rectangle enclosed by an inner surface contour of the filled dielectric may be simply considered as a length and a width of the ground plane. Alternatively, a length and a width of a rectangle enclosed by a contour formed by superposing all conductive parts inside the side frame may be considered as a length and a width of the ground plane.

The electronic device 100 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a mainboard and a subboard. The battery may be disposed between the mainboard and the subboard. The mainboard may be disposed between the middle frame 19 and an upper edge of the battery, and the subboard may be disposed between the middle frame 19 and a lower edge of the battery.

The electronic device 100 may further include a side frame 11. The side frame 11 may be made of a conductive material like metal. The side frame 11 may be disposed between the display module 15 and the rear cover 21, and circumferentially extends around a periphery of the electronic device 100. The side frame 11 may have four sides surrounding the display module 15, to help fasten the display module 15.

In an implementation, the side frame 11 mainly including a conductive material may be referred to as a conductive side frame or a metal side frame of the electronic device 100, and is applicable to a metal industrial design (industrial design, ID). In an implementation, an outer surface of the side frame 11 is mainly made of a conductive material, for example, a metal material, to form an appearance of a metal side frame. In these implementations, the conductive part that is of the side frame 11 and that includes the outer surface may serve as a radiator of an antenna of the electronic device 100, and is usually referred to as a side frame antenna.

In another implementation, an outer surface of the side frame 11 is mainly made of a non-conductive material, for example, plastic, to form an appearance of a non-metal side frame, and is applicable to a non-metal ID. In an implementation, an inner surface of the side frame 11 may include a conductive material, for example, a metal material. In this implementation, the conductive part of the inner surface of the side frame 11 may serve as a radiator of an antenna of the electronic device 100. It should be understood that, the radiator (or the conductive material on the inner surface) disposed on the inner surface of the side frame 11 may be disposed close to the non-conductive material of the side frame 11, to minimize a volume occupied by the radiator, and be closer to the outside of the electronic device 100, thereby implementing better signal transmission effect. The radiator may also be referred to as a side frame antenna. It should be noted that, disposing the radiator of the antenna close to the non-conductive material of the side frame 11 means that the radiator of the antenna may be disposed close to an inner surface of the non-conductive material, or may be embedded into the non-conductive material, or may be disposed close to an inner surface of the non-conductive material. For example, there may be a specific small slot between the radiator of the antenna and the inner surface of the non-conductive material. It should be understood that both the conductive material and the non-conductive material may be considered as a part of the side frame 11.

It should be understood that the side frame 11 may have insulation slots, and a conductor part of the side frame between the insulation slots, and/or between the insulation slot and a ground point serves as a radiator, so as to form a side frame antenna (it should be understood that the radiator of the side frame antenna may also include a conductor part of the side frame between ground points). When the side frame 11 is made of a conductive material such as metal, the insulation slot may be understood as that a slot provided in the side frame 11 is filled with a non-metal material (insulation material). In this case, the slot is visible on an appearance surface. When the outer surface of the side frame 11 is made of a non-conductive material, the insulation slot may be understood as an end part (for example, an end part that is not electrically connected to another radiator or a conductor) of the radiator on the inner surface of the side frame 11, or may be understood as a slot formed between radiators on the inner surface of the side frame 11, and a non-metal material (an insulation material) may be disposed in the slot, or may not be disposed, for example, filled with air. In this case, the slot is invisible on the appearance surface.

The middle frame 19 may include the side frame 11, and the middle frame 19 including the side frame 11 is used as an integrated part, and may support an electronic component in the entire device. The cover 13 and the rear cover 21 are respectively closed along an upper edge and a lower edge of the side frame, to form a casing or a housing (housing) of the electronic device. In an embodiment, the cover 13, the rear cover 21, the side frame 11, and/or the middle frame 19 may be collectively referred to as a casing or a housing of the electronic device 100. It should be understood that the “casing or housing” may mean a part or all of any one of the cover 13, the rear cover 21, the side frame 11, and the middle frame 19, or mean a part or all of any combination of the cover 13, the rear cover 21, the side frame 11, and the middle frame 19.

At least a part of the side frame 11 may serve as a radiator of an antenna to transmit/receive a radio frequency signal. A gap may exist between the part of the side frame that serves as the radiator and another part of the middle frame 19, to ensure that the radiator of the antenna has a good radiation environment. In an embodiment, the middle frame 19 may be provided with an aperture at the part of the side frame that serves as the radiator, to facilitate radiation of the antenna.

Alternatively, the side frame 11 may not be considered as a part of the middle frame 19. In an embodiment, the side frame 11 may be connected to and integrally formed with the middle frame 19. In another embodiment, the side frame 11 may include a protruding part extending inward, to be connected to the middle frame 19, for example, connected via a spring or a screw, or connected through welding. The protruding part of the side frame 11 may be further configured to receive a feed signal, so that at least a part of the side frame 11 serves as a radiator of an antenna to receive/transmit a radio frequency signal. A gap may exist between the middle frame 19 and the part of the side frame that serves as the radiator, to ensure that the radiator of the antenna has a good radiation environment, and the antenna has a good signal transmission function.

The rear cover 21 may be a rear cover made of a metal material, or may be a rear cover made of a non-conductive material, for example, may be a non-metal rear cover like a glass rear cover and a plastic rear cover, or may be a rear cover made of both a conductive material and a non-conductive material. In an embodiment, the rear cover 21 including the conductive material may replace the middle frame 19, and serves as an integrated part with the side frame 11, to support an electronic component in the entire device.

In an embodiment, the middle frame 19 and/or a conductive part of the rear cover 21 may serve as a reference ground of the electronic device 100. The side frame 11, the PCB 17, and the like of the electronic device may be electrically connected to the middle frame for grounding.

The antenna of the electronic device 100 may be further disposed in the casing, for example, a bracket antenna or a millimeter wave antenna (not shown in FIG. 1). Clearance of the antenna disposed in the housing may be obtained through a slit/hole in any one of the middle frame, and/or the side frame, and/or the rear cover, and/or the display, or through a non-conductive slot/aperture formed between any several of the middle frame, and/or the side frame, and/or the rear cover, and/or the display. The clearance of the antenna may be provided, to ensure a radiation characteristic of the antenna. It should be understood that the clearance of the antenna may be a non-conductive area formed by any conductive member in the electronic device 100, and the antenna radiates a signal to external space through the non-conductive area. In an embodiment, a form of the antenna 40 may be an antenna form based on a flexible mainboard (flexible printed circuit, FPC), an antenna form based on laser-direct-structuring (laser-direct-structuring, LDS), or an antenna form like a microstrip antenna (microstrip disk antenna, MDA). In an embodiment, the antenna may alternatively use a transparent structure embedded into a screen of the electronic device 100, so that the antenna is a transparent antenna element embedded into the screen of the electronic device 100.

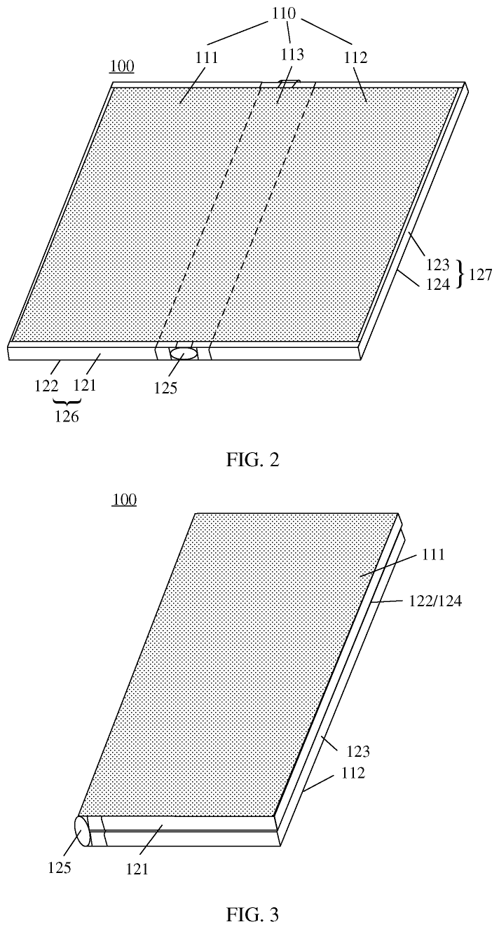

FIG. 2 is a diagram of a structure of a foldable electronic device 100 according to an embodiment of this application. The foldable electronic device 100 may be an electronic device having a folding function, for example, a mobile phone, a tablet computer, an e-reader, a notebook computer, or a wearable device such as a watch. The embodiment shown in FIG. 2 is described by using a foldable mobile phone as an example.

It should be understood that FIG. 1 shows only the electronic device 100 including one housing (for example, the middle frame 19). In actual production or design, the electronic device 100 may alternatively include a plurality of housings to form the foldable electronic device 100.

As shown in FIG. 2, the foldable electronic device 100 may include a flexible display 110 (which may correspond to the display module 15 in FIG. 1), a first side frame 121 (which may correspond to the side frame 11 in FIG. 1), a first cover body 122, a second side frame 123 (which may correspond to the side frame 11 in FIG. 1), a second cover body 124, and a rotating shaft 125. In some embodiments, the first side frame 121, the first cover body 122, the second side frame 123, and the second cover body 124 may form a first housing 126 (which may correspond to the middle frame 19 in FIG. 1) and a second housing 127 (which may correspond to the middle frame 19 in FIG. 1) that support the flexible display 110. In some other embodiments, at least one of the first cover body 122 and the second cover body 124 may include a display.

A lattice pattern filled in FIG. 2 may schematically represent the flexible display 110. The flexible display 110 may have features of strong flexibility and bendability, and may provide a user with a new bendability-based interaction mode.

The flexible display 110 may include a first display part 111 corresponding to the first housing 126, a second display part 112 corresponding to the second housing 127, and a foldable display part 113 corresponding to the rotating shaft 125. The foldable display part 113 may be connected between the first display part 111 and the second display part 112.

The first side frame 121 may surround a periphery of the first cover body 122, and at least a part of the first side frame 121 may further surround a periphery of the first display part 111. The first display part 111 and the first cover body 122 may be spaced from each other in parallel, and the first display part 111 and the first cover body 122 may be located on two sides of the first side frame 121. Space between the first display part 111 and the first cover body 122 may be provided with a component of the foldable electronic device 100, for example, an antenna or a circuit board component.

The second side frame 123 may surround a periphery of the second cover body 124, and at least a part of the second side frame 123 may further surround a periphery of the second display part 112. The second display part 112 and the second cover body 124 may be spaced from each other in parallel, and the second display part 112 and the second cover body 124 may be located on two sides of the second side frame 123. Space between the second display part 112 and the second cover body 124 may be provided with a component of the foldable electronic device 100, for example, an antenna or a circuit board component.

In an embodiment provided in this application, the cover body and the side frame may be two parts of the housing of the foldable electronic device 100. The cover body and the side frame may be connected, and a form of the connection may not belong to an assembly manner such as clamping, bonding, welding, riveting, or clearance fit. A connection relationship between the cover body and the side frame is usually difficult to divide. In another embodiment provided in this application, the cover body and the side frame may be two different parts. The housing of the foldable electronic device 100 may be formed by assembling the cover body and the side frame.

The rotating shaft 125 may be connected between the first housing 126 and the second housing 127. Under an action of the rotating shaft 125, the first housing 126 and the second housing 127 may be close to or far away from each other. Correspondingly, the first display part 111 of the flexible display 110 and the second display part 112 of the flexible display 110 may be close to or far away from each other, so that the flexible display 110 may be folded or unfolded.

In an example, the rotating shaft 125 may include, for example, a main shaft, a first connection component, and a second connection component. The first connection component may be fastened to the first cover body 122, the second connection component may be fastened to the second cover body 124, and the first connection component and the second connection component may rotate relative to the main shaft. Mutual movement between the first connection component and the second connection component may drive mutual movement between the first housing 126 and the second housing 127, to implement folding and unfolding functions of the foldable electronic device 100.

The foldable electronic device 100 shown in FIG. 2 is currently in a possible unfolded state. In this unfolded state, an angle between the first housing 126 and the second housing 127 may be 180°, or may be referred to as a flattened state. The flexible display 110 may be in the flattened state shown in FIG. 2.

That the flexible display 110 is in the flattened state may be understood as that an angle between the first display part 111 corresponding to the first housing 126 and the second display part 112 corresponding to the second housing 127 is 180. Because there may be a specific error in engineering implementation, when the angle between the first display part 111 and the second display part 112 is between 170° and 190°, it may be considered that the flexible display 110 is in the flattened state.

FIG. 3 shows a possible folded state of the foldable electronic device 100. FIG. 3 shows an outward folded state (the outward folded state may be referred to as an outward-folded state for short) of the foldable electronic device 100. The outward folded state shown in FIG. 3 may be, for example, a left-right outward folded state or a top-down outward folded state. With reference to FIG. 2 and FIG. 3, the following describes a possible folded state of the foldable electronic device 100.

In this embodiment of this application, that the foldable electronic device 100 is in a folded state may mean that the foldable electronic device 100 is currently bent, and the foldable electronic device 100 reaches a maximum bending degree. In this case, the first cover body 122 and the second cover body 124 may be approximately parallel to each other, spaced from each other, or provided face to face. In addition, a spacing distance between the first cover body 122 and the second cover body 124 is minimal, and at least a part of the first housing 126 and at least a part of the second housing 127 are accommodated in space enclosed by the flexible display 110. The first display part 111, the first housing 126, the second housing 127, and the second display part 112 are sequentially stacked. Similarly, the first display part 111 and the second display part 112 may be approximately parallel to each other, and are spaced from each other. A spacing distance between the first cover body 122 and the second cover body 124 is less than a spacing distance between the first display part 111 and the second display part 112. In this case, the first display part 111 and the second display part 112 may be considered to be located on different planes.

With reference to FIG. 2 and FIG. 3, when the foldable electronic device 100 is in the outward-folded state, the first cover body 122 and the second cover body 124 may be close to each other, and the first display part 111 and the second display part 112 may be close to each other. The first display part 111, the second display part 112, and the foldable display part 113 may form a housing area used to accommodate the first cover body 122, the second cover body 124, and the rotating shaft 125. That is, the first cover body 122, the second cover body 124, and the rotating shaft 125 may be accommodated in space between the first display part 111 and the second display part 112.

It should be understood that the foldable electronic device 100 may be folded inward (the inward folded state may be referred to as an inward-folded state for short). When the foldable electronic device 100 is in the inward-folded state, the first cover body 122 and the second cover body 124 may be close to each other, and the first display part 111 and the second display part 112 may be close to each other. The first cover body 122, the second cover body 124, and the rotating shaft 125 may form a housing area used to accommodate the first display part 111, the second display part 112, and the foldable display part 113. In other words, the first display part 111, the second display part 112, and the foldable display part 113 may be accommodated in space between the first cover body 122 and the second cover body 124.

The foldable electronic device 100 may be switched between a folded state and an unfolded state. When the foldable electronic device 100 is in the folded state, space occupied by the foldable electronic device 100 is small. When the foldable electronic device 100 is in the unfolded state, the foldable electronic device 100 may display a large screen, to increase a viewable range of a user. It should be understood that the folded state includes a closed state, and in this case, the foldable electronic device 100 occupies minimum space. The unfolded state includes a flattened state, and in this case, the foldable electronic device 100 occupies maximum space.

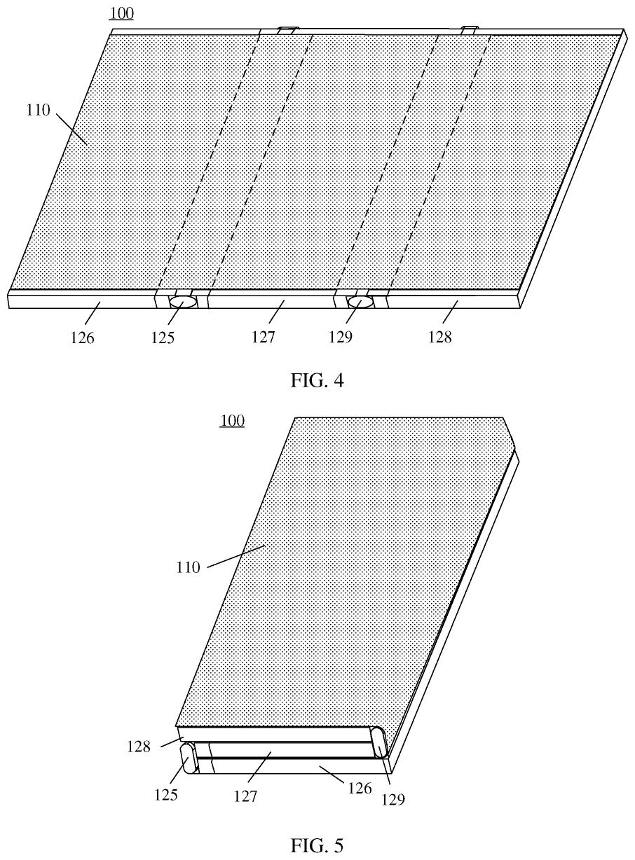

The foldable electronic device 100 may further include a third housing 128 and a rotating shaft 129, as shown in FIG. 4. The rotating shaft 129 may be connected between the third housing 128 and the second housing 127. The third housing 128 and the second housing 127 may be close to or far away from each other. As a quantity of foldable parts of the foldable electronic device 100 increases, in a case in which a same screen size is maintained in the unfolded state, space occupied by the foldable electronic device 100 may be further reduced in the folded state.

However, the foldable electronic device 100 shown in FIG. 4 has three foldable parts (the first housing 126, the second housing 127, and the third housing 128). Therefore, the foldable electronic device 100 has at least three forms: 1. an unfolded state, 2. a folded state, and 3. a partially-unfolded state.

1. FIG. 4 shows a possible unfolded state of the foldable electronic device 100. In the unfolded state, angles among the first housing 126, the second housing 127, and the third housing 128 may be about 180°. The flexible display 110 may be in the unfolded state.

2. FIG. 5 shows a possible folded state (a triple-fold state) of the foldable electronic device 100. In the folded state, the first housing 126 and the second housing 127 rotate along the rotating shaft 125, and the second housing 127 and the third housing 128 rotate along the rotating shaft 129, so that the foldable electronic device 100 reaches a maximum bending degree. In this case, the first housing 126, the second housing 127, and the third housing 128 may be considered to be located on different planes.

It should be understood that, for brief description, in the structure shown in FIG. 5, the foldable electronic device 100 is in an S-folded state (a side surface of the foldable electronic device 100 is S-shaped, and the second housing 127 is located between the first housing 126 and the third housing 128). In an embodiment, the foldable electronic device 100 may also be in a G-folded state (a side surface of the foldable electronic device 100 is G-shaped, and the third housing 128 is located between the first housing 126 and the second housing 127). The folded state of the foldable electronic device 100 is not limited in this embodiment of this application.

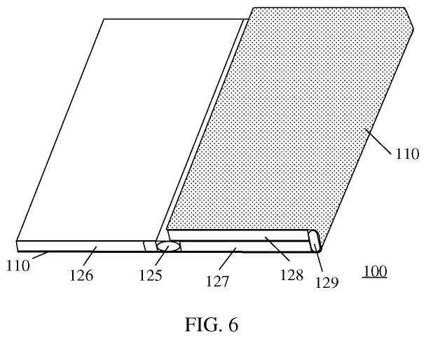

3. FIG. 6 shows a possible partially-unfolded state (a two-folded state) of the foldable electronic device 100. In a partially-unfolded state, an angle between the first housing 126 and the second housing 127 may be about 180°, and the second housing 127 and the third housing 128 rotate along the rotating shaft 129, so that the third housing 128 approaches the second housing 127. In this case, the first housing 126 and the second housing 127 are considered to be located on a same plane, and the second housing 127 and the third housing 128 may be considered to be located on different planes. In another possible partially-unfolded state, an angle between the third housing 128 and the second housing 127 may be about 180°, and the first housing 126 and the second housing 127 rotate along the rotating shaft 125, so that the first housing 126 approaches the second housing 127.

FIG. 1 and FIG. 2 show only some components included in the electronic device 10 and the foldable electronic device 100. Actual shapes, actual sizes, and actual structures of these components are not limited by the foregoing accompanying drawings.

It should be understood that, in embodiments of this application, it may be considered that a surface on which the display of the electronic device is located is a front surface, a surface on which the rear cover is located is a rear surface, and a surface on which the side frame is located is a side surface.

It should be understood that, in embodiments of this application, it is considered that when a user holds the electronic device (the user usually holds the electronic device vertically and faces the screen), an orientation in which the electronic device is located has a top part, a bottom part, a left part, and a right part. It should be understood that, in embodiments of this application, it is considered that when the user holds the electronic device (the user usually holds the electronic device vertically and faces the screen), the orientation in which the electronic device is located has the top part, the bottom part, the left part, and the right part.

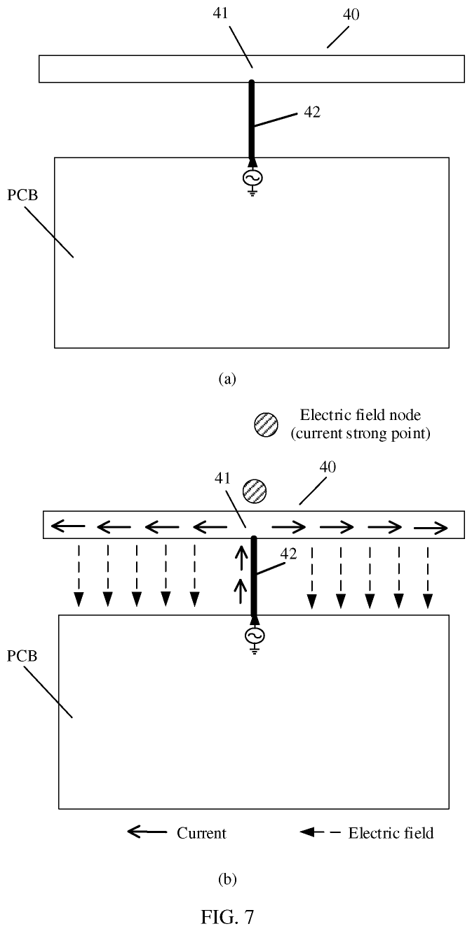

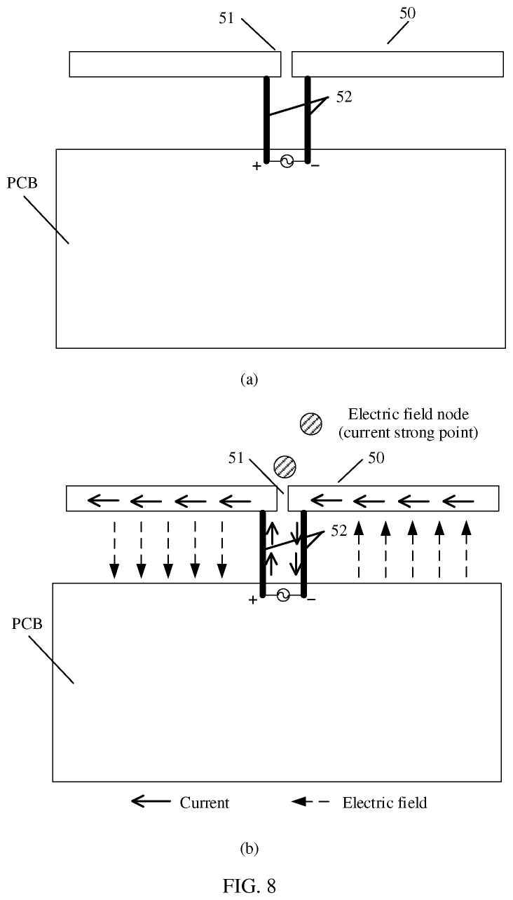

First, FIG. 7 and FIG. 8 are used to describe two antenna modes in this application. FIG. 7 is a diagram of a structure of an antenna in a common mode and distribution of corresponding currents and electric fields according to this application. FIG. 8 is a diagram of a structure of another antenna in a differential mode and distribution of corresponding currents and electric fields according to this application. Two ends of a radiator of an antenna in FIG. 7 and FIG. 8 are open, and a common mode and a differential mode of the radiator of antenna may be respectively referred to as a wire common mode and a wire differential mode.

It should be understood that the “common mode” or the “CM mode” in this application includes a wire common mode and a slot common mode, and the “differential mode” or the “DM mode” in this application includes a wire differential mode and a slot differential mode, which may be determined based on a structure of an antenna.

It should be understood that a “common-differential mode” or a “CM-DM mode” in this application is a wire common mode and a wire differential mode that are generated on a same radiator, or is a slot common mode and a slot differential mode that are generated on a same radiator, and may be determined based on a structure of an antenna.

### 1. Wire (Wire) Common Mode (Common Mode, CM)

Herein, (a) in FIG. 7 shows that two ends of a radiator of an antenna 40 are open, and a feed circuit (not shown in the figure) is connected to a middle position 41. In an embodiment, the antenna 40 adopts a symmetrical feed (symmetrical feed) form. The feed circuit may be connected at the middle position 41 of the antenna 40 through a feeder 42. It should be understood that symmetrical feed may be understood as that one end of the feed circuit is connected to the radiator and the other end of the feed circuit is coupled to a ground plane for grounding. A connection point (feed point) between the feed circuit and the radiator is located in a center of the radiator. The center of the radiator may be, for example, a midpoint of a geometric structure, or a midpoint of an electrical length (or an area in a specific range near the midpoint).

The middle position 41 of the antenna 40 may be, for example, a geometric center of the antenna, or the midpoint of the electrical length of the radiator. For example, a joint between the feeder 42 and the antenna 40 covers the middle position 41.

Herein, (b) in FIG. 7 shows distribution of currents and electric fields of the antenna 40. As shown in (b) in FIG. 7, the currents are reversely distributed, for example, symmetrically distributed, on two sides of the middle position 41. Electric fields are co-directionally distributed on the two sides of the middle position 41. As shown in (b) in FIG. 7, the currents are co-directionally distributed at the feeder 42. Based on co-directional current distribution at the feeder 42, such feed shown in (a) in FIG. 7 may be referred to as wire CM feed. Based on reverse current distribution on two sides of a joint between the radiator and the feeder 42, such an antenna mode shown in (b) in FIG. 7 may be referred to as a wire CM mode (which may also be briefly referred to as a CM mode, for example, for a wire antenna, the CM mode is the wire CM mode). The current and the electric field shown in (b) in FIG. 7 may be respectively referred to as a current and an electric field in the wire CM mode.

The currents are stronger at the middle position 41 of the antenna 40 (a current strong point is located near the middle position 41 of the antenna 40), and are weaker at two ends of the antenna 40, as shown in (b) in FIG. 7. The electric fields are weaker at the middle position 41 of the antenna 40, and are stronger at the two ends of the antenna 40.

### 2. Wire Differential Mode (Differential Mode, DM)

As shown in (a) in FIG. 8, a left end and a right end of each of two radiators of an antenna 50 are open ends, and a feed circuit is connected to a middle position 51. In an embodiment, the antenna 50 adopts an anti-symmetrical feed (anti-symmetrical feed) form. One end of the feed circuit is connected to one of the radiators through a feeder 52, and the other end of the feed circuit is connected to the other radiator through the feeder 52. The middle position 51 may be a geometric center of the antenna 50, or a slot formed between the radiators.

It should be understood that, “central anti-symmetrical feed” mentioned in this application may be understood as that a positive electrode and a negative electrode of a feed unit are respectively connected to two connection points near a midpoint of the radiators. In an embodiment, signals output from the positive and negative electrodes of the feed unit have a same amplitude but opposite phases. For example, a phase difference is 180°+10°.

Herein, (b) in FIG. 8 shows distribution of currents and electric fields of the antenna 50. As shown in (b) in FIG. 8, currents are co-directionally distributed, for example, anti-symmetrically distributed, on two sides of the middle position 51 of the antenna 50. Electric fields are reversely distributed on the two sides of the middle position 51. As shown in (b) in FIG. 8, the currents are reversely distributed at the feeder 52. Based on reverse current distribution at the feeder 52, such feed shown in (a) in FIG. 8 may be referred to as wire DM feed. Based on co-directional current distribution on two sides of a joint between the radiator and the feeder 52, such an antenna mode shown in (b) in FIG. 8 may be referred to as a wire DM mode (which may also be briefly referred to as a DM mode, for example, for a wire antenna, the DM mode is the wire DM mode). The current and the electric field shown in (b) in FIG. 8 may be respectively referred to as a current and an electric field in the wire DM mode. It should be understood that, based on co-directional current distribution on the two sides of the joint between the radiator and the feeder 52, such an antenna mode shown in (b) in FIG. 8 may also be referred to as a one-half antenna mode or a one-half-wavelength mode, or may be referred to as a one-half mode for short.

In an embodiment, in the wire DM mode or the one-half mode, the currents are stronger at the middle position 51 of the antenna 50 (a current strong point is near the middle position 51 of the antenna 50), and are weaker at two ends of the antenna 50, as shown in (b) in FIG. 8. The electric fields are weaker at the middle position 51 of the antenna 50, and are stronger at the two ends of the wire antenna 50.

It should be understood that the radiator of the antenna may be understood as a metal mechanical member that generates radiation, and there may be one radiator of the antenna, as shown in FIG. 7, or there may be two radiators of the antenna, as shown in FIG. 8, which may be adjusted based on an actual design or production requirement. For example, for the wire CM mode, the two radiators may alternatively be used, as shown in FIG. 8. Two ends of the two radiators are oppositely disposed and are spaced from each other by a slot. A symmetrical feed manner is used at the two ends that are close to each other. For example, effect similar to that of the antenna structure shown in FIG. 7 may also be achieved by separately feeding a same feed signal into the two ends that are of the two radiators and that are close to each other. Correspondingly, for the wire DM mode, one radiator may alternatively be used, as shown in FIG. 7. Two feed points are disposed at a middle position of the radiator, and an anti-symmetrical feed manner is used. For example, effect similar to that of the antenna structure shown in FIG. 8 may also be achieved if signals of a same amplitude but opposite phases are respectively fed at the two symmetrical feed points on the radiator.

### 3. Wire CM-DM Mode

FIG. 7 and FIG. 8 respectively show that when two ends of a radiator are open, a wire CM mode and a wire DM mode are respectively generated in different feed manners.

When an antenna adopts an asymmetric feed form (including a side feed form and an offset feed form, where a feed point deviates from a middle position of the radiator), or a ground point (a position coupled to a ground plane) of the radiator is asymmetric (the ground point deviates from the middle position of the radiator), the antenna may generate both a first resonance and a second resonance, which respectively correspond to the wire CM mode and the wire DM mode. For example, the first resonance corresponds to the wire CM mode, and distribution of currents and electric fields is shown in (b) in FIG. 7. The second resonance corresponds to the wire DM mode, and distribution of currents and electric fields is shown in (b) in FIG. 8.

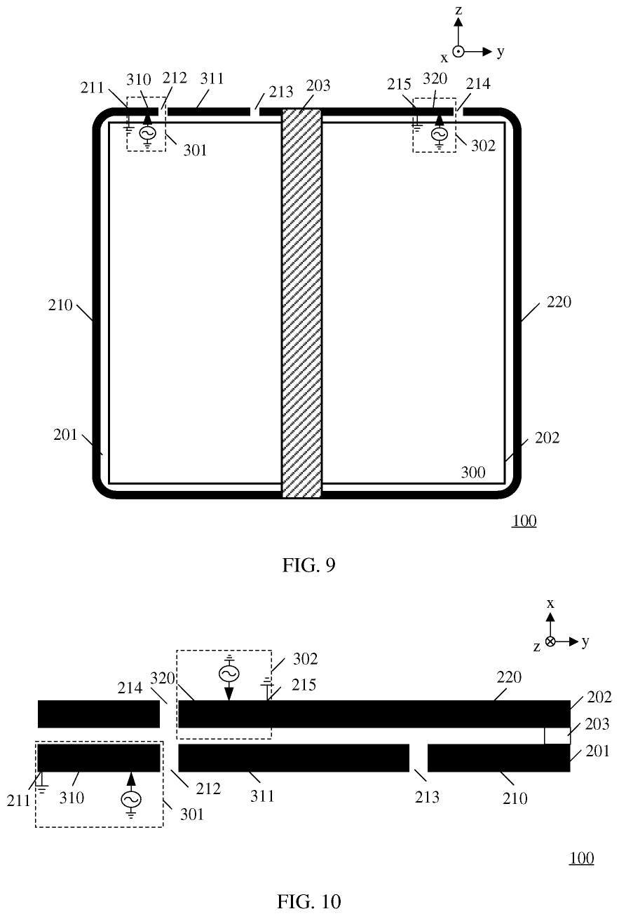

FIG. 9 is a diagram of an electronic device 100 according to an embodiment of this application.

It should be understood that, for brevity of description, only an example in which the electronic device 100 is a foldable electronic device and includes only the first housing 201 and the second housing 202 is used for description. The first housing 201 and the second housing 202 may be rotationally connected to a rotating shaft 203.

As shown in FIG. 9, the first housing 201 includes a first side frame 210. The second housing 202 includes a second side frame 220.

The electronic device 100 includes an antenna 301 and an antenna 302. The antenna 301 includes a radiator 310. The antenna 302 includes a radiator 320. Both the antenna 301 and the antenna 302 include a parasitic stub 311.

The radiator 310 is a conductive part of the first side frame 210 between a first position 211 and a second position 212. The parasitic stub 311 is a conductive part of the first side frame 210 between the second position 212 and a third position 213. The radiator 320 is a conductive part of the second side frame 220 between a fourth position 214 and a fifth position 215.

When the electronic device 100 is in a folded state, the parasitic stub 311 and the radiator 320 at least partially overlap in a first direction, as shown in FIG. 10. The first direction is a thickness direction of the electronic device 100, or may be a direction (for example, an x direction) perpendicular to a display when the electronic device 100 is in an unfolded state.

It should be understood that, when the electronic device 100 is in a folded state, and no parasitic stub 311 is disposed (the first side frame 210 is coupled to a ground plane 300 at the second position 212 and the third position 213), because there is a specific distance between the radiator 310 and the radiator 320, coupling between the radiator 310 and the radiator 320 is weaker, and isolation between the antenna 301 and the antenna 302 is better.

To improve radiation characteristics (for example, bandwidth and efficiency) of the antenna 301 and the antenna 302, the parasitic stub 311 is disposed near the radiator 310 and the radiator 320. However, when the electronic device 100 is in the folded state, both the radiator 310 and the radiator 320 may couple the parasitic stub 311 to generate co-directional currents (currents between the second position 212 and the third position 213 are co-directional). Because both the radiator 310 and the radiator 320 can generate the co-directional currents, coupling between the radiator 310 and the radiator 320 is enhanced, and isolation between the antenna 301 and the antenna 302 deteriorates.

Embodiments of this application provide an electronic device. The electronic device includes a first antenna and a second antenna. The first antenna uses a conductive part of a side frame of the first housing as a first radiator. The second antenna uses a conductive part of a side frame of the second housing as a second radiator. Both the first antenna and the second antenna can improve antenna radiation characteristics by using the parasitic stub. When the electronic device is in the folded state, there is good isolation between the first antenna and the second antenna, and the first antenna and the second antenna can simultaneously operate to improve communication performance of the electronic device.

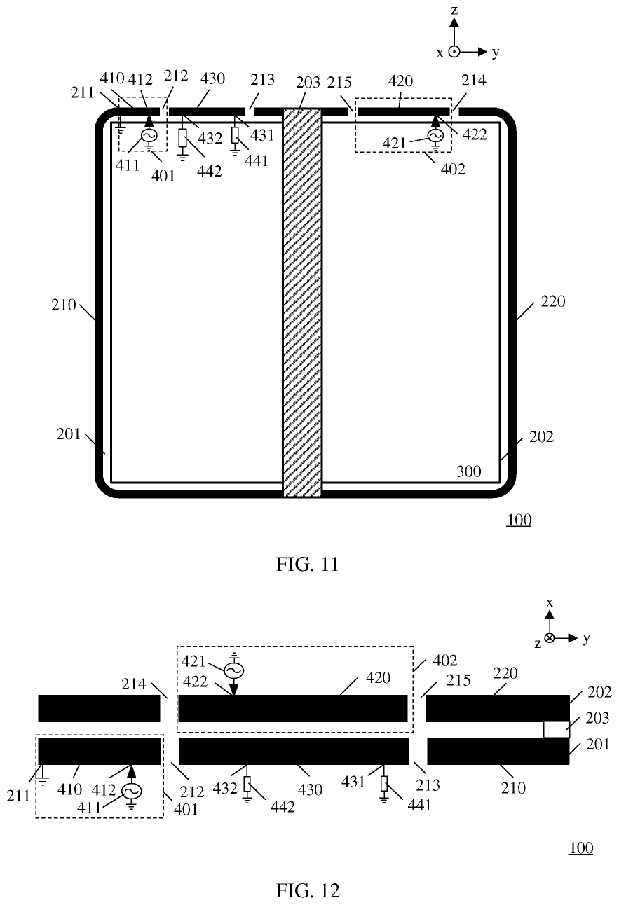

FIG. 11 is a diagram of an electronic device 100 according to an embodiment of this application.

It should be understood that the electronic device 100 in this embodiment of this application is merely a diagram, and shows only a structure of an area related to this embodiment of this application. In actual production or design, other areas may be adjusted. For example, a side frame (for example, a first side frame or a second side frame) has a plurality of insulation slots or is coupled to a ground plane at a plurality of points to form a radiator or a parasitic stub of another antenna. This is not limited in this embodiment of this application.

As shown in FIG. 11, the electronic device 100 may include a first housing 201, a second housing 202, a first rotating shaft 203, and a ground plane 300.

The first housing 201 includes a first side frame 210, and at least a part of the first side frame 210 and the ground plane 300 are spaced from each other. The second housing 202 includes a second side frame 220, and at least a part of the second side frame 220 and the ground plane 300 are spaced from each other.

The first rotating shaft 203 is located between the first housing 201 and the second housing 202, and the first rotating shaft 203 is rotatably connected to the first housing 201 and the second housing 202 separately, so that the first housing 201 and the second housing 202 can rotate relative to each other. In an embodiment, the ground plane 300 may include a first part and a second part. The first part may be located in the first housing 201, the second part may be located in the second housing 202, and the first part and the second part may be connected through the first rotating shaft 203.

It should be understood that, in the electronic device 100 shown in FIG. 11, the electronic device 100 is a foldable electronic device, and the first rotating shaft 203 is directly connected to the first housing 201 and the second housing 202 separately, so that the first housing 201 and the second housing 202 can rotate relative to each other. In addition, “the first rotating shaft 203 is rotatably connected to the first housing 201 and the second housing 202 separately” includes this case: The first rotating shaft 203 may be rotatably connected to the first housing or the second housing through one or more second rotating shafts and one or more intermediate housings. For example, in an embodiment, the electronic device 100 may further include a first rotating shaft, a second rotating shaft, and one or more intermediate housings located between the first rotating shaft and the second rotating shaft. The first rotating shaft is located between the first housing 201 and the intermediate housing, and the first rotating shaft is rotatably connected to the first housing 201 and the intermediate housing separately, so that the first housing 201 and the intermediate housing can rotate relative to each other. The second rotating shaft is located between the intermediate housing and the second housing 202, and the first rotating shaft 203 is rotatably connected to the intermediate housing and the second housing 202 separately, so that the intermediate housing and the second housing 202 can rotate relative to each other.

The first side frame 210 includes a first position 211, a second position 212, and a third position 213 that are sequentially disposed. The first side frame 210 is provided with a first insulation slot and a second insulation slot at the second position 212 and the third position 213 respectively. The first side frame 210 is coupled to the ground plane 300 or has an insulation slot at the first position 211.

The second side frame 220 includes a fourth position 214 and a fifth position 215. The second side frame 220 and the ground plane 300 have a third insulation slot at the fourth position 214. The second side frame 220 is coupled to the ground plane 300 or has an insulation slot at the fifth position 215. The electronic device 100 includes a first antenna 401 and a second antenna 402.

The first antenna 401 includes a first radiator 410 and a first feed circuit 411. The first radiator 410 includes a conductive part of the first side frame 210 between the first position 211 and the second position 212. At least a part of the first radiator 410 and the ground plane 300 are spaced from each other. The first radiator 410 includes a first feed point 412. The first feed circuit 411 is coupled to the first feed point 412 to feed a radio frequency signal of a first frequency band.

The second antenna 402 includes a second radiator 420 and a second feed circuit 421. The second radiator 420 includes a conductive part of the second side frame 220 between the fourth position 214 and the fifth position 215. At least a part of the second radiator 420 and the ground plane 300 are spaced from each other. The second radiator 420 includes a second feed point 422. The second feed circuit 421 is coupled to the second feed point 422 to feed a radio frequency signal of a second frequency band.

In an embodiment, when the electronic device 100 is in a folded state, a distance between the second position 212 and the fourth position 214 is less than a distance between the second position 212 and the fifth position 215.

It should be understood that an open end of the second radiator 420 may be disposed close to the first radiator 410. An open end of the first radiator 410 is close to the open end of the second radiator 420, there is a stronger electric field in an area near the open end, and there is stronger coupling between the first antenna 401 and the second antenna 402.

In an embodiment, the first radiator 410 is configured to generate a first resonance, and a resonance frequency band of the first resonance includes the first frequency band. The second radiator 420 is configured to generate a second resonance, and a resonance frequency band of the second resonance includes the second frequency band. In an embodiment, a resonance point frequency of the first resonance is less than or equal to a resonance point frequency of the second resonance.

The electronic device 100 further includes a parasitic stub 430 and a first element 441.

The parasitic stub 430 includes a conductive part of the first side frame 210 between the second position 212 and the third position 213. At least a part of the parasitic stub 430 and the ground plane 300 are spaced from each other.

When the electronic device 100 is in the folded state, the parasitic stub 430 and the second radiator 420 at least partially overlap in a first direction, as shown in FIG. 12. The first direction is a thickness direction of the electronic device 100, or when the electronic device 100 is in an unfolded state, the first direction is a direction perpendicular to a display, for example, an x direction.

In an embodiment, when the electronic device 100 is in the folded state, the first radiator 410 and the second radiator 420 are staggered in the first direction. The first radiator 410 and the second radiator 420 do not overlap in the first direction.

In an embodiment, the first position 211, the second position 212, and the third position 213 may be located on a first edge of the first side frame 210. In an embodiment, the fourth position 214 and the fifth position 215 may be located on a second edge of the second side frame 220.

In an embodiment, when the electronic device 100 is in the unfolded state, the first edge and the second edge are a same side of the electronic device 100. For brevity of description, only an example in which the first edge and the second edge are the top edge (or the bottom edge) of the electronic device 100 is used for description. The top edge/bottom edge of the electronic device 100 may be understood as a top/bottom edge in the unfolded state. For example, in a mobile phone, the top edge/bottom edge may be understood as a top/bottom edge under a desktop (desktop) or a graphical user interface (graphical user interface, GUI).

The parasitic stub 430 includes a first connection point 431, and the first connection point 431 is located between the second position 212 and the third position 213. The first element 441 is coupled between the first connection point 431 and the ground plane 300. In an embodiment, the first element 441 is inductive.

A center frequency of the first frequency band is less than a center frequency of the second frequency band, and a frequency difference between the center frequency of the first frequency band and the center frequency of the second frequency band is less than or equal to 300 MHz. In an embodiment, the center frequency of the first frequency band is less than or equal to the center frequency of the second frequency band.

In an embodiment, an operating frequency band of the first antenna 401 is adjacent to an operating frequency band of the second antenna 402 (a frequency difference between the center frequency of the first frequency band and the center frequency of the second frequency band is less than or equal to 300 MHz).

For example, an operating frequency band (the first frequency band) of the first antenna 401 includes L1 (1578.42±1.023 MHz) in a global positioning system (global positioning system, GPS), and an operating frequency band (the second frequency band) of the second antenna 402 includes B3 (1.71 GHz to 1.785 GHz) in LTE. Alternatively, for example, an operating frequency band (the first frequency band) of the first antenna 401 includes a 2.4 GHz frequency band (2.4 GHz to 2.4835 GHz) in a wireless network communication technology (Wi-Fi) or a Bluetooth wireless technology (bluetooth, BT) (2.4 GHz to 2.4835 GHZ), and an operating frequency band (the second frequency band) of the second antenna 402 includes B7 (2.5 GHz to 2.57 GHz) or B41 (2.496 GHz to 2.69 GHz) in LTE.

It should be understood that in the foregoing embodiment, only some communication frequency bands that may be included in the first frequency band and the second frequency band are used as an example. In actual production or design, another communication frequency band may also be included. This is not limited in this embodiment of this application.

According to this embodiment of this application, when the electronic device 100 is in the folded state, and the radio frequency signal is fed at the first feed point 412, the first antenna 401 may be coupled on the parasitic stub 430 to generate a first current path. In the first current path, currents on the parasitic stub 430 between the second position 212 and the third position 213 are co-directional.

In the first frequency band, because the first element 441 is coupled between the first connection point 431 of the parasitic stub 430 and the ground plane 300, a second current path may be additionally generated on the parasitic stub 430. In the second current path, currents on parasitic stubs 430 on two sides of the first connection point 431 are reverse.

Therefore, the currents on the first current path are partially reverse to the currents on the second path, and the currents on the second path may offset a part of the currents on the first path, thereby weakening coupling between the first radiator 410 and the second radiator 420, and improving isolation between the first antenna 401 and the second antenna 402.

In addition, because the first element 441 is inductive, the operating frequency band of the first antenna 401 is lower than the operating frequency band of the second antenna 402, and the inductive element has a low-pass high-resistance characteristic, an additional current path generated by the second antenna 402 (a radio frequency signal fed at the second feed point 422) on the parasitic stub 430 is weaker, and does not greatly affect an original current path, and the parasitic stub 430 can be configured to improve a radiation characteristic (for example, radiation efficiency) of the second antenna 402.

In an embodiment, the parasitic stub 430 and the first element 441 may be configured to generate a first parasitic resonance and a second parasitic resonance. A resonance point frequency of the first parasitic resonance is greater than the resonance point frequency of the second resonance, and a resonance point frequency of the second parasitic resonance is less than the resonance point frequency of the first resonance.

Correspondingly, when boundary conditions of the parasitic stub 430 and the second radiator 420 are the same (both ends are open ends, or one end is an open end and the other end is a ground end), an electrical length of the parasitic stub 430 is less than an electrical length of the second radiator 420.

It should be understood that, in the foregoing embodiment, the first current path generated by coupling the first antenna 401 on the parasitic stub 430 and the current path generated by coupling the second antenna 402 on the parasitic stub 430 may correspond to the first parasitic resonance. In the foregoing embodiment, the second current path generated by coupling the first antenna 401 on the parasitic stub 430 may correspond to the second parasitic resonance.

In an embodiment, the first parasitic resonance may be used to improve a radiation characteristic (for example, radiation efficiency) of the second antenna 402 in the second frequency band. In an embodiment, the second parasitic resonance may be used to improve isolation between the first antenna 401 and the second antenna 402 in the first frequency band.

It should be understood that, at the resonance point of the first parasitic resonance, in the first current path generated by coupling the first antenna 401 on the parasitic stub 430 and the current path generated by coupling the second antenna 402 on the parasitic stub 430, currents on the parasitic stub 430 are co-directional, and the co-directional currents can be used to improve a radiation characteristic (for example, radiation efficiency) of the antenna.

At the resonance point of the second parasitic resonance, in the second current path generated by coupling the first antenna 401 on the parasitic stub 430, part of currents on the parasitic stub 430 are reverse currents, and currents on the second current path may offset a part of currents on the first current path, so that an overall current generated by coupling the first antenna 401 on the parasitic stub 430 is weakened (because the overall current is weakened, the radiation characteristic of the first antenna 401 is slightly improved by using the first parasitic resonance), thereby weakening coupling between the first radiator 410 and the second radiator 420, and improving isolation between the first antenna 401 and the second antenna 402.

Therefore, in the electronic device 100 shown in FIG. 11, the parasitic stub 430 is mainly configured to improve a radiation characteristic (for example, radiation efficiency) of the second antenna 402.

In an embodiment, a frequency difference between the resonance point frequency of the second parasitic resonance and the resonance point frequency of the first resonance is greater than or equal to 100 MHz. In an embodiment, a frequency difference between the resonance point frequency of the second parasitic resonance and the resonance point frequency of the first resonance is less than or equal to 800 MHz.

It should be understood that, compared with a resonance point of the first resonance, a resonance point of the second parasitic resonance is closer to a low frequency. When a frequency between the resonance point frequency of the second parasitic resonance and the resonance point frequency of the first resonance is within a specific range, cancellation effect between the current on the second current path and the current on the first current path is better, and there is better isolation between the first antenna 401 and the second antenna 402. In addition, the second parasitic resonance being close to the first resonance does not cause a dip in the radiation efficiency of the first antenna 401 in the first frequency band, nor does it reduce a radiation characteristic of the first antenna 401 in the first frequency band.

In an embodiment, a frequency difference between the resonance point frequency of the first parasitic resonance and the resonance point frequency of the second resonance is greater than or equal to 100 MHz and less than or equal to 400 MHz.

It should be understood that, when a frequency between the resonance point frequency of the first parasitic resonance and the resonance point frequency of the second resonance is within a specific range, the first parasitic resonance being close to the second resonance does not cause a dip in the radiation efficiency of the second antenna 402 in the second frequency band. In this way, the second antenna 402 can have a better radiation characteristic (for example, radiation efficiency) in the second frequency band.

In an embodiment, a length L1 of the first side frame 210 between the first position 211 and the second position 212 and a length L2 of the first side frame between the second position 212 and the third position 213 satisfy: L1×150%≤L2.

It should be understood that, as a length of the parasitic stub 430 increases, it is more conducive to improving a radiation characteristic of the antenna (the first antenna 401 or the second antenna 402).

In an embodiment, the first connection point 431 is disposed on a side that is of the parasitic stub 430 and that is away from the first radiator 410. A distance between the first connection point 431 and the second position 212 (a length of the parasitic stub 430 between the first connection point 431 and the second position 212) is greater than a distance between the first connection point 431 and the third position 213 (a length of the parasitic stub 430 between the first connection point 431 and the second position 212).

It should be understood that, when the first connection point 431 is disposed on the side that is of the parasitic stub 430 and that is away from the first radiator 410, a current for reverse cancellation between the current on the first current path and the current on the second path can be increased, further reducing coupling between the first radiator 410 and the second radiator 420, and improving isolation between the first antenna 401 and the second antenna 402.

In an embodiment, the first connection point 431 may be located in a first current strong point area of the parasitic stub 430 between the second position 212 and the third position 213. The first current strong point area is generated by coupling the second antenna 402.

It should be understood that, the first current strong point area generated by coupling the second antenna 402 may be understood as an area in which a current strong point is located in a current path generated by coupling the second antenna 402 on the parasitic stub 430. Because a current corresponds to an electric field, the current strong point may also be understood as an electric field node (electric fields on two sides of the electric field node are reverse). In this embodiment of this application, the current strong point area may be understood as an area within 5 mm away from a current strongest point, or an area within 5 mm away from an electric field node.

When the first connection point 431 is located in the first current strong point area, the first element 441 has less impact on the second antenna 402, and the radiation characteristic of the second antenna 402 can be greatly improved by using the parasitic stub 430.

In an embodiment, an equivalent inductance value of the first element 441 may be determined based on an actual frequency of the first frequency band. In an embodiment, when the center frequency of the first frequency band is less than or equal to 2 GHZ, an equivalent inductance value of the first element 441 is greater than or equal to 2 nH. When the center frequency of the first frequency band is greater than 2 GHZ, an equivalent inductance value of the first element 441 is greater than or equal to 1 nH.

In an embodiment, the first element 441 may be a 0-ohm resistor.

In an embodiment, the electronic device 100 further includes a second element 442. The parasitic stub 430 includes a second connection point 432. The second element 442 is coupled between the second connection point 432 and the ground plane 300. In an embodiment, the second element 442 is capacitive.

According to this embodiment of this application, a part of currents in the current path generated by the second antenna 402 flows into the ground plane 300 at the second connection point 432, further reducing coupling between the first radiator 410 and the second radiator 420, and improving isolation between the first antenna 401 and the second antenna 402.

In addition, because the second element 442 is capacitive, an operating frequency band of the first antenna 401 is lower than an operating frequency band of the second antenna 402, and the capacitive element has a high-pass low-impedance characteristic, on the parasitic stub 430, a current path generated by the first antenna 401 is not affected near the second connection point 432, and the parasitic stub 430 can be configured to improve the radiation characteristic (for example, radiation efficiency) of the first antenna 401.

In an embodiment, the first connection point 431 and the second connection point 432 are respectively located on two sides of a center of a parasitic stub between the second position 212 and the third position 213, and a distance between the center and the second position 212 (a length of the parasitic stub 430 between the center and the second position 212) is the same as a distance between the center and the third position 213 (a length of the parasitic stub 430 between the center and the third position 213).

In an embodiment, the first connection point 431 is included on a side that is of the parasitic stub 430 and that is away from the first radiator 410. The second connection point 432 is included on a side that is of the parasitic stub 430 and that is close to the first radiator 410. In an embodiment, a distance between the second connection point 432 and the second position 212 (a length of the parasitic stub 430 between the second connection point 432 and the second position 212) is less than a distance between the second connection point 432 and the third position 213 (a length of the parasitic stub 430 between the second connection point 432 and the third position 213).

In an embodiment, the second connection point 432 may be located in a second current strong point area of the parasitic stub 430 between the second position 212 and the third position 213. The second current strong point area is generated by coupling the first antenna 401.

It should be understood that, the second current strong point area by the first antenna 401 may be understood as an area in which a current strong point is located in a current path generated by coupling the first antenna 401 on the parasitic stub 430.

When the second connection point 432 is located in the second current strong point area, the second element 442 has less impact on the first antenna 401, and the radiation characteristic of the first antenna 401 can be greatly improved by using the parasitic stub 430.

In an embodiment, an equivalent capacitance value of the second element 442 may be determined based on an actual frequency of the second frequency band. In an embodiment, when the center frequency of the second frequency band is less than or equal to 2 GHz, an equivalent inductance value of the second element 442 is less than or equal to 3 pF. When the center frequency of the second frequency band is greater than 2 GHz, an equivalent inductance value of the second element 442 is greater than or equal to 2 pF.

In an embodiment, the first side frame 210 is coupled to the ground plane 300 at the first position 211.

It should be understood that one end of the first radiator 410 is a ground end, and the other end is an open end, to form a structure similar to an IFA or a structure similar to a left-hand antenna. The left-handed antenna may be, for example, an antenna that conforms to a composite right and left hand (CRLH) transmission line structure.

When the first radiator 410 forms a structure similar to the inverted F antenna, the first feed point 412 is close to the ground end, and a distance between the first feed point 412 and the ground end (a length of the first radiator 410 between the first feed point 412 and the first position 211) is less than or equal to one-half of the length of the first radiator 410.

When the first radiator 410 forms a structure similar to the left-handed antenna, the first feed point 412 is close to the open end, and a distance between the first feed point 412 and the ground end (a length of the first radiator 410 between the first feed point 412 and the first position 211) is greater than or equal to one-half of the length of the first radiator 410. The first feed point 412 being close to the open end facilitates miniaturization of the first radiator 410. A capacitor is coupled between the first feed circuit 411 and the first feed point 412, to better excite the first radiator 410.

For brevity of description, structures similar to the inverted F antenna or the left-handed antenna may be accordingly understood in embodiments of this application. Details are not described again.

In an embodiment, the first resonance generated by the first radiator 410 may correspond to a quarter-wavelength mode. An electrical length of the first radiator 410 is approximately a quarter of a first wavelength.

The first wavelength may be understood as a vacuum wavelength corresponding to the resonance point frequency of the first resonance generated by the first radiator 410, or may be understood as a vacuum wavelength corresponding to a center frequency of a resonance frequency band formed by the first resonance generated by the first radiator 410.

It should be understood that the foregoing wavelengths are all vacuum wavelengths. Because there is a specific conversion relationship between a dielectric wavelength and a vacuum wavelength, the foregoing vacuum wavelength may also be converted into the dielectric wavelength. For brevity of description, all wavelengths described in embodiments of this application may be correspondingly understood.

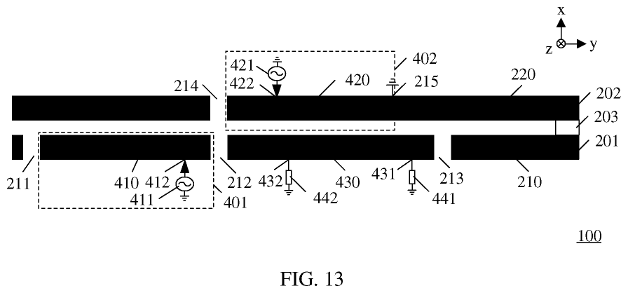

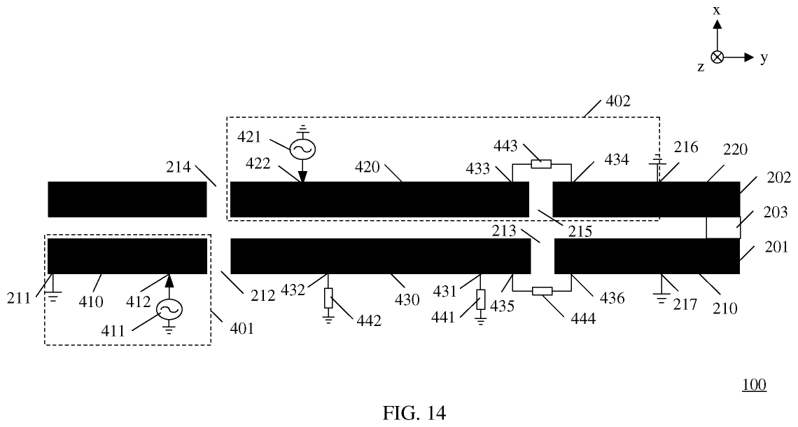

In an embodiment, the first side frame 210 has an insulation slot at the first position 211, as shown in FIG. 13.

It should be understood that both ends of the first radiator 410 are open ends, to form an antenna structure similar to a dipole.

In an embodiment, the first resonance generated by the first radiator 410 may correspond to a one-half-wavelength mode. An electrical length of the first radiator 410 is approximately one-half of the first wavelength.

In an embodiment, the second side frame 220 has a fourth insulation slot at the fifth position 215, as shown in FIG. 12.

It should be understood that both ends of the second radiator 420 are open ends, to form an antenna structure similar to a dipole.

In an embodiment, the second resonance generated by the second radiator 420 may correspond to a one-half-wavelength mode. An electrical length of the second radiator 420 is approximately one-half of a second wavelength. The second wavelength may be understood as a wavelength corresponding to the second resonance generated by the second radiator 410.

In an embodiment, the electronic device 100 is in the folded state, and the first insulation slot is aligned with the third insulation slot, and/or the second insulation slot is aligned with the fourth insulation slot.

It should be understood that the alignment may be understood as the electronic device 100 being in the folded state, with at least partial overlap in a thickness direction (for example, in an unfolded state, in a direction perpendicular to a display) perpendicular to the electronic device 100. In an embodiment, the second radiator 420 (the second radiator 420 between the fourth position 214 and the fifth position 215) may further include a ground point, and the second radiator 420 (the second side frame 220) is coupled to the ground plane 300 at the ground point.

It should be understood that, when no ground point is disposed between the fourth position 214 and the fifth position 215, the second radiator 420 may generate the second resonance in the wire DM mode in the foregoing embodiments. When the ground point is disposed between the fourth position 214 and the fifth position 215, the second radiator 420 may generate the third resonance in the wire CM mode in the foregoing embodiments.

In an embodiment, a distance between the ground point and the fourth position 214 (a length of the second side frame 220 between the ground point and the fourth position 214) is different from a distance between the ground point and the fifth position 215 (a length of the second side frame 220 between the ground point and the fifth position 215).

It should be understood that, when the ground point is not located in the center of the second radiator 420, the second radiator 420 may generate the third resonance in the wire CM mode, or may be coupled on the parasitic stub 430 to generate co-directional currents, to improve a radiation characteristic (for example, radiation efficiency) of the second antenna 402.

In an embodiment, the second side frame 220 is coupled to the ground plane 300 at the fifth position 215, as shown in FIG. 13.

It should be understood that one end of the second radiator 420 is a ground end, and the other end is an open end, to form a structure similar to an IFA or a structure similar to a left-hand antenna.

In an embodiment, the first resonance generated by the second radiator 420 may correspond to a quarter-wavelength mode. An electrical length of the second radiator 420 is approximately a quarter of a first wavelength.

In an embodiment, both ends of the parasitic stub 430 are open ends, to form an antenna structure similar to a dipole, and the parasitic stub 430 operates in the one-half-wavelength mode. The parasitic stub 430 may generate the parasitic resonance in the wire DM mode in the foregoing embodiments.

It should be understood that, in this embodiment of this application, when the first connection point 431 and/or the second connection point 432 is located between the second position 212 and the third position 213, only the first side frame 210 has the first insulation slot and the second insulation slot at the second position 212 and the third position 213. Structures formed by the first radiator 410, the second radiator 420, and the parasitic stub 430 are not limited in this embodiment of this application. For example, the first side frame 210 has an insulation slot at the first position 211 or the fourth position 214, and the structures formed by the first radiator 410, the second radiator 420, and the parasitic stub 430 can be determined based on actual production or design.

In an embodiment, the parasitic stub 430 (the parasitic stub 430 between the second position 212 and the third position 213) does not include a ground point.

It should be understood that when the parasitic stub 430 includes a ground point, current distribution on the parasitic stub 430 changes. The first antenna 401 and the second antenna 402 may also be coupled on the parasitic stub 430 to generate reverse currents, and it is difficult to improve a radiation characteristic (for example, radiation efficiency) of the antenna by using the parasitic stub 430.

In an embodiment, the second side frame 220 may further include a sixth position 216, and the fifth position 215 is located between the sixth position 216 and the fourth position 214, as shown in FIG. 14. The second side frame 220 has a third insulation slot and a fourth insulation slot at the fourth position 214 and the fifth position 215 respectively. The second side frame 220 is coupled to the ground plane 300 at the sixth position 216.

In an embodiment, the second radiator 420 includes a conductive part of the second side frame 220 between the fourth position 214 and the sixth position 216, as shown in FIG. 14.

It should be understood that, in the foregoing embodiment, a conductive part of the second side frame 220 between the fourth position 214 and the fifth position 215 is used as the second radiator 420. Both ends of the second radiator 420 are open ends, and the second radiator 420 operates in the one-half-wavelength mode.

In the foldable electronic device 100 shown in FIG. 14, the second radiator 420 is a structure with one end being a ground end and the other end being an open end. In addition, the fourth insulation slot of the second radiator 420 may be considered as an equivalent capacitor (for example, a distributed capacitor) disposed on the second radiator 420, and the equivalent capacitor may enable the second radiator 420 to form a metamaterial (metamaterial, meta for short) structure. The second radiator 420 having the metamaterial structure may increase a radiation aperture, and electric fields are more dispersed after the fourth insulation slot is provided. In an embodiment, dielectric losses near the second radiator 420 forming the metamaterial structure are reduced. Therefore, radiation characteristics (for example, total efficiency and radiation efficiency) of the second antenna 402 can be effectively improved.

In an embodiment, an electrical length of the second radiator 420 is greater than three-eighths of the first wavelength.

It should be understood that, the second resonance generated by the second radiator 420 may correspond to the quarter-wavelength mode. By using the fourth insulation slot, the electrical length of the second radiator 420 may be greater than three-eighths of the first wavelength, and currents on the second radiator 420 are co-directional (for example, are not reversed). The electrical length of the second radiator 420 increases from a quarter of the first wavelength to more than three-eighths of the first wavelength, but the second radiator 420 still operates in the quarter-wavelength mode.

In this case, a current density on the second radiator 420 is dispersed, and an electric field density between the second radiator 420 and the ground plane 300 is weakened, thereby reducing a conductor loss and a dielectric loss caused by a conductor and a dielectric disposed around the second radiator 420 and the second radiator 420, and improving a radiation characteristic of the second antenna 402. The second radiator 420 increases the radiation aperture, effectively improving total efficiency and radiation efficiency of the second antenna 402.

The first wavelength may be understood as a dielectric wavelength corresponding to the resonance point frequency of the second resonance generated by the second radiator 420, or may be understood as a dielectric wavelength corresponding to a center frequency of a resonance frequency band formed by the second resonance generated by the second radiator 420. Because there is a specific correspondence between the vacuum wavelength and the dielectric wavelength, the foregoing proportion may be converted into a proportion of the vacuum wavelength. Details are not described in this application.

In an embodiment, the second radiator 420 may further include a third connection point 433 and a fourth connection point 434, and the fourth insulation slot is located between the third connection point 433 and the fourth connection point 434. A third element 443 is coupled between the third connection point 433 and the fourth connection point 434.

It should be understood that, an equivalent capacitance value of the fourth insulation slot may be adjusted through the third element 443 coupled between the third connection point 433 and the fourth connection point 434, so as to adjust a radiation characteristic of the second antenna 402 (for example, the resonance point frequency of the second resonance generated by the second radiator 420).

In an embodiment, a length of the second radiator 420 between a first end (the ground end, one end at the sixth position 216) of the second radiator 420 and the fourth insulation slot is less than a length of the second radiator 420 between a second end (the open end, one end at the fourth position 214) of the second radiator 420 and the fourth insulation slot.

It should be understood that the length of the radiator between one end of the second radiator 420 and the fourth insulation slot may be understood as a length of a conductor part between an end part of the end and the fourth insulation slot. For brevity of description, it may be correspondingly understood in this embodiment of this application.

In an embodiment, a length of the second radiator 420 between a first end (the ground end, one end at the sixth position 216) of the second radiator 420 and the fourth insulation slot is less than three-fifths of a length of the second radiator 420 between a second end (the open end, one end at the fourth position 214) of the second radiator 420 and the fourth insulation slot.

In an embodiment, a length of the second radiator 420 between a first end (the ground end, one end at the sixth position 216) of the second radiator 420 and the fourth insulation slot is less than one-third of a length of the second radiator 420 between a second end (the open end, one end at the fourth position 214) of the second radiator 420 and the fourth insulation slot.

In an embodiment, a length of the second radiator 420 between a first end (the ground end, one end at the sixth position 216) of the second radiator 420 and the fourth insulation slot is less than one-seventh of a length of the second radiator 420 between a second end (the open end, one end at the fourth position 214) of the second radiator 420 and the fourth insulation slot.

It should be understood that the fourth insulation slot may be located in an area in which a current of the second radiator 420 is stronger. The area with a stronger current should be understood as corresponding to the second radiator 420 (for example, operating in the quarter-wavelength mode) without a slit. After the fourth insulation slot is provided, electric field strength of the second radiator 420 becomes weak, and electric fields are dispersed, thereby improving radiation characteristics (for example, total efficiency and radiation efficiency) of the second antenna 402.

In an embodiment, the third element 443 may be a capacitor or an element equivalent to a capacitor, for example, a distributed capacitor.

In an embodiment, an equivalent capacitance value of the third element 443 may be less than or equal to a first threshold. The first threshold may be designed based on the resonance point frequency (or the center frequency of the second frequency band) of the second resonance generated by the second radiator 420. When the resonance point frequency of the second resonance is less than or equal to 1 GHz, the first threshold is 10 pF. When the resonance point frequency of the second resonance is greater than 1 GHZ, the first threshold is 2 pF.

In an embodiment, the third element 443 may be an inductor or an element equivalent to an inductor.

In an embodiment, an equivalent inductance value of the third element 443 may be less than or equal to 5 nH.

It should be understood that, the equivalent capacitance value or the equivalent inductance value of the third element 443 is designed based on frequencies of resonance points of different resonances, so that current distribution on the second radiator 420 can be more dispersed, a conductor loss is reduced, and a radiation aperture of the second radiator 420 is increased, thereby improving radiation characteristics (for example, total efficiency and radiation efficiency) of the second antenna 402.

In an embodiment, a distance between the third connection point 433 and the fourth insulation slot and/or a distance between the fourth connection point 434 and the fourth insulation slot are/is less than or equal to 5 mm.

The distance between the third connection point 433 and the fourth insulation slot and/or the distance between the fourth connection point 434 and the fourth insulation slot may be understood as a minimum distance between the third connection point 433 and conductors on both sides of the fourth insulation slot and/or a minimum distance between the fourth connection point 434 and conductors on both sides of the fourth insulation slot (a length of the second radiator 420 between the third connection point 433 and the fourth insulation slot and/or a length of the second radiator 420 between the fourth connection point 434 and the fourth insulation slot). During an electrical connection to the third connection point 433 and/or the fourth connection point 434 through a connector (for example, a metal spring), a distance between the third connection point 433 and the fourth insulation slot and/or a distance between the fourth connection point 434 and the fourth insulation slot may be understood as minimum distances between a center of a part that is of the connector and that is in contact with the connection point and conductors on two sides of the fourth insulation slot.

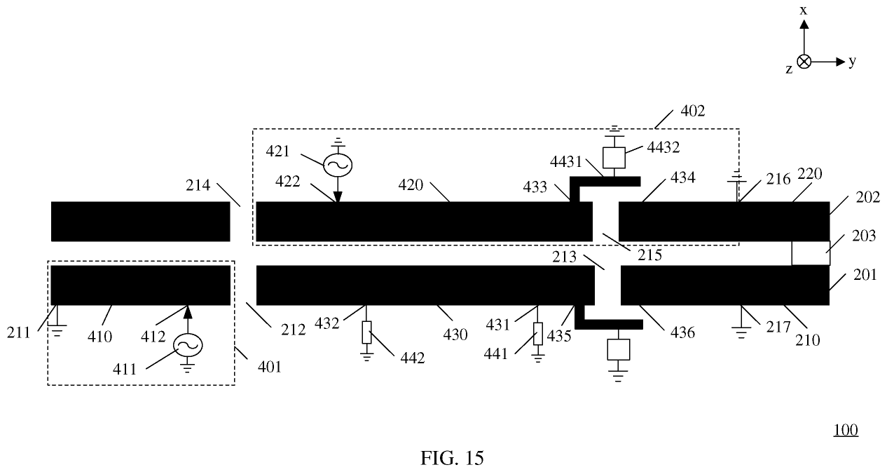

In an embodiment, the third element 443 may be a distributed capacitor, as shown in FIG. 15.

In an embodiment, the second antenna 402 includes a distributed connector 4431, and the distributed connector 4431 and the second side frame 220 jointly form the third element 443, as shown in FIG. 15. A first end of the distributed connector 4431 is connected to the third connection point 433, and a second end extends to the fourth connection point 434 and is opposite to the fourth connection point 434 (the second radiator 420 between the fifth position 215 and the sixth position 216) and is not in contact with the fourth connection point 434.

It should be understood that, when the third element 443 is a distributed component, structural strength at the fifth position 215 (the fourth insulation slot) can be improved, and stability of the electronic device 100 can be improved.

In an embodiment, the second antenna 402 may further include a switch 4432. The switch 4432 is coupled between the distributed connector 4431 and the ground plane 300.

It should be understood that the switch 4432 may be configured to switch an equivalent capacitance value or an equivalent inductance value of an element coupled to the distributed connector 4431, to adjust an equivalent capacitance value or an equivalent inductance value of the third element 443 formed by the distributed connector 4431, so that the second antenna 402 has different radiation characteristics.

It should be understood that, in the formed metamaterial structure described in this embodiment of this application, elements coupled to two sides of the slot provided on the radiator may use the foregoing structure. For brevity of description, details are not described again.

In an embodiment, the first side frame 210 may further include a seventh position 217, and the third position 213 is located between the second position 212 and the seventh position 217, as shown in FIG. 14. The first side frame 210 has a first insulation slot and a second insulation slot at the second position 212 and the third position 213 respectively. The first side frame 210 is coupled to the ground plane 300 at the seventh position 217.

In an embodiment, the parasitic stub 430 includes a conductive part of the first side frame 210 between the second position 212 and the seventh position 217.

It should be understood that, in the foregoing embodiment, a conductive part of the first side frame 210 between the second position 212 and the third position 213 is used as the parasitic stub 430. Both ends of the parasitic stub 430 are open ends, and the parasitic stub 430 operates in the one-half-wavelength mode.

In the foldable electronic device 100 shown in FIG. 14, the parasitic stub 430 is a structure with one end being a ground end and the other end being an open end. In addition, the second insulation slot of the parasitic stub 430 may be considered as an equivalent capacitor (for example, a distributed capacitor) disposed on the parasitic stub 430, and the equivalent capacitor may enable the parasitic stub 430 to form a metamaterial structure.

In an embodiment, the parasitic stub 430 may further include a fifth connection point 435 and a sixth connection point 436, and the second insulation slot is located between the fifth connection point 435 and the sixth connection point 436. A fourth element 444 is coupled between the fifth connection point 435 and the sixth connection point 436.

It should be understood that the metamaterial structure formed by the parasitic stub 430 is similar to the metamaterial structure formed by the second radiator 420 in the foregoing embodiments. For related structure limitations, refer to limitations of the foregoing metamaterial structure. For brevity of description, details are not described again.

In an embodiment, the second radiator 420 may further include a seventh connection point. The second antenna 402 further includes a fifth element, and the fifth element is coupled between the seventh connection point and the ground plane 300.

The second radiator 420 is electrically connected to the ground plane 300 at the seventh connection point by using the fifth element, so that when the second radiator 420 generates the second resonance, a current on the second radiator 420 is shunted in an area near the seventh connection point. Because shunt occurs in the area near the seventh connection point, a current density on the second radiator 420 can be dispersed. In an embodiment, current distribution on the second radiator is more dispersed, to reduce a conductor loss of the second radiator. In an embodiment, current distribution on the second radiator is more dispersed, to increase a radiation aperture of the second radiator 420. Because the conductor loss of the second radiator 420 is reduced and the radiation aperture is increased, radiation characteristics (for example, total efficiency and radiation efficiency) of the second antenna 402 can be improved.

In an embodiment, a distance between the seventh connection point and the third connection point 433 and/or a distance between the seventh connection point and the fourth connection point 434 (for example, a length of the second radiator 420 between the seventh connection point and the third connection point 433 and/or a length of the second radiator 420 between the seventh connection point and the fourth connection point 434) are/is greater than or equal to o mm and less than or equal to 5 mm.

It should be understood that, when the distance between the seventh connection point and the third connection point 433 and/or the distance between the seventh connection point and the fourth connection point 434 are/is equal to o mm, the seventh connection point overlaps the third connection point 433 and/or the fourth connection point 434.

In an embodiment, the parasitic stub 430 may further include a sixth element, similar to the fifth element. For a connection point, refer to the foregoing embodiments. For brevity of description, details are not described again.

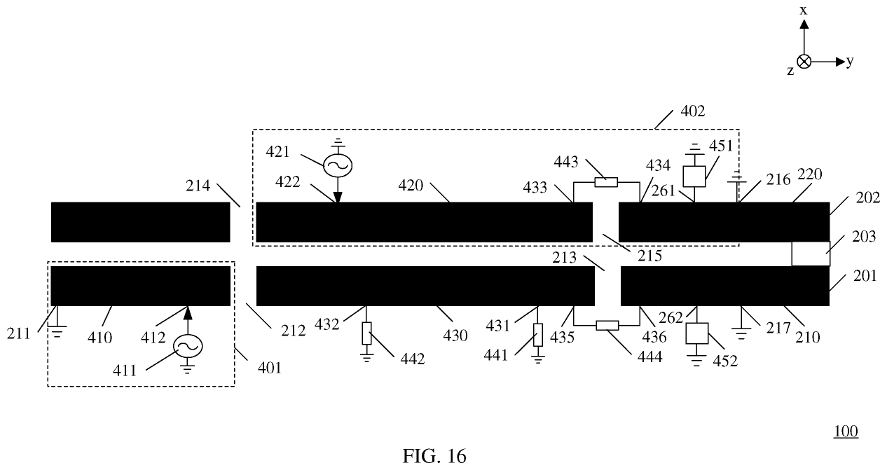

In an embodiment, the second antenna 402 may further include a first matching circuit 451, as shown in FIG. 16. The first matching circuit 451 is coupled between a first matching point 261 of the second radiator 420 and the ground plane 300.

It should be understood that the first matching circuit 451 may be configured to adjust the resonance point frequency of the second resonance generated by the second radiator 420.

In an embodiment, the first matching point 261 is located between the fourth insulation slot (the fifth position 215) and the sixth position 216.

In an embodiment, the electronic device 100 may further include a second matching circuit 452, as shown in FIG. 16. The second matching circuit 452 is coupled between a second matching point 262 of the parasitic stub 430 and the ground plane 300.

It should be understood that the second matching circuit 452 may be configured to adjust a resonance point frequency of the parasitic resonance generated by the parasitic stub 430.

In an embodiment, the second matching point 262 is located between the second insulation slot (the third position 213) and the seventh position 217.

In an embodiment, the first radiator 410 may further include a third matching point, and a third matching circuit is coupled between the third matching point and the ground plane 300, and is configured to adjust the resonance point frequency of the first resonance generated by the first radiator 410. For brevity of description, details are not described again.

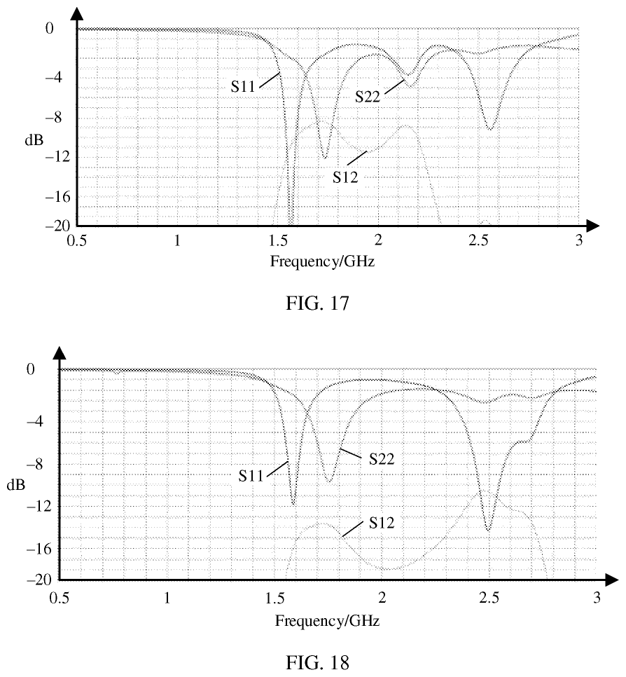

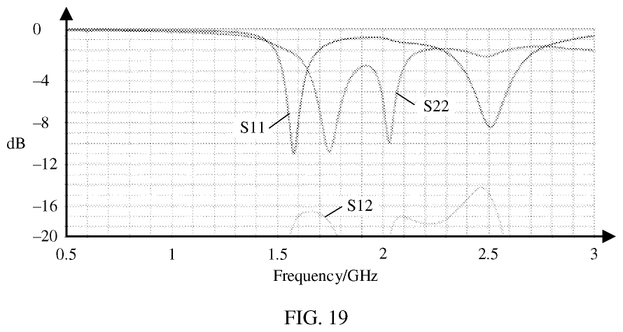

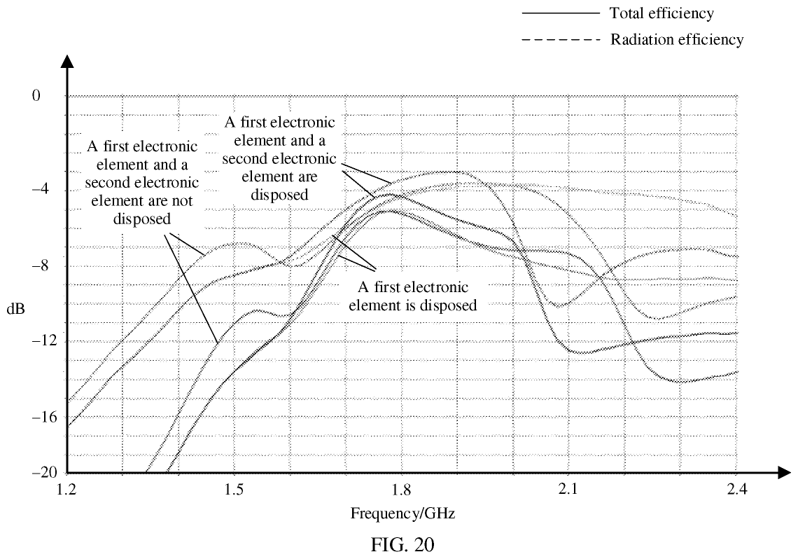

FIG. 17 to FIG. 20 show simulation results of the first antenna and the second antenna in the electronic device 100 shown in FIG. 16. FIG. 17 shows simulation results of S parameters of the first antenna and the second antenna when the first element and the second element are not disposed. FIG. 18 shows simulation results of S parameters of the first antenna and the second antenna when only the first element is disposed. FIG. 19 shows simulation results of S parameters of the first antenna and the second antenna when the first element and the second element are disposed. FIG. 20 shows simulation results of radiation efficiency and total efficiency of the second antenna.

It should be understood that, for brevity of description, in the simulation results shown in FIG. 17 to FIG. 20, only an example in which the first frequency band includes an L1 frequency band (1578.42±1.023 MHz) in the GPS and the second frequency band includes a B3 frequency band (1.71 GHz to 1.785 GHz) in LTE is used for description.

As shown in FIG. 17, the first antenna (S11) generates a resonance near 1.55 GHZ, which may correspond to the first resonance. A resonance frequency band of the first resonance includes an L1 frequency band in the GPS. The second antenna (S22) generates a resonance near 1.75 GHZ, which may correspond to the second resonance. A resonance frequency band of the second resonance includes a B3 frequency band in LTE.

Both the first antenna and the second antenna generate a resonance near 2.25 GHZ, which may correspond to the first parasitic resonance generated by the parasitic stub.

In the S curve, both the first antenna and the second antenna generate the first parasitic resonance near 2.15 GHz. Therefore, both the first antenna and the second antenna can be coupled on the first parasitic stub to generate co-directional currents, and isolation between the first antenna and the second antenna is poorer.

In the first frequency band, isolation between the isolation (S12) between the first antenna and the second antenna is only about 11.5 dB. In the second frequency band, isolation between the isolation (S12) between the first antenna and the second antenna is only about 9 dB.

As shown in FIG. 18, after the first element is disposed, the first resonance of the first antenna and the second resonance of the second antenna do not change. Because the parasitic stub loads the first element, the parasitic resonance is shifted to near 2.7 GHZ, and a resonance point frequency of the parasitic resonance may be adjusted through the second matching circuit. For brevity of description, details are not described in this embodiment of this application.

In addition, a new resonance generated by the second antenna near 0.75 GHz may be understood as a second parasitic resonance generated on the parasitic stub due to a new current path introduced after loading of the first element.

In the first frequency band, isolation between the isolation (S12) between the first antenna and the second antenna is improved to about 16 dB. In the second frequency band, isolation between the isolation (S12) between the first antenna and the second antenna is improved to about 14.5 dB.

As shown in FIG. 19, after the first element and the second element are disposed, the first resonance of the first antenna and the second resonance of the second antenna do not change.

The first antenna may be coupled on the parasitic stub to generate a first current path and a second current path with currents partially reverse to currents on the first current path. Therefore, the first parasitic resonance generated by coupling the first antenna on the parasitic stub is weaker, and is not obvious in the S curve. The parasitic resonance generated by coupling the second antenna on the parasitic stub is located near 2 GHz. In addition, a new resonance generated by the first antenna near 0.6 GHz may be understood as a second parasitic resonance generated on the parasitic stub due to the second current path introduced after loading of the first element.

In addition, after the parasitic stub loads the second element, a part of currents of the second antenna coupled on the parasitic stub flows to the ground plane, and isolation between the first antenna and the second antenna is improved. In the first frequency band, isolation between the isolation (S12) between the first antenna and the second antenna is improved to about 17.5 dB. In the second frequency band, isolation between the isolation (S12) between the first antenna and the second antenna is improved to about 18 dB.

As shown in FIG. 20, compared with not disposing the first element and/or the second element, disposing the parasitic stubs of the first element and the second element can improve the radiation efficiency and the total efficiency of the second antenna.

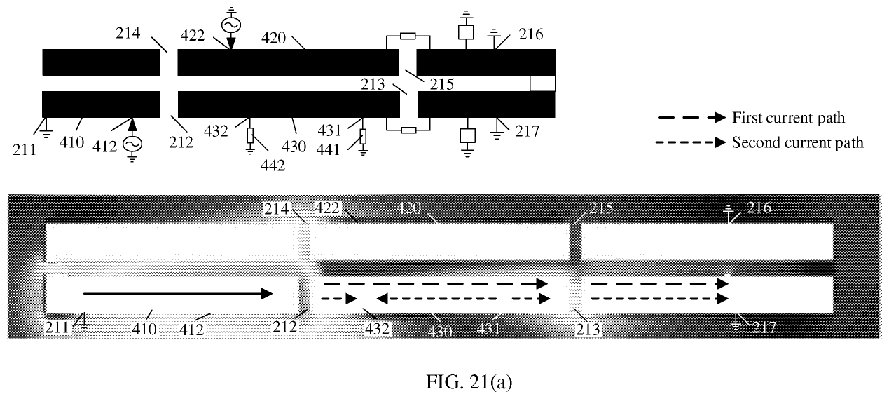

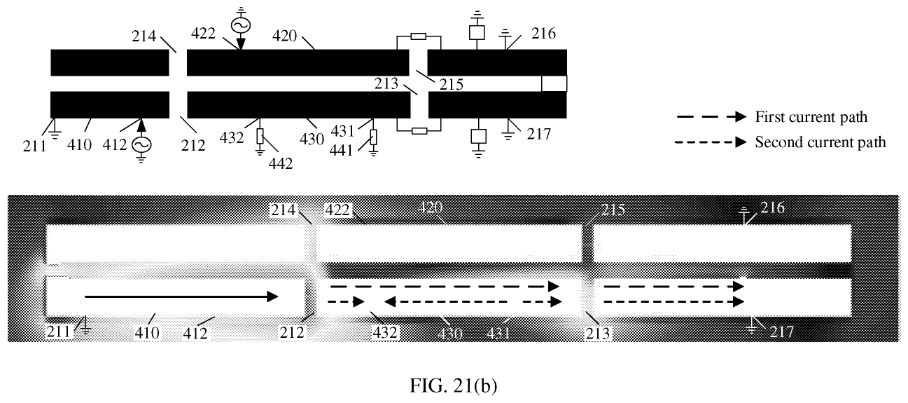

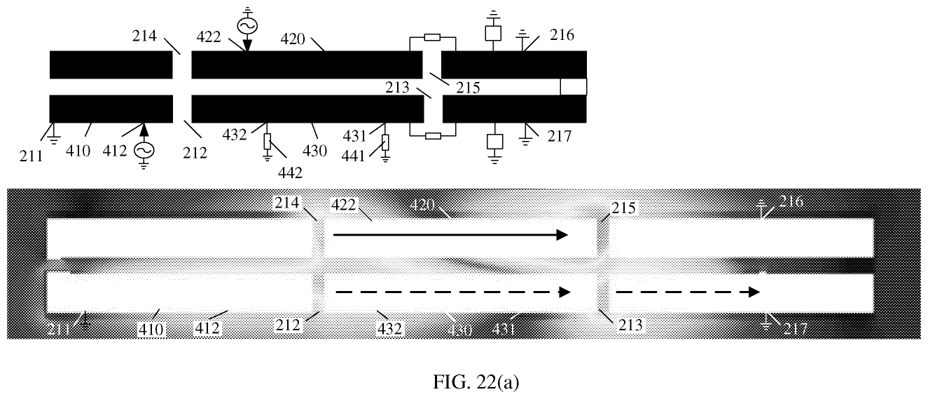

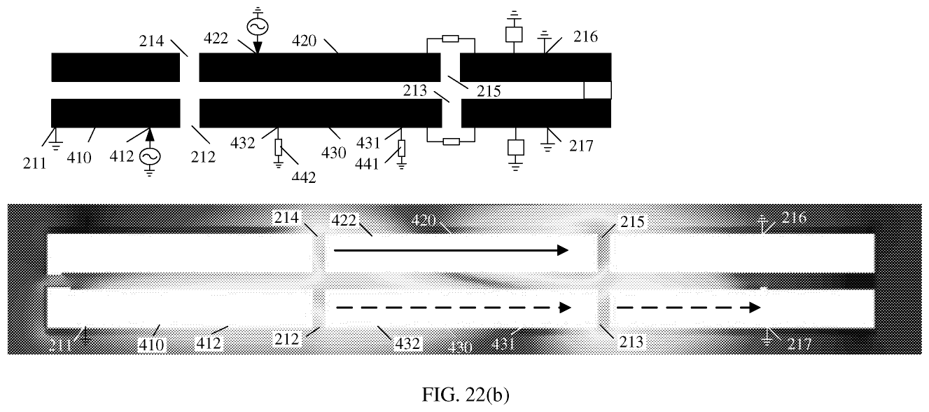

FIG. 21(a) to FIG. 22(b) are diagrams of distribution of currents and electric fields of the antenna in the electronic device 100 shown in FIG. 16. FIG. 21(a) and FIG. 21(b) are the diagram of distribution of currents and electric fields of the first antenna at a resonance point (1.57 GHZ) of the first resonance in the electronic device 100 shown in FIG. 16. FIG. 22(a) and FIG. 22(b) are the diagram of distribution of currents and electric fields of the second antenna at a resonance point (1.74 GHz) of the second resonance in the electronic device 100 shown in FIG. 16.

As shown in FIG. 21(a) and FIG. 21(b), when a radio frequency signal is fed at the first feed point 412, a first current path and a second current path may be generated on the parasitic stub 430. In the second current path, currents on parasitic stubs 430 on two sides of the first connection point 431 are reverse.

Therefore, currents on the first current path are partially reverse to currents on the second path. The currents on the second path may offset a part of the currents on the first path, thereby weakening coupling between the first radiator 410 and the second radiator 420, and improving isolation between the first antenna 401 and the second antenna 402.

As shown in FIG. 22(a) and FIG. 22(b), when a radio frequency signal is fed at the second feed point 422, because the first element 441 is inductive, an operating frequency band of the first antenna 401 is lower than an operating frequency band of the second antenna 402, and the inductive element has a low-pass high-resistance characteristic, an additional current path generated by the second antenna 402 on the parasitic stub 430 is weaker, and impact on an original current path is smaller.

The first connection point 431 may be located in an area in which a current strong point (an electric field node) is located in a current path generated by coupling the second antenna 402 on the parasitic stub 430, the first element 441 has less impact on the second antenna 402, and the radiation characteristic of the second antenna 402 can be greatly improved by using the parasitic stub 430, as shown in FIG. 22(a) and FIG. 22(b).

The second connection point 432 may be located in an area in which a current strong point (an electric field node) is located in a current path generated by coupling the first antenna 401 on the parasitic stub 430, the second element 442 has less impact on the first antenna 401, and the radiation characteristic of the first antenna 401 can be greatly improved by using the parasitic stub 430, as shown in FIG. 21(a) and FIG. 21(b).

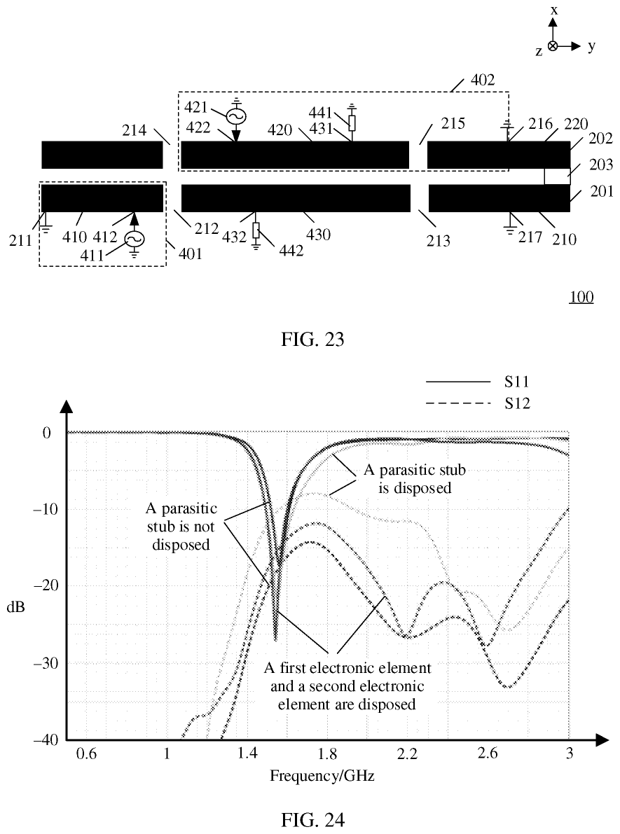

FIG. 23 is a diagram of another electronic device 100 according to an embodiment of this application.

As shown in FIG. 23, a second radiator 420 includes a first connection point 431, and the first connection point 431 is located between a fourth position 214 and a fifth position 215.

It should be understood that a difference between a first antenna 401 and a second antenna 402 shown in FIG. 23 and the first antenna 401 and the second antenna 402 shown in FIG. 11 to FIG. 16 lies only in a position of the first connection point 431.

In the first antenna 401 and the second antenna 402 shown in FIG. 11 to FIG. 16, the first connection point 431 is located at the second position 212 and the third position 213. A second current path (corresponding to the second parasitic resonance in the foregoing embodiments) may be additionally generated on a parasitic stub 430 through the first element 441 coupled between the first connection point 431 and a ground plane 300. Currents on an original first current path are partially reverse to currents on the additional second path, thereby weakening coupling between a first radiator 410 and the second radiator 420, and improving isolation between the first antenna 401 and the second antenna 402.

However, in the first antenna 401 and the second antenna 402 shown in FIG. 23, the first connection point 431 is located between the fourth position 214 and the fifth position 215. When the electronic device 100 is in a folded state, the first antenna 401 may be coupled on the second radiator 420 through the parasitic stub 430 to generate a third current path. Because the first element 441 is coupled between the first connection point 431 of the second radiator 420 and the ground plane 300, a fourth current path may be additionally generated on the second radiator 420. In the fourth current path, currents on parasitic stubs 430 on two sides of the first connection point 431 are reverse. Currents on the original third current path are partially reverse to currents on the additional fourth path, thereby weakening coupling between the first radiator 410 and the second radiator 420, and improving isolation between the first antenna 401 and the second antenna 402.

In addition, because the first element 441 is inductive, an operating frequency band of the first antenna 401 is lower than an operating frequency band of the second antenna 402, and the inductive element has a low-pass high-resistance characteristic, the current path generated on the second radiator 420 is for generating an additional current path without being affected by the first connection point 431 when the second antenna 402 operates (a radio frequency signal is fed at a second feed point 422).

It should be understood that, in the first antenna 401 and the second antenna 402 shown in FIG. 23, when only the first connection point 431 is disposed (a second connection point 432 is not disposed), a second side frame 220 has a third insulation slot and a fourth insulation slot at the fourth position 214 and the fifth position 215, and the parasitic stub 430 may be in any form. For example, a first side frame 210 has a first insulation slot at a second position 212, and is coupled to the ground plane 300 at a third position 213. When the first connection point 431 and the second connection point 432 are disposed, the first side frame 210 has the first insulation slot and a second insulation slot at the second position 212 and the third position 213 respectively, and the second side frame 220 has the third insulation slot and the fourth insulation slot at the fourth position 214 and the fifth position 215.

In an embodiment, the first radiator 410 is configured to generate a first resonance, and a resonance frequency band of the first resonance includes the first frequency band. In an embodiment, the second radiator 420 and the first element 441 are configured to generate a second resonance and a third resonance, and a resonance frequency band of the second resonance includes the second frequency band. In an embodiment, a resonance point frequency of the first resonance is less than or equal to a resonance point frequency of the second resonance. The resonance point frequency of the first resonance is greater than a resonance point frequency of the third resonance.

It should be understood that, at the resonance point of the second resonance, currents on the second radiator 420 are co-directional. The third resonance may correspond to the fourth current path in the foregoing embodiments. At a resonance point of the third resonance, currents on the second radiator 420 include a part of reverse currents.

In an embodiment, the third resonance may be used to improve isolation between the first antenna 401 and the second antenna 402 in the first frequency band.

It should be understood that, at the resonance point of the third resonance, in the fourth current path generated by coupling the first antenna 401 on the second radiator 420, the currents on the second radiator 420 include a part of reverse currents, and currents on the fourth current path may offset a part of currents on the third current path, so that an overall current generated by coupling the first antenna 401 on the second radiator 420 is weakened, thereby weakening coupling between the first radiator 410 and the second radiator 420, and improving isolation between the first antenna 401 and the second antenna 402.

In addition, because the currents on the second radiator 420 include a part of reverse currents, a radiation characteristic of the second antenna 402 is weakened to some extent. Therefore, in the electronic device 100 shown in FIG. 23, the parasitic stub 430 is mainly configured to improve a radiation characteristic (for example, radiation efficiency) of the first antenna 401.

In an embodiment, the parasitic stub 430 may be configured to generate a first parasitic resonance. A resonance point frequency of the first parasitic resonance is greater than the resonance point frequency of the second resonance.

In an embodiment, the first parasitic resonance may be used to improve a radiation characteristic (for example, radiation efficiency) of the first antenna 401 in the first frequency band.

In an embodiment, a frequency difference between the resonance point frequency of the third resonance and the resonance point frequency of the first resonance is greater than or equal to 100 MHz. In an embodiment, a frequency difference between the resonance point frequency of the third resonance and the resonance point frequency of the first resonance is less than or equal to 800 MHz.

It should be understood that, compared with a resonance point of the first resonance, the resonance point of the third resonance is closer to a low frequency. When a frequency between the resonance point frequency of the third resonance and the resonance point frequency of the first resonance is within a specific range, cancellation effect between the current on the fourth current path and the current on the third current path is better, and there is better isolation between the first antenna 401 and the second antenna 402.

In an embodiment, a frequency difference between the resonance point frequency of the first parasitic resonance and the resonance point frequency of the first resonance is greater than or equal to 100 MHz and less than or equal to 400 MHz.

It should be understood that, when a frequency between the resonance point frequency of the first parasitic resonance and the resonance point frequency of the first resonance is within a specific range, the first parasitic resonance being close to the first resonance does not cause a dip in the radiation efficiency of the first antenna 401 in the first frequency band. In this way, the first antenna 401 can have a better radiation characteristic (for example, radiation efficiency) in the first frequency band.

In an embodiment, the first connection point 431 is disposed on a side that is of the second radiator 420 and that is away from the first radiator 410. A distance between the first connection point 431 and the fourth position 214 (a length of the second radiator 420 between the first connection point 431 and the fourth position 214) is greater than a distance between the first connection point 431 and the fifth position 215 (a length of the second radiator 420 between the first connection point 431 and the fifth position 215).

It should be understood that, when the first connection point 431 is disposed on the side that is of the second radiator 420 and that is away from the first radiator 410, a radiation characteristic of the second resonance generated by the second radiator 420 may be less affected by the first connection point 431, and the second antenna 402 still has a good radiation characteristic in the second frequency band.

In an embodiment, the second feed point 422 and the first connection point 431 are respectively located on two sides of a center of the second radiator 420 between the fourth position 214 and the fifth position 215, and a distance between the center and the fourth position 214 (a length of the second radiator 420 between the center and the fourth position 214) is the same as a distance between the center and the fifth position 215 (a length of the second radiator 420 between the center and the fifth position 215).

In an embodiment, the first connection point 431 is included on the side that is of the second radiator 420 and that is away from the first radiator 410. The second feed point 422 is included on a side that is of the second radiator 420 and that is close to the first radiator 410. In an embodiment, a distance between the second feed point 422 and the fourth position 214 (a length of the second radiator 420 between the second feed point 422 and the fourth position 214) is less than a distance between the second feed point 422 and the fifth position 215 (a length of the second radiator 420 between the second feed point 422 and the fifth position 215).

In an embodiment, the first connection point 431 may be located in a third current strong point area of the second radiator 420 between the fourth position 214 and the fifth position 215. The third current strong point area is generated by coupling the second antenna 402.

It should be understood that, the third current strong point area generated by coupling the second antenna 402 may be understood as an area in which a current strong point is located in a current path when the second antenna 402 generates the second resonance. Because a current corresponds to an electric field, the current strong point may also be understood as an electric field node (electric fields on two sides of the electric field node are reverse).

When the first connection point 431 is located in the third current strong point area, the first element 441 has less impact on the second antenna 402, and the second antenna 402 can still have a good radiation characteristic in the second frequency band.

In an embodiment, the second radiator 420 (the second radiator 420 between the fourth position 214 and the fifth position 215) does not include a ground point.

It should be understood that when the second radiator 420 includes the ground point, current distribution on the second radiator 420 changes, and it is difficult to control current distribution on the second radiator 420.

For brevity of description, parts that are of the first antenna 401 and the second antenna 402 shown in FIG. 23 and that are similar to those of the first antenna 401 and the second antenna 402 shown in FIG. 11 to FIG. 16 are not described one by one again. For example, similar parts include: a position and a structure of the first radiator 410; a position and a structure of the second radiator 420; a position and a structure of the parasitic stub 430; a relationship between the first frequency band and the second frequency band; an equivalent inductor of the first element 441; an equivalent capacitor of the second element 442; a position of the second connection point 432; and the like.

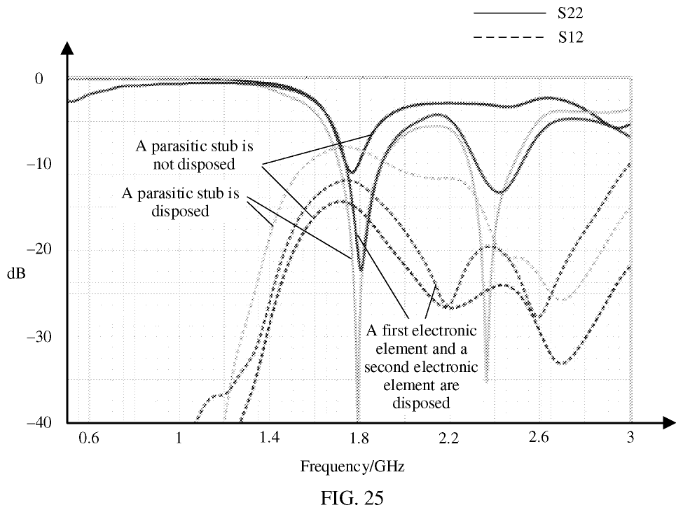

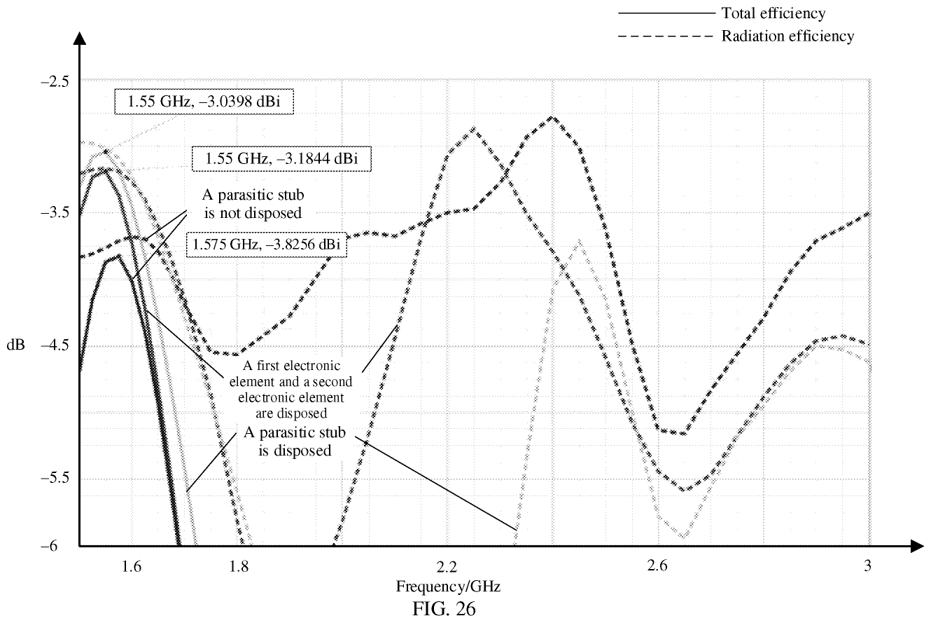

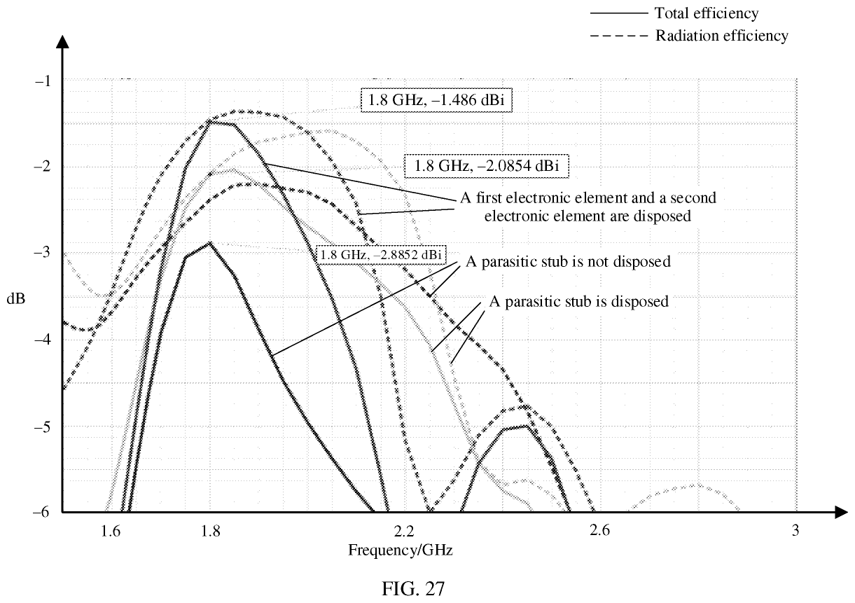

FIG. 24 to FIG. 27 show simulation results of the first antenna and the second antenna in the electronic device 100 shown in FIG. 23. FIG. 24 shows a simulation result of an S parameter of the first antenna in the electronic device 100 shown in FIG. 23. FIG. 25 shows a simulation result of an S parameter of the second antenna in the electronic device 100 shown in FIG. 23. FIG. 26 shows simulation results of radiation efficiency and total efficiency of the first antenna in the electronic device 100 shown in FIG. 23. FIG. 27 shows simulation results of radiation efficiency and total efficiency of the second antenna in the electronic device 100 shown in FIG. 23.

It should be understood that, in the simulation results shown in FIG. 24 to FIG. 27, simulation results in cases of not disposing the parasitic stub, disposing the parasitic stub, disposing the first element, the second element, and the parasitic stub are respectively shown.

As shown in FIG. 24, in the foregoing different cases, the first antenna (S11) may generate a resonance near 1.55 GHz, which may correspond to the first resonance. A resonance frequency band of the first resonance includes an L1 frequency band in the GPS.

As shown in FIG. 25, in the foregoing different cases, the second antenna (S22) generates a resonance near 1.8 GHz, which may correspond to the second resonance. A resonance frequency band of the second resonance includes a B3 frequency band in LTE.

In addition, a new resonance generated by the second antenna near 0.6 GHz may be understood as a third resonance generated on the parasitic stub due to a fourth current path introduced after loading of the first element.

Compared with the case of not disposing the parasitic stub, in the case of disposing the parasitic stub, isolation (S12) between the first antenna and the second antenna deteriorates by about 7 dB. When the first element and the second element are added, isolation between the isolation (S12) between the first antenna and the second antenna is improved by about 12 dB.

As shown in FIG. 26 and FIG. 27, compared with not disposing the parasitic stub, the parasitic stub improves radiation efficiency and total efficiency of the first antenna and the second antenna to some extent.

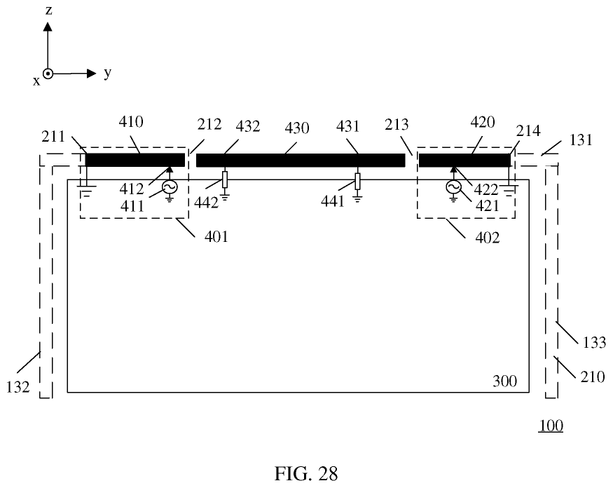

FIG. 28 is a diagram of another electronic device 100 according to an embodiment of this application.

It should be understood that, in the foregoing embodiments, an example in which the first radiator 410 of the first antenna 401 and the second radiator 420 of the second antenna 402 are respectively located in different housings is used for description. In actual production or design, the first radiator 410 of the first antenna 401 and the second radiator 420 of the second antenna 402 are both disposed in a same housing. The electronic device 100 shown in FIG. 28 includes only a single housing, and a first radiator 410 and a second radiator 420 each include a part of a side frame of the housing.

As shown in FIG. 28, the electronic device 100 includes a first side frame 210 and a ground plane 300.

The first side frame 210 includes a first position 211, a second position 212, a third position 213, and a fourth position 214 that are sequentially disposed. The first side frame 210 has a first insulation slot and a second insulation slot at the second position 212 and the third position 213 respectively. The first side frame 210 is coupled to the ground plane 300 or has an insulation slot at the first position 211. The first side frame 210 is coupled to the ground plane 300 or has an insulation slot at the fourth position 214.

In an embodiment, the first position 211, the second position 212, the third position 213, and the fourth position 214 may be located on a first edge 131 of the first side frame 210. In an embodiment, the second position 212 and the third position 213 may be located on a first edge 131 of the first side frame 210, the first position 211 may be located on a second edge 132 of the first side frame 210, and the fourth position 214 may be located on a third edge 133 of the first side frame 210. The first edge 131 separately intersects the second edge 132 and the third edge 133 at an angle.

It should be understood that specific positions of the first position 211, the second position 212, the third position 213, and the fourth position 214 are not limited in this embodiment of this application, and may be determined based on actual production or design.

The electronic device 100 includes a first antenna 401 and a second antenna 402.

The first antenna 401 includes the first radiator 410 and a first feed circuit 411. The first radiator 410 includes a conductive part of the first side frame 210 between the first position 211 and the second position 212. At least a part of the first radiator 410 and the ground plane 300 are spaced from each other. The first radiator 410 includes a first feed point 412. The first feed circuit 411 is coupled to the first feed point 412 to feed a radio frequency signal of a first frequency band.

The second antenna 402 includes the second radiator 420 and a second feed circuit 421. The second radiator 420 includes a conductive part of the first side frame 210 between the third position 213 and the fourth position 214. At least a part of the second radiator 420 and the ground plane 300 are spaced from each other. The second radiator 420 includes a second feed point 422. The second feed circuit 421 is coupled to the second feed point 422 to feed a radio frequency signal of a second frequency band.

In an embodiment, the first radiator 410 is configured to generate a first resonance, and a resonance frequency band of the first resonance includes the first frequency band. The second radiator 420 is configured to generate a second resonance, and a resonance frequency band of the second resonance includes the second frequency band. In an embodiment, a resonance point frequency of the first resonance is less than or equal to a resonance point frequency of the second resonance.

The electronic device 100 further includes a parasitic stub 430 and a first element 441.

The parasitic stub 430 includes a conductive part of the first side frame 210 between the second position 212 and the third position 213. At least a part of the parasitic stub 430 and the ground plane 300 are spaced from each other.

The parasitic stub 430 includes a first connection point 431, and the first connection point 431 is located between the second position 212 and the third position 213. The first element 441 is coupled between the first connection point 431 and the ground plane 300. In an embodiment, the first element 441 is inductive.

A center frequency of the first frequency band is less than a center frequency of the second frequency band, and a frequency difference between the center frequency of the first frequency band and the center frequency of the second frequency band is less than or equal to 300 MHz. In an embodiment, the center frequency of the first frequency band is less than or equal to the center frequency of the second frequency band.

In an embodiment, an operating frequency band of the first antenna 401 is adjacent to an operating frequency band of the second antenna 402 (a frequency difference between the center frequency of the first frequency band and the center frequency of the second frequency band is less than or equal to 300 MHz).

For example, an operating frequency band (the first frequency band) of the first antenna 401 includes L1 (1578.42±1.023 MHz) in a global positioning system (global positioning system, GPS), and an operating frequency band (the second frequency band) of the second antenna 402 includes B3 (1.71 GHz to 1.785 GHz) in LTE. Alternatively, for example, an operating frequency band (the first frequency band) of the first antenna 401 includes a 2.4 GHz frequency band (2.4 GHz to 2.4835 GHZ) in Wi-Fi or BT (2.4 GHz to 2.4835 GHZ), and an operating frequency band (the second frequency band) of the second antenna 402 includes B7 (2.5 GHz to 2.57 GHz) or B41 (2.496 GHz to 2.69 GHz) in LTE.

It should be understood that in the foregoing embodiment, only some communication frequency bands that may be included in the first frequency band and the second frequency band are used as an example. In actual production or design, another communication frequency band may also be included. This is not limited in this embodiment of this application.

According to this embodiment of this application, when the radio frequency signal is fed at the first feed point 412, the first antenna 401 may be coupled on the parasitic stub 430 to generate a first current path. In the first current path, currents on the parasitic stub 430 between the second position 212 and the third position 213 are co-directional.

In the first frequency band, because the first element 441 is coupled between the first connection point 431 of the parasitic stub 430 and the ground plane 300, a second current path may be additionally generated on the parasitic stub 430. In the second current path, currents on parasitic stubs 430 on two sides of the first connection point 431 are reverse.

Therefore, the currents on the first current path are partially reverse to the currents on the second path, and the currents on the second path may offset a part of the currents on the first path, thereby weakening coupling between the first radiator 410 and the second radiator 420, and improving isolation between the first antenna 401 and the second antenna 402.

In addition, because the first element 441 is inductive, the operating frequency band of the first antenna 401 is lower than the operating frequency band of the second antenna 402, and the inductive element has a low-pass high-resistance characteristic, an additional current path generated by the second antenna 402 (a radio frequency signal fed at the second feed point 422) on the parasitic stub 430 is weaker, and does not greatly affect an original current path, and the parasitic stub 430 can be configured to improve a radiation characteristic (for example, radiation efficiency) of the second antenna 402.

In an embodiment, the parasitic stub 430 and the first element 441 may be configured to generate a first parasitic resonance and a second parasitic resonance. A resonance point frequency of the first parasitic resonance is greater than the resonance point frequency of the second resonance, and a resonance point frequency of the second parasitic resonance is less than the resonance point frequency of the first resonance.

Correspondingly, when boundary conditions of the parasitic stub 430 and the second radiator 420 are the same (both ends are open ends, or one end is an open end and the other end is a ground end), an electrical length of the parasitic stub 430 is less than an electrical length of the second radiator 420.

It should be understood that, in the foregoing embodiment, the first current path generated by coupling the first antenna 401 on the parasitic stub 430 and the current path generated by coupling the second antenna 402 on the parasitic stub 430 may correspond to the first parasitic resonance. In the foregoing embodiment, the second current path generated by coupling the first antenna 401 on the parasitic stub 430 may correspond to the second parasitic resonance.

In an embodiment, the first parasitic resonance may be used to improve a radiation characteristic (for example, radiation efficiency) of the second antenna 402 in the second frequency band. In an embodiment, the second parasitic resonance may be used to improve isolation between the first antenna 401 and the second antenna 402 in the first frequency band.

It should be understood that, at a resonance point of the first parasitic resonance, in the first current path generated by coupling the first antenna 401 on the parasitic stub 430 and the current path generated by coupling the second antenna 402 on the parasitic stub 430, currents on the parasitic stub 430 are co-directional, and the co-directional currents can be used to improve a radiation characteristic (for example, radiation efficiency) of the antenna.

At a resonance point of the second parasitic resonance, in the second current path generated by coupling the first antenna 401 on the parasitic stub 430, part of currents on the parasitic stub 430 are reverse currents, and currents on the second current path may offset a part of currents on the first current path, so that an overall current generated by coupling the first antenna 401 on the parasitic stub 430 is weakened (because the overall current is weakened, the radiation characteristic of the first antenna 301 is slightly improved by using the first parasitic resonance), thereby weakening coupling between the first radiator 410 and the second radiator 420, and improving isolation between the first antenna 401 and the second antenna 402.

Therefore, in the electronic device 100 shown in FIG. 11, the parasitic stub 430 is mainly configured to improve a radiation characteristic (for example, radiation efficiency) of the second antenna 402.

In an embodiment, a frequency difference between the resonance point frequency of the second parasitic resonance and the resonance point frequency of the first resonance is greater than or equal to 100 MHz. In an embodiment, a frequency difference between the resonance point frequency of the second parasitic resonance and the resonance point frequency of the first resonance is less than or equal to 800 MHz.

It should be understood that, compared with a resonance point of the first resonance, the resonance point of the second parasitic resonance is closer to a low frequency. When a frequency between the resonance point frequency of the second parasitic resonance and the resonance point frequency of the first resonance is within a specific range, cancellation effect between the current on the second current path and the current on the first current path is better, and there is better isolation between the first antenna 401 and the second antenna 402. In addition, the second parasitic resonance being close to the first resonance does not cause a dip in the radiation efficiency of the first antenna 401 in the first frequency band, nor does it reduce a radiation characteristic of the first antenna 401 in the first frequency band.

In an embodiment, a frequency difference between the resonance point frequency of the first parasitic resonance and the resonance point frequency of the second resonance is greater than or equal to 100 MHz and less than or equal to 400 MHz.

It should be understood that, when a frequency between the resonance point frequency of the first parasitic resonance and the resonance point frequency of the second resonance is within a specific range, the first parasitic resonance being close to the second resonance does not cause a dip in the radiation efficiency of the second antenna 402 in the second frequency band. In this way, the second antenna 402 can have a better radiation characteristic (for example, radiation efficiency) in the second frequency band.

In an embodiment, a length L1 of the first side frame 210 between the first position 211 and the second position 212 and a length L2 of the first side frame between the second position 212 and the third position 213 satisfy: L1×150%≤L2.

It should be understood that, as a length of the parasitic stub 430 increases, it is more conducive to improving a radiation characteristic of the antenna (the first antenna 401 or the second antenna 402).

In an embodiment, the first connection point 431 is disposed on a side that is of the parasitic stub 430 and that is away from the first radiator 410. A distance between the first connection point 431 and the second position 212 (a length of the parasitic stub 430 between the first connection point 431 and the second position 212) is greater than a distance between the first connection point 431 and the third position 213 (a length of the parasitic stub 430 between the first connection point 431 and the third position 213).

It should be understood that, when the first connection point 431 is disposed on the side that is of the parasitic stub 430 and that is away from the first radiator 410, a reverse current between the current on the first current path and the current on the second path can be increased, further reducing coupling between the first radiator 410 and the second radiator 420, and improving isolation between the first antenna 401 and the second antenna 402.

In an embodiment, the first connection point 431 may be located in a first current strong point area of the parasitic stub 430 between the second position 212 and the third position 213. The first current strong point area is generated by coupling the second antenna 402.

It should be understood that, the first current strong point area generated by coupling the second antenna 402 may be understood as an area in which a current strong point is located in a current path generated by coupling the second antenna 402 on the parasitic stub 430. Because a current corresponds to an electric field, the current strong point may also be understood as an electric field node (electric fields on two sides of the electric field node are reverse). In this embodiment of this application, the current strong point area may be understood as an area within 5 mm away from the electric field node.

When the first connection point 431 is located in the first current strong point area, the first element 441 has less impact on the second antenna 402, and the radiation characteristic of the second antenna 402 can be greatly improved by using the parasitic stub 430.

In an embodiment, an equivalent inductance value of the first element 441 may be determined based on an actual frequency of the first frequency band. In an embodiment, when the center frequency of the first frequency band is less than or equal to 2 GHz, an equivalent inductance value of the first element 441 is greater than or equal to 2 nH. When the center frequency of the first frequency band is greater than 2 GHZ, an equivalent inductance value of the first element 441 is greater than or equal to 10 nH.

In an embodiment, the electronic device 100 further includes a second element 442. The parasitic stub 430 includes a second connection point 432. The second element 442 is coupled between the second connection point 432 and the ground plane 300. In an embodiment, the second element 442 is capacitive.

According to this embodiment of this application, a part of currents in the current path generated by the second antenna 402 flows into the ground plane 300 at the second connection point 432, further reducing coupling between the first radiator 410 and the second radiator 420, and improving isolation between the first antenna 401 and the second antenna 402.

In addition, because the second element 442 is capacitive, an operating frequency band of the first antenna 401 is lower than an operating frequency band of the second antenna 402, and the capacitive element has a high-pass low-impedance characteristic, on the parasitic stub 430, a current path generated by the first antenna 401 is not affected near the second connection point 432, and the parasitic stub 430 can be configured to improve the radiation characteristic (for example, radiation efficiency) of the first antenna 401.

In an embodiment, the first connection point 431 and the second connection point 432 are respectively located on two sides of a center of a parasitic stub between the second position 212 and the third position 213, and a distance between the center and the second position 212 (a length of the parasitic stub 430 between the center and the second position 212) is the same as a distance between the center and the third position 213 (a length of the parasitic stub 430 between the center and the third position 213).

In an embodiment, the first connection point 431 is included on a side that is of the parasitic stub 430 and that is away from the first radiator 410. The second connection point 432 is included on a side that is of the parasitic stub 430 and that is close to the first radiator 410. In an embodiment, a distance between the second connection point 432 and the second position 212 (a length of the parasitic stub 430 between the second connection point 432 and the second position 212) is less than a distance between the second connection point 432 and the third position 213 (a length of the parasitic stub 430 between the second connection point 432 and the third position 213).

In an embodiment, the second connection point 432 may be located in a second current strong point area of the parasitic stub 430 between the second position 212 and the third position 213. The second current strong point area is generated by coupling the first antenna 401.

It should be understood that, the second current strong point area by the first antenna 401 may be understood as an area in which a current strong point is located in a current path generated by coupling the first antenna 401 on the parasitic stub 430.

When the second connection point 432 is located in the second current strong point area, the second element 442 has less impact on the first antenna 401, and the radiation characteristic of the first antenna 401 can be greatly improved by using the parasitic stub 430.

In an embodiment, an equivalent inductance value of the second element 442 may be determined based on an actual frequency of the second frequency band. In an embodiment, when the center frequency of the second frequency band is less than or equal to 2 GHz, an equivalent inductance value of the second element 442 is less than or equal to 2 pF. When the center frequency of the second frequency band is greater than 2 GHZ, an equivalent inductance value of the second element 442 is greater than or equal to 1 pF.

In an embodiment, the first side frame 210 is coupled to the ground plane 300 at the first position 211. In an embodiment, the first side frame 210 is coupled to the ground plane 300 at the fourth position 214.

It should be understood that one end of the first radiator 410 and/or the second radiator 420 is a ground end, and the other end is an open end, to form a structure similar to an IFA or a structure similar to a left-hand antenna.

In an embodiment, a resonance generated by the first radiator 410 and/or the second radiator 420 may correspond to a quarter-wavelength mode. An electrical length of the first radiator 410 is approximately a quarter of a first wavelength. An electrical length of the second radiator 420 is approximately a quarter of a second wavelength.

In an embodiment, the first side frame 210 has an insulation slot at the first position 211. In an embodiment, the first side frame 210 has an insulation slot at the fourth position 214.

It should be understood that both ends of the first radiator 410 and/or the second radiator 420 are open ends, to form an antenna structure similar to a dipole.

In an embodiment, a resonance generated by the first radiator 410 and/or the second radiator 420 may correspond to a one-half-wavelength mode. An electrical length of the first radiator 410 is approximately one-half of the first wavelength. An electrical length of the second radiator 420 is approximately one-half of the second wavelength.

In an embodiment, both ends of the parasitic stub 430 are open ends, to form an antenna structure similar to a dipole, and the parasitic stub 430 operates in the one-half-wavelength mode. The parasitic stub 430 may generate the parasitic resonance in the wire DM mode in the foregoing embodiments.

It should be understood that, in this embodiment of this application, structures formed by the first radiator 410 and the second radiator 420 are not limited in this embodiment of this application. For example, the first side frame 210 has an insulation slot at the first position 211 or the fourth position 214, and the structures formed by the first radiator 410 and the second radiator 420 can be determined based on actual production or design.

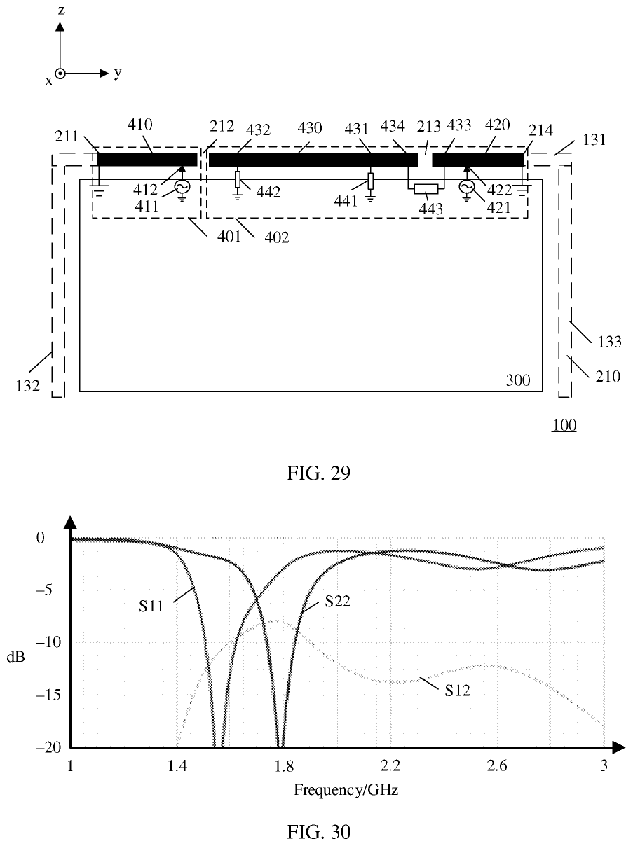

In an embodiment, the second antenna 402 also includes a third element 443, as shown in FIG. 29. The second radiator 420 may further include a third connection point 433, the parasitic stub 430 may further include a fourth connection point 434, and the second insulation slot is located between the third connection point 433 and the fourth connection point 434. The third element 443 is coupled between the third connection point 433 and the fourth connection point 434.

It should be understood that the second radiator 420 and the parasitic stub 430 may jointly form the metamaterial structure in the foregoing embodiments. For related structure limitations, refer to limitations of the foregoing metamaterial structure, for example, a specific value of the third element 443, and a distance between the third connection point 433 and the second insulation slot and/or a distance between the fourth connection point 434 and the second insulation slot. For brevity of description, details are not described again.

In an embodiment, the second radiator 420, the parasitic stub 430, and the first element 441 are configured to generate a second resonance and a third resonance, and a resonance frequency band of the second resonance includes the second frequency band. In an embodiment, a resonance point frequency of the first resonance is less than or equal to a resonance point frequency of the second resonance. The resonance point frequency of the first resonance is greater than a resonance point frequency of the third resonance.

It should be understood that, when the second radiator 420 and the parasitic stub 430 may jointly form the metamaterial structure in the foregoing embodiments, the parasitic stub 430 is not configured to generate a parasitic resonance, and the parasitic stub 430 and the second radiator 420 jointly serve as a radiator of the second antenna 402.

At the resonance point of the second resonance, currents on the parasitic stub 430 are co-directional. The third resonance may correspond to the second current path in the foregoing embodiments. At a resonance point of the third resonance, part of currents on the parasitic stub 430 are reverse currents.

In an embodiment, the third resonance may be used to improve isolation between the first antenna 401 and the second antenna 402 in the first frequency band.

It should be understood that, at the resonance point of the third resonance, in the second current path generated by coupling the first antenna 401 on the parasitic stub 430, part of currents on the parasitic stub 430 are reverse currents, and currents on the second current path may offset a part of currents on the first current path, so that an overall current generated by coupling the first antenna 401 on the second radiator 420 is weakened, thereby weakening coupling between the first radiator 410 and the second radiator 420, and improving isolation between the first antenna 401 and the second antenna 402.

In an embodiment, a frequency difference between the resonance point frequency of the third resonance and the resonance point frequency of the first resonance is greater than or equal to 100 MHz. In an embodiment, a frequency difference between the resonance point frequency of the third resonance and the resonance point frequency of the first resonance is less than or equal to 800 MHz.

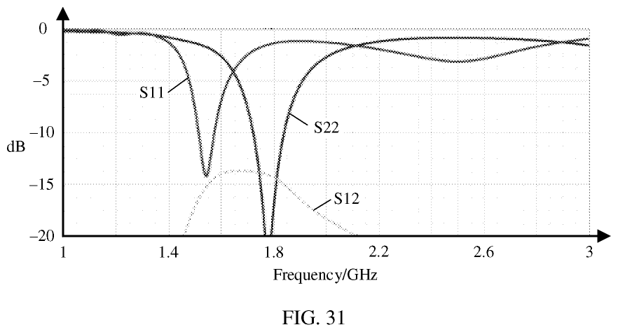

It should be understood that, compared with a resonance point of the first resonance, the resonance point of the third resonance is closer to a low frequency. When a frequency between the resonance point frequency of the third resonance and the resonance point frequency of the first resonance is within a specific range, cancellation effect between the current on the second current path and the current on the first current path is better, and there is better isolation between the first antenna 401 and the second antenna 402. FIG. 30 and FIG. 31 show simulation results of S parameters of the first antenna and the second antenna in the electronic device 100 shown in FIG. 29. FIG. 30 shows simulation results of S parameters of the first antenna and the second antenna when the first element and the second element are not disposed. FIG. 31 shows simulation results of S parameters of the first antenna and the second antenna when the first element and the second element are disposed.

As shown in FIG. 30 and FIG. 31, the first antenna (S11) generates a resonance near 1.55 GHZ, which may correspond to the first resonance. A resonance frequency band of the first resonance includes an L1 frequency band in the GPS. The second antenna (S22) generates a resonance near 1.75 GHZ, which may correspond to the second resonance. A resonance frequency band of the second resonance includes a B3 frequency band in LTE.

In addition, a new resonance generated by the second antenna near 0.6 GHz may be understood as a third resonance generated on the parasitic stub due to a second current path introduced after loading of the first element.

When the first element and the second element are not disposed, in the first frequency band, isolation between the isolation (S12) between the first antenna and the second antenna is only about 12 dB, and in the second frequency band, isolation between the isolation (S12) between the first antenna and the second antenna is only about 9 dB, as shown in FIG. 30.

When the first element and the second element are disposed, in the first frequency band, isolation between the isolation (S12) between the first antenna and the second antenna is improved to about 14 dB, and in the second frequency band, isolation between the isolation (S12) between the first antenna and the second antenna is improved to about 14 dB, as shown in FIG. 31.

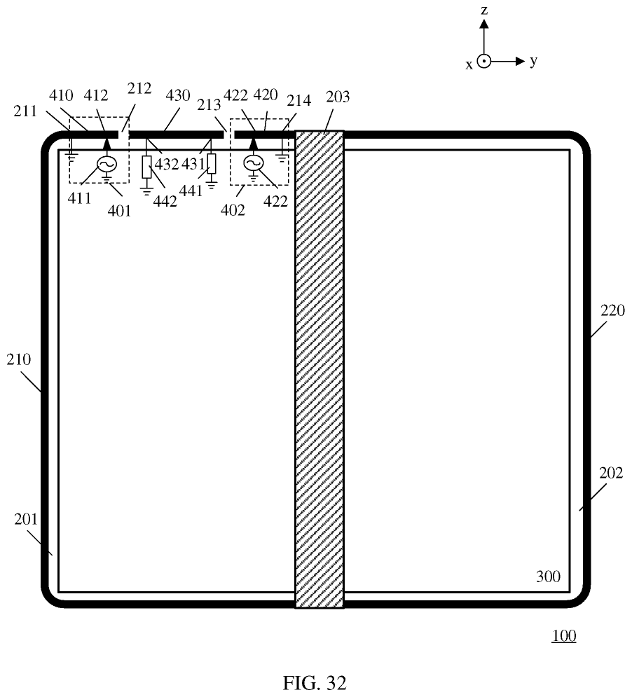

FIG. 32 is a diagram of another electronic device 100 according to an embodiment of this application.

As shown in FIG. 32, the electronic device 100 may include a first housing 201, a second housing 202, a first rotating shaft 203, and a ground plane 300.

The first housing 201 includes a first side frame 210, and at least a part of the first side frame 210 and the ground plane 300 are spaced from each other. The second housing 202 includes a second side frame 220, and at least a part of the second side frame 220 and the ground plane 300 are spaced from each other.

The first rotating shaft 203 is located between the first housing 201 and the second housing 202, and the first rotating shaft 203 is rotatably connected to the first housing 201 and the second housing 202 separately, so that the first housing 201 and the second housing 202 can rotate relative to each other. In an embodiment, the ground plane 300 may include a first part and a second part. The first part may be located in the first housing 201, the second part may be located in the second housing 202, and the first part and the second part may be connected through the first rotating shaft 203.

It should be understood that a difference between the electronic device 100 shown in FIG. 32 and the electronic device 100 shown in FIG. 28 and FIG. 29 lies only in whether the electronic device 100 can be folded.

In the electronic device 100 shown in FIG. 28 and FIG. 29, the electronic device 100 includes only one housing, and the first radiator 410 of the first antenna 401 and the second radiator 420 of the second antenna 402 each include a part of a side frame of the housing.

However, in the electronic device 100 shown in FIG. 32, the electronic device 100 includes a plurality of housings (for example, the first housing and the second housing 202), and the electronic device 100 is a foldable electronic device. A first radiator 410 of a first antenna 401 and a second radiator 420 of a second antenna 402 each include a part of a side frame of the first housing 201.

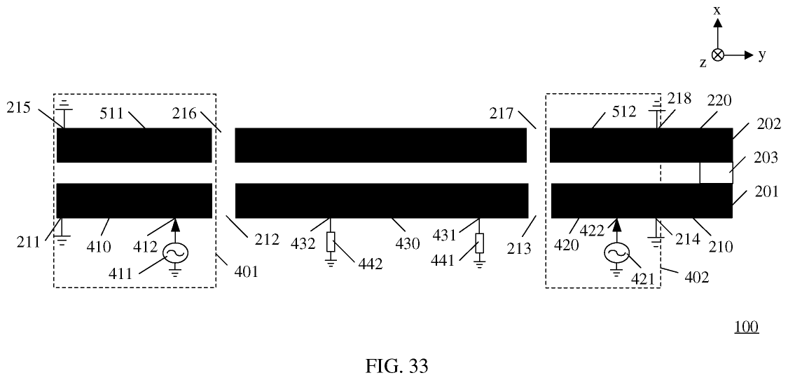

In an embodiment, the second side frame 220 may further include a fifth position 215 and a sixth position 216, as shown in FIG. 33. The second side frame 220 has an insulation slot or is coupled to the ground plane 300 at the fifth position 215 and the sixth position 216.

In an embodiment, the electronic device 100 may further include a parasitic stub 511. The parasitic stub 511 includes a conductive part of the second side frame 220 between the fifth position 215 and the sixth position 216. At least a part of the parasitic stub 511 and the ground plane 300 are spaced from each other.

When the electronic device 100 is in a folded state, the parasitic stub 511 and the first radiator 410 at least partially overlap in a first direction. The first direction is a thickness direction of the electronic device 100, or when the electronic device 100 is in an unfolded state, the first direction is a direction perpendicular to a display, for example, an x direction.

It should be understood that the parasitic stub 511 can be configured to improve a radiation characteristic (for example, radiation efficiency) of the first antenna 401. For example, a frequency difference between a resonance point frequency of a parasitic resonance generated by the parasitic stub 511 and a resonance point frequency of a resonance generated by the first antenna 401 is greater than or equal to 100 MHz and is less than or equal to 400 MHz. In an embodiment, when a radio frequency signal is fed at a first feed point 412, a current on the first radiator 410 and a current on the parasitic stub 511 are co-directional.

In an embodiment, the second side frame 220 is coupled to the ground plane 300 at the fifth position 215 and has a third insulation slot at the sixth position 216.

It should be understood that one end of the parasitic stub 511 is a ground end, and the other end is an open end, to form a structure similar to an IFA or a structure similar to a left-hand antenna. The parasitic stub 511 may operate in a quarter-wavelength mode. A specific structure of the parasitic stub 511 is not limited in this embodiment of this application, and may be determined based on actual production or design. For example, the second side frame 220 has insulation slots at both the fifth position 215 and the sixth position 216.

In an embodiment, the electronic device 100 is in the folded state, and a first insulation slot is aligned with the third insulation slot, to improve aesthetics of the electronic device 100.

In an embodiment, the second side frame 220 may further include a seventh position 217 and an eighth position 218, as shown in FIG. 33. The second side frame 220 has an insulation slot or is coupled to the ground plane 300 at the seventh position 217 and the eighth position 218. In an embodiment, the fifth position 215, the sixth position 216, the seventh position 217, and the eighth position 218 are sequentially disposed on the second side frame.

In an embodiment, the electronic device 100 may further include a parasitic stub 512. The parasitic stub 512 includes a conductive part of the second side frame 220 between the seventh position 217 and the eighth position 218. At least a part of the parasitic stub 511 and the ground plane 300 are spaced from each other.

When the electronic device 100 is in the folded state, the parasitic stub 512 and the second radiator 420 at least partially overlap in the first direction.

It should be understood that the parasitic stub 512 can be configured to improve a radiation characteristic (for example, radiation efficiency) of the second antenna 402. For example, a frequency difference between a resonance point frequency of a parasitic resonance generated by the parasitic stub 512 and a resonance point frequency of a resonance generated by the second antenna 402 is greater than or equal to 100 MHz and is less than or equal to 400 MHz. In an embodiment, when a radio frequency signal is fed at a second feed point 422, a current on the second radiator 420 and a current on the parasitic stub 512 are co-directional.

In an embodiment, the second side frame 220 is coupled to the ground plane 300 at the eighth position 218 and has a fourth insulation slot at the seventh position 217.

It should be understood that one end of the parasitic stub 512 is a ground end, and the other end is an open end, to form a structure similar to an IFA or a structure similar to a left-hand antenna. The parasitic stub 512 may operate in a quarter-wavelength mode. A specific structure of the parasitic stub 512 is not limited in this embodiment of this application, and may be determined based on actual production or design. For example, the second side frame 220 has insulation slots at both the seventh position 217 and the eighth position 218.

In an embodiment, the electronic device 100 is in the folded state, and a second insulation slot is aligned with the fourth insulation slot, to improve aesthetics of the electronic device 100.

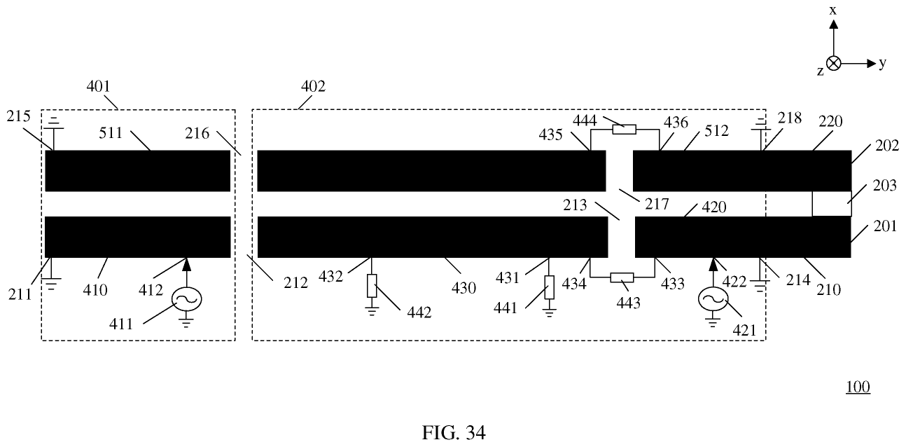

In an embodiment, the second side frame 220 has the third insulation slot and the fourth insulation slot at the sixth position 216 and the seventh position 217 respectively. The parasitic stub 512 includes a conductive part of the second side frame 220 between the sixth position 216 and the eighth position 218, as shown in FIG. 34.

In an embodiment, the second antenna 402 may further include a fourth element 444. The parasitic stub 512 may further include a fifth connection point 435 and a sixth connection point 436, and the fourth insulation slot is located between the fifth connection point 435 and the sixth connection point 436. The fourth element 444 is coupled between the fifth connection point 435 and the sixth connection point 436.

It should be understood that the metamaterial structure that may be formed by the parasitic stub 512 is similar to the metamaterial structure that is formed by the second radiator 420 in the foregoing embodiments. For related structure limitations, refer to limitations of the foregoing metamaterial structure. For brevity of description, details are not described again.

For brevity of description, parts that are of the first antenna 401 and the second antenna 402 shown in FIG. 32 to FIG. 34 and that are similar to those of the first antenna 401 and the second antenna 402 shown in FIG. 28 and FIG. 29 are not described one by one again. For example, similar parts include: a position and a structure of the first radiator 410; a position and a structure of the second radiator 420; a position and a structure of the parasitic stub 430; a relationship between the first frequency band and the second frequency band; an equivalent inductor of the first element 441; an equivalent capacitor of the second element 442; a position of the second connection point 432; and the like.

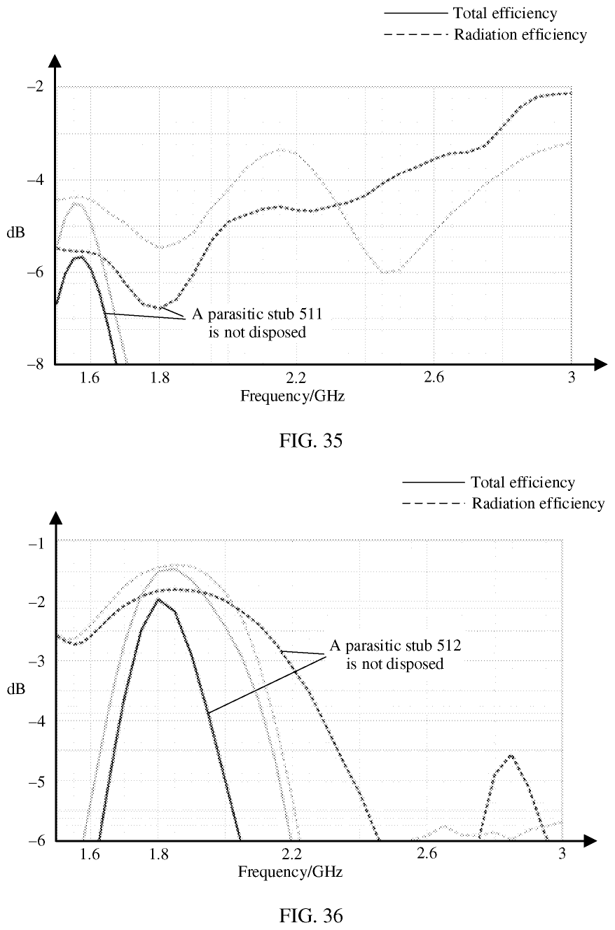

FIG. 35 and FIG. 36 show simulation results of radiation efficiency and total efficiency of the first antenna and the second antenna in the electronic device 100 shown in FIG. 34. FIG. 35 shows simulation results of radiation efficiency and total efficiency of the first antenna and the second antenna in the electronic device 100 shown in FIG. 34. FIG. 36 shows simulation results of radiation efficiency and total efficiency of the second antenna in the electronic device 100 shown in FIG. 34.

It should be understood that, for brevity of description, in the simulation results shown in FIG. 35 and FIG. 36, only an example in which the first frequency band includes an L1 frequency band (1578.42±1.023 MHz) in the GPS and the second frequency band includes a B3 frequency band (1.71 GHz to 1.785 GHz) in LTE is used for description.

As shown in FIG. 35, in the electronic device 100 shown in FIG. 34, after the parasitic stub 511 is disposed on the first antenna, in the first frequency band, radiation efficiency is improved by about 2 dB, and radiation efficiency is improved by about 2 dB.

As shown in FIG. 35, in the electronic device 100 shown in FIG. 34, after the parasitic stub 512 is disposed on the second antenna, in the second frequency band, radiation efficiency is improved by about 0.5 dB, and radiation efficiency is improved by about 0.5 dB.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An electronic device, comprising:
a first housing comprising a first side frame;
a second housing comprising a second side frame;
a ground plane, wherein:
the first side frame is coupled to the ground plane or has an insulation slot at a first position of the first side frame, the first side frame has a first insulation slot and a second insulation slot at a second position of the first side frame and a third position of the first side frame, respectively and the first position, the second position, and the third position, are sequentially disposed; and
the second side frame has a third insulation slot at a fourth position of the second side frame, and the second side frame is coupled to the ground plane or has an insulation slot at a fifth position of the second side frame;
a first rotating shaft between the first housing and the second housing, and the first rotating shaft is rotatably connected to the first housing and the second housing separately;
a first antenna comprising:
a first radiator comprising a conductive part of the first side frame between the first position and the second position, and at least a part of the first radiator and the ground plane are spaced from each other; and
a first feed circuit coupled to a first feed point of the first radiator to feed a radio frequency signal of a first frequency band; and
a second antenna, wherein the second antenna comprises:
a second radiator comprising a conductive part of the second side frame between the fourth position and the fifth position, and at least a part of the second radiator and the ground plane are spaced from each other; and
a second feed circuit coupled to a second feed point of the second radiator to feed a radio frequency signal of a second frequency band;
a parasitic stub comprising a conductive part of the first side frame between the second position and the third position, and at least a part of the parasitic stub and the ground plane are spaced from each other; and
a first element, wherein:
the first element is inductive, and the first element is coupled between a first connection point of the parasitic stub and the ground plane, wherein when the electronic device is in a folded state, the parasitic stub and the second radiator at least partially overlap in a first direction, the first radiator and the second radiator are staggered in the first direction, the first direction is a thickness direction of the electronic device, and a distance between the second position and the fourth position is less than a distance between the second position and the fifth position; and
a center frequency of the first frequency band is less than or equal to a center frequency of the second frequency band, and a frequency difference between the center frequency of the first frequency band and the center frequency of the second frequency band is less than or equal to 300 MHz.

2. The electronic device according to claim 1, wherein:
a distance between the first connection point and the second position is greater than a distance between the first connection point and the third position.

3. The electronic device according to claim 1, wherein:
the first radiator is configured to generate a first resonance, and a resonance frequency band of the first resonance comprises the first frequency band;
the second radiator is configured to generate a second resonance, a resonance frequency band of the second resonance comprises the second frequency band, and a resonance point frequency of the second resonance is greater than or equal to a resonance point frequency of the first resonance; and
the parasitic stub and the first element are configured to generate a first parasitic resonance and a second parasitic resonance, a resonance point frequency of the first parasitic resonance is greater than the resonance point frequency of the second resonance, and a resonance point frequency of the second parasitic resonance is less than the resonance point frequency of the first resonance.

4. The electronic device according to claim 3, wherein:
a frequency difference between the resonance point frequency of the second parasitic resonance and the resonance point frequency of the first resonance is greater than or equal to 100 MHz.

5. The electronic device according to claim 3, wherein
a frequency difference between the resonance point frequency of the first parasitic resonance and the resonance point frequency of the second resonance is greater than or equal to 100 MHz and less than or equal to 400 MHz.

6. The electronic device according to claim 3, wherein:
at a resonance point of the first parasitic resonance, currents on the parasitic stub are co-directional; or
at a resonance point of the second parasitic resonance, part of currents on the parasitic stub are reverse currents.

7. The electronic device according to claim 1, further comprising:
a second element, the second element is capacitive, and the second element is coupled between a second connection point of the parasitic stub and the ground plane.

8. The electronic device according to claim 7, wherein:
a distance between the second connection point and the second position is less than a distance between the second connection point and the third position.

9. The electronic device according to claim 1, wherein:
the first side frame is coupled to the ground plane at the first position;
the second side frame has a fourth insulation slot at the fifth position; and
the first insulation slot is aligned with the third insulation slot, or the first insulation slot is aligned with the fourth insulation slot.

10. The electronic device according to claim 1, wherein:
the fifth position is located between the fourth position and the sixth position of the second side frame, the second side frame has the fourth insulation slot at the fifth position, and the second side frame is coupled to the ground plane at the sixth position;
the second radiator comprises a conductive part of the second side frame between the fourth position and the sixth position; and
the second antenna further comprises a third element, the fourth insulation slot is located between the third connection point of the second radiator and the fourth connection point of the second radiator, and the third element is coupled between the third connection point and the fourth connection point.

11. The electronic device according to claim 10, wherein:
a distance between the fourth insulation slot and the third connection point or a distance between the fourth insulation slot and the fourth connection point is less than or equal to 5 mm.

12. The electronic device according to claim 1, wherein:
the third position is located between the second position and a seventh position of the first side frame, and the first side frame is coupled to the ground plane at the seventh position;
the conductive part of the first side frame is between the second position and the seventh position, and the first connection point is located on the parasitic stub between the second position and the third position; and
the first antenna and the second antenna further comprise a fourth element, the second insulation slot is located between the fifth connection point of the parasitic stub and the sixth connection point of the parasitic stub, and the fourth element is coupled between the fifth connection point and the sixth connection point.

13. The electronic device according to claim 12, wherein:
a distance between the second insulation slot and the fifth connection point and a distance between the second insulation slot and the sixth connection point are less than or equal to 5 mm.

14. The electronic device according to claim 1, wherein
a length L1 of the first side frame between the first position and the second position and a length L2 of the first side frame between the second position and the third position satisfy L1×150%≤L2.

15. The electronic device according to claim 1, wherein a portion of the first side frame between the second position and the third position does not comprise a ground point.

16. An electronic device, comprising:
a first side frame coupled to a ground plane or has an insulation slot at a first position of the first side frame, the first side frame has a first insulation slot and a second insulation slot at a second position of the first side frame and the third position of the first side frame, respectively, the first side frame is coupled to the ground plane or has an insulation slot at a fourth position of the first side frame, and the first position, the second position, the third position, and the fourth position are sequentially disposed;
a first antenna comprising:
a first radiator comprising a conductive part of the first side frame between the first position and the second position, and at least a part of the first radiator and the ground plane are spaced from each other; and
a first feed circuit coupled to a first feed point of the first radiator to feed a radio frequency signal of a first frequency band; and
a second antenna, wherein the second antenna comprises:
a second radiator comprising a conductive part of the first side frame between the third position and the fourth position, and at least a part of the second radiator and the ground plane are spaced from each other, and
a second feed circuit, coupled to a second feed point of the second radiator to feed a radio frequency signal of a second frequency band;
a first parasitic stub, wherein the first parasitic stub comprises a conductive part of the first side frame between the second position and the third position, and at least a part of the first parasitic stub and the ground plane are spaced from each other; and
a first element, wherein the first element is inductive, the first element is coupled between a first connection point of the first parasitic stub and the ground plane, a center frequency of the first frequency band is less than or equal to a center frequency of the second frequency band, and a frequency difference between the center frequency of the first frequency band and the center frequency of the second frequency band is less than or equal to 300 MHz.

17. The electronic device according to claim 16, wherein the first element is configured to increase isolation between the first antenna and the second antenna in the first frequency band.

18. The electronic device according to claim 16, wherein:
the first antenna and the second antenna further comprise a second element, the second element is capacitive, the first parasitic stub comprises a second connection point, and the second element is coupled between the second connection point and the ground plane.

19. The electronic device according to claim 18, wherein the second element is configured to increase isolation between the first antenna and the second antenna in the second frequency band.

20. The electronic device according to claim 16, wherein:
the first side frame is coupled to the ground plane at the fourth position; and
the second antenna further comprises a third element, the third element is coupled between a third connection point of the second radiator and a fourth connection point of the first parasitic stub.
